(19) United States
(12) Patent Application Publication
(10) Pub. No.: US 2013/0040016 A1
(43) Pub. Date: Feb. 14, 2013

(54) ALLERGEN-FREE COMPOSITIONS

(71) Applicant: Laura Lane BECKER, West Linn, OR (US)

(72) Inventor: Laura Lane BECKER, West Linn, OR (US)

(21) Appl. No.: 13/586,601

(22) Filed: Aug. 15, 2012

Related U.S. Application Data
(63) Continuation-in-part of application No. 13/296,000, filed on Nov. 14, 2011.
(60) Provisional application No. 61/412,997, filed on Nov. 12, 2010.

(51) Int. Cl. A21D 13/04; A21D 8/06; A21D 10/04; A21D 10/02; A23L 1/39; A21D 13/08

(52) U.S. Cl. 426/18; 426/62; 426/496; 426/549; 426/555; 426/659; 426/631; 426/589; 426/523; 426/556

(57) ABSTRACT

The present disclosure provides an allergen-free composition (e.g., flours and dough) and baked products made without eggs or any other major food allergen. The disclosed allergen-free flours, dough, and batters overcome the various problems associated with allergen-free baking by appropriate adjustment of the relative amounts of various components that contribute moisture, alkalinity, texture, etc., to the final product. Baked products produced using the allergen-free flours thus have a moistness, springiness, rise, texture, and flavor comparable to products containing major food allergens. Baked products according to the disclosure include, but are not limited to, cookies (e.g., chocolate chunk/chip cookies), cakes (e.g., cupcakes), muffins, pancakes, waffles, pizza crust, pie crust, and bread products.

### CROSS REFERENCE TO RELATED APPLICATIONS

This application claims benefit to U.S. application Ser. No. 13/296,000 filed Nov. 14, 2011, which claims benefit to U.S. Provisional Application No. 61/412,997 filed Nov. 12, 2010, which is incorporated by reference in its entirety herein.

### FIELD

The present disclosure relates to allergen-free food compositions and baked products that are free from the eight most common food allergens: gluten, dairy, eggs, soy, peanuts, tree nuts, fish, and shellfish, known as “allergen-free foods.” The need for the allergen-free foods is great, since more people are being diagnosed with diseases, food allergies, and food sensitivities.

### BACKGROUND

There is a lot we can do to heal our bodies by the foods we eat. In the case of food allergies and related diseases, the only effective treatment may be to control what we eat. Dietary and nutritional changes can have an immediate and profound impact on the health and well-being of people with food allergies. And just as important in our society, these people should be able to eat and enjoy meals with their families and eat healthily during social events. Our culture is one that is based around food and social events. Eating and enjoying our food is a choice, but it is also a way of life.

There is an equally great need for “low fat” and “cholesterol free foods.” With the wowing number of people with obesity, high cholesterol, and heart disease the U.S. and worldwide, healthy foods are essential. These foods support our bodies. They should provide energy, promote well-being, and taste delicious.

### Disorders and Diets Supported by Allergen-Free Foods

Allergen-free foods support people with celiac disease, food allergies, food intolerances, autism, digestive disorders, auto immune diseases, e.g., rheumatoid arthritis. These conditions affect a large number of people. Celiac disease, for example, affects one in 133 people in the United States. Celiac disease is an inherited autoimmune disorder that affects the digestive process of the small intestine. When a person who has celiac disease consumes gluten, a protein found in many grains such as wheat, rye and barley, the individual's immune system responds by attacking the small intestine and inhibiting the absorption of important nutrients into the body. There are two distinct signs and symptoms of celiac disease: (1) those due to malabsorption and (2) those due to malnutrition, including vitamin and mineral deficiencies. The effects of these signs and symptoms may range from minimal to severe.

There have been changes during the past 20 years in the way in which celiac disease is diagnosed. The average age at which celiac disease is diagnosed has increased, probably because of the increased awareness that the disease can first cause symptoms or signs in adults. Diarrhea formerly was the major diagnosed symptom. However, a growing proportion of patients, now about 15%, are now diagnosed with blood antibody tests. The following diseases are associated with celiac disease: dermatitis herpetiformis, a skin disease characterized by an itchy rash on the extremities, buttocks, neck, trunk, and scalp, which occurs in an estimated 10% of patients with celiac disease; recurrent, painful mouth ulcers (aphthous stomatitis); insulin-dependent diabetes (juvenile-onset or type 1 diabetes); autoimmune thyroid disease; rheumatoid arthritis; and systemic lupus. Celiac disease is not an allergy, but an auto-immune disorder—the body rejects its own digestive proteins used to process gluten and produces antibodies against them. There is currently no cure for celiac disease; only a strict avoidance of gluten in a person's diet can ward off symptoms and possible damage to the intestines. Gluten-free flours, for example, are disclosed in U.S. Published Application No. 2008/0038434.

Gluten is a protein found most notably in wheat, barley, rye, spelt, and malt and in almost any food made from one or more of these grains. Gluten provides wheat flour its flexibility as a baking material. Gluten's elasticity allows the cells that form in bread and keeps baked goods from crumbling. Oats by themselves do not contain gluten, but they are may become contaminated to some degree with wheat. For example, oats and wheat are usually grown next to each other in the fields. Additionally, they may be harvested with the same equipment, processed/milled within the same facility, and subsequently transported using the same containers. Oats therefore must be considered a suspect ingredient, at best. The U.S. is certainly a country with wheat cross-contamination. It is possible to obtain gluten-free oats from dedicated mills that are certified gluten-free by the Gluten-Free Certification Organization (GFCO, Seattle, Wash.) or from manufacturers that have no allergen cross-contamination.

Allergen-free foods also support those who are vegan or keep kosher. The term “vegan” means “non-dairy vegetarian.” Vegans exclude meat, eggs, dairy products, and all other animal derived ingredients, such as honey, from their diets. Veganism is a small but growing movement, and the number of vegan restaurants is increasing. In 1997, 0.5 percent in the U.S. said they had not used animals for any purpose within the previous two years.

### Food Allergies and Food Intolerances

Food allergies are a growing public health concern in the United States, A “food allergy” is the result of an abnormal immunologic response after ingestion of a food. It occurs when the body mistakes an ingredient in food, usually a protein, as harmful and creates a defense system, e.g., antibodies, to fight it. Food allergy symptoms develop when the antibodies are battling the “invading” food. The most common food allergens are gluten-containing grains, dairy, eggs, soy, peanuts, tree nuts (such as walnuts, pecans, and almonds), fish, and shellfish. Special diets are the most commonly used treatment for food allergies. If the patient is allergic to only one or two foods, eliminating the offending foods may be the only treatment necessary.

According to The Food Allergy & Anaphylaxis Network, more than 12 million Americans have food allergies. That is one in 25, or 4 percent of the population. Special care must be taken for children who have food allergies. The incidence of peanut allergies, for example, has doubled in children over a five-year period (1997-2002). A child with severe food allergies may have a life-threatening anaphylactic reaction to even a tiny amount of a food allergen. The reasons for the increased incidence of food allergies and associated anaphylaxis are poorly understood. Research suggests that food-related anaphylaxis might be under-diagnosed. A 2007 study has shown that milk allergy, the most common food allergy, may persist longer in life than previously thought. Of 800 children allergic to milk, only 19 percent had outgrown their allergy by age 4, and only 79 percent had outgrown it by age 16. There is no cure for food allergies. Strict avoidance of food allergens and early recognition and management of allergic reactions to food are important to preventing serious health consequences. Even trace amounts of a food allergen can cause a reaction. Food allergy symptoms include: rash or hives; nausea; stomach pain; diarrhea or constipation; itchy skin; shortness of breath; chest pain; swelling of the airways to the lungs; and anaphylaxis.

There are many people in the U.S. that may not have a food allergy; however, they still experience adverse reactions to certain foods. These sensitivities are called “food intolerances.” Food intolerance is a digestive system response, rather than an immune system response. A food intolerance occurs when something in a food irritates a person's digestive system or when a person is unable to properly digest or breakdown the food. Intolerance to lactose, the sugar found in milk and other dairy products, is the most common food intolerance. Symptoms of food intolerance includes: nausea; stomach pain; gas; cramps; bloating; vomiting; heartburn; diarrhea or constipation; headaches; irritability or nervousness.

Many people may experience the symptoms of food allergies or intolerances without knowing the cause. There are many ways to detect food sensitivities, including the rotation diet, elimination diet, and the allergy skin prick test. The most effective and medically accepted test is the ALCAT Food and Chemical Sensitivity/Intolerance Test, which requires only a blood draw. For over 24 years, the ALCAT Test has provided both patients and healthcare professionals with a tool successfully overcome a wide variety of conditions, such as digestive disorders, migraines, obesity, chronic fatigue, skin disorders, and arthritis, which result from food and chemical sensitivities. The ALCAT Test measures the immune response to food by assaying leukocyte cellular reactivity in whole blood. Other tests for the detection of food allergy include skin tests, elimination and challenge diets, or double blind placebo controlled oral food challenges. Skin tests, although fairly reliable for the detection of immunoglobulin E (IgE) to environmental allergens, are not well correlated with food allergy signs and symptoms. Food panels are another technique that has found an increasing popularity among physicians who are looking for a reliable and convenient diagnostic method. Using food panels, physicians can identify foods to which the patient is allergic or intolerant and then can recommend a diet for the patient.

Delayed food allergy or food sensitivity also involves the immune system. Both occur when the immune system creates an overabundance of IgG to a specific food. The IgG immune reaction is delayed in onset, appearing anywhere from a couple of hours to several days after consuming allergic reactions. Delayed food reactions may be associated with over 100 allergic symptoms and well over 150 different medical diseases. Symptoms of this type of food allergy may include: abdominal pains; aches and pains; acne; attention deficit hyperactivity disorder (ADHD); anxiety; arthritis; asthma; autism; bloating; celiac disease; chronic fatigue; chronic infections; constipation; depression; dizziness; eczema; edema; enuresis (i.e., bed wetting); fibromyalgia; fluid retention; gastrointestinal (GI) problems; hyperactivity; irritable bowel syndrome; itching; lethargy; loss of appetite; migraine; nausea; abnormal postmenstrual syndrome (PMS); psoriasis; recurrent ear infections; recurrent sinus infections; rhinitis; sinusitis; skin rashes; stomach cramps; tension; urticaria; weight grain; weight loss; and wheezing.

The best treatment for a food anew is to avoid the food(s) that causes the allergy. When that is not possible, medicines can be used, such as antihistamines for mild reactions or epinephrine for serious reactions. A relatively new treatment is the gluten-free casein-free (GFCF) diet, which is free of gluten and casein ingredients and derivatives. More people are trying the GFCF diet to help their children with autism, pervasive developmental disorder (PDD), ADHD, allergies, impulsive behavior and speech difficulties. See, e.g., “The GFCF Diet Intervention—Autism Diet,” The GFCF Diet Support Group, at hypertext transfer protocol www.gfcfdiet.com (last updated Jun. 20, 2011). The GFCF diet can also be used by adults to improve their gastrointestinal problems and other symptoms. The theory behind the GFCF diet is that the digestive systems of some people do not completely break down the gluten and casein proteins and that the incompletely digested proteins leak into the gut and are disseminated through the bloodstream. Anecdotal evidence supports at least occasional significant improvements and dramatic decreases in symptoms, such as gastrointestinal problems (diarrhea, constipation, and reflux), and behavior and speech difficulties with the use of the GFCF diet.

### Low Eat and Cholesterol Free Diets

There is an equally great need for a “low fat” diet. A low fat diet is part of a healthy, balanced diet. While not fat-free, a low fat diet should be especially low in saturated fats. Fats supply energy and essential fatty acids and are needed for good health. High levels of saturated fats and cholesterol, however, are related to increased blood cholesterol levels and a greater risk for heart disease, cancers, and other diseases. Saturated fats should be reduced to less than ten percent of total dietary calories to help lower your cholesterol levels.

Saturated fats are present in meat, milk, and milk products. Many baked foods also contain saturated fats. Smaller amounts of saturated fats are supplied from vegetable oils. Sources of polyunsaturated fats are vegetable oils, nuts, and high fat fish. The sources of monosaturated fats are olive and canola oils. These two types of unsaturated fats lower blood cholesterol, when they replace saturated fats in the diet. The FDA recently authorized the health labeling claim that canola oil may reduce the risk of heart disease, because it contains less saturated fat compared to most other oils, has omega-3 polyunsaturated fat, and has a high amount of monounsaturated fat.

Diets also can be “cholesterol free.” Cholesterol is a waxy steroid that is manufactured in the live or intestines. Cholesterol is required to build and maintain cell membranes. Unfortunately, it can also accumulate in the inner parts of arteries, leading to progressive reduction in the diameter of blood vessels and blood flow. This in turn leads to heart attacks, angina, abnormal heart rhythms, and heart failure, among other conditions. The extent to which cholesterol accumulates in arteries depends in part on the level of cholesterol in the blood. When high, this is called hypercholesterolemia.

Major dietary sources of cholesterol include cheese, egg yolks, beef, pork, poultry, and shrimp. The amount of cholesterol present in plant-based sources is generally much lower than animal based sources. Animal fats are complex mixtures of triglycerides, with lesser amounts of phospholipids and cholesterol. As a consequence, all foods containing animal fat contain cholesterol to varying extents. It is worth noting, however, that the body can make its own cholesterol, so that dietary cholesterol is not an essential nutrient.

Not only dietary cholesterol, but also dietary saturated fat, elevate the blood cholesterol level. Total fat intake, especially saturated fat and trans-fat, plays a larger role in blood cholesterol than intake of cholesterol itself. Saturated fat is present in full-fat dairy products, animal fats, several types of oil and chocolate. A change in diet, in addition to other lifestyle modifications, thus may help reduce blood cholesterol. Increasing the relative intake of polyunsaturated fat and certain kinds of dietary fiber, for example, can lower the blood cholesterol level.

### SUMMARY

There is thus a need in the art to produce foods that are allergen-free to support people with food allergies, intolerances, and associated diseases. There is also a need for foods useful in a low fat, cholesterol free diet. Every cook and baker desires to produce the best food product, having a great taste, texture, and appearance. This desire is no less strong for allergen-free baking. Allergen-free food should be look, taste, and smell like what we are used to eating every day. For example, we are unaccustomed to eating a flat, nutty-flavor, gray-colored cake. With health foods, people can accept different tastes and textures in the short term. People who have heart disease or celiac disease, for example, may have to change their diet or risk the consequences—increased risk of a heart attack, stroke, or intestine problems. They have no other choices. But in the ease of food we have to eat every day, year after year, there is a desire that the food tastes good, is esthetically pleasing, and is healthy.

The challenge of allergen-free baking is achieving this goal without using ingredients that are major food allergens, which have been used almost universally in baking for centuries. Wheat flour and eggs are two examples of major food allergens that have multiple roles in baking, making replacement of these ingredients difficult and unpredictable. No single alternative to wheat flour can do all these things in the same way as wheat flour, for example. What works in traditional baking often does not work when baking without such ingredients.

Allergen-free baking has many unique problems. Simply modifying or substituting ingredients often leads to other less desirable results. Traditional baking typically requires flour, milk, butter and/or oil, protein, eggs or a binder that produces similar results, sugar, salt, yeast (for bread and pizza), and baking soda and/or baking powder. From this list only sugar, salt, yeast, baking soda, and baking powder are the only allergen-free ingredients to work with. Trying to create a cake or bread from only these ingredients is of course impossible.

Milk products (all diary), e.g., dry milk solids, cottage cheese, butter, and evaporated milk, are also commonly used in gluten-free baking as a major source of protein and moisture and to enhance structure of the baked goods. See, e.g., Watson et al., Colorado State University, “Gluten-Free Baking,” at hypertext transfer protocol www.ext.colostate.edu/pubs/foodnut/09376.html (last revised April 2009). Soy milk, almond milk, egg whites, and egg beaters (containing eggs) are commonly used in gluten-free products as replacements to provide moisture and protein, for example. In an allergen-free baking product, however, replacements for gluten must be found that are not themselves major food allergens.

### Dairy Ingredients and Eggs

Dairy ingredients are used in almost all baked goods, but are also among those ingredients that contribute to both food allergies and intolerances, as well as dietary fat and cholesterol. While dairy may be a good source of calcium and protein, many people are reducing their consumption of dairy. Dairy is the most common cause of food allergies in the United States. Vegans and some vegetarians do not include milk in their diet because it is of animal origin. Milk also is inappropriate for those who adhere to a “primal” or “paleo” diet. And then there are those that are lactose intolerant. Finally, there are people who prefer milk alternatives because milk contains high levels of fat and cholesterol compared to other available milks.

The most common milks include cow milk, soy milk, almond milk, rice milk, and coconut milk. Cow milk, at least, is not naturally low in fat. Cow milk contains a range of nutrients, including protein and calcium; however, whole milk contains 8 grams of fat and 2.4 grams of cholesterol per 8 ounce serving. Whole cow's milk is the highest in fat and cholesterol compared to milk alternatives. Cow's milk has been linked to a number of health conditions. According to at least one report, women who have more than 90 g of fat per day from sources such as full cream milk are at an increased risk of breast cancer. Further, because whole cow's milk is high is saturated fat, it may lead to heart disease and increased risk of coronary heart disease. Milk is even considered a trigger for eczema, and anecdotal evidence links milk to increased phlegm production. Milk therefore should be avoided by those with respiratory conditions such as asthma.

Milk also needs to be avoided by those who have lactose intolerance. Lactose intolerance is caused by a deficiency in the enzyme lactase, which is needed to bread down and digest dairy products. Those who are intolerant of the milk sugar lactose may be vulnerable to a reaction regardless of the relative fat content of the milk. The milk sugar lactose may over-stimulate the production of hormones that encourage tumors, such as ovarian cancer.

An alternative to cow milk is soy milk. Sow milk contains only 4 grams of fat and zero gams of cholesterol per 1 cup serving. However, soy is one of the eight most common allergens. Soy allergies are quite common and are prevalent in young children. Soy milk also contains a high level of phytoestrogen, which mimics the functions of the female sex hormone estrogen in humans. Some studies are shown that regular intake of soy products can increase breast cancer risks in women. Soy estrogen can also interfere with breast cancer chemotherapy and medication. Doctors are advising patients to avoid drinking soy milk if they are a current breast cancer patient or have a history of breast cancer.

Almond milk is another commonly used cow milk substitute. Almonds, however, are tree nuts, which are one of the eight most common food allergens; they cannot be used in an allergen-free diet. Almond milk is a good source of the antioxidant vitamin E, so it can help prevent cancer and slow the signs of aging. The flavonoids in almonds also help to reduce the number of free radicals in the body, protecting people from a number of degenerative diseases that occur with aging. Unlike cow's milk, almond milk contains no cholesterol and no saturated fats, and the total fat in almond milk is only 2.5 grams per 1 cup serving.

Yet another alternative to cow's milk is rice milk. People with lactose intolerance or casein allergy cannot have dairy, and those with soy and nut allergies cannot drink soy or almond milk. Rice milk, by contrast, is the most hypoallergenic, of all milk products. Rice milk contains a generous supply of balanced nutrition for those who are not able to tolerate other milk alternatives. Rice milk has the least amount of fat compared to all other alternatives. There are only 2 grams of fat per 1 cup serving of rice milk. Rice is cholesterol free; therefore, it works for people with dietary restrictions on fat and cholesterol.

There are plenty of heart-healthy nutrients in the rice bran, and these nutrients are also contained in rice milk. Rice bran oil is a source of unsaturated fat, which can lower blood cholesterol. (Niacin and vitamin B6 are also effective for this purpose.) Rice milk is an excellent source of magnesium, which helps control blood pressure. Iron and copper increases red blood cell production, giving better oxygenation and vitality. Rice milk also contains more manganese and selenium than any other alternatives. These are powerful antioxidants that help protect from all kinds of infections and cancers. Drinking rice milk also can boost the immune system.

Lastly, coconut milk is a milk alternative. Coconut milk is well tolerated by almost everyone; however, coconuts are tree nuts, which are major food allergens. Coconuts have re-vitalizing properties. Within minutes of consuming fresh coconut, people may feel a burst of energy, clarity of mind, and well-being. Coconuts can boost thyroid function by up to 20%, which is important for metabolism and energy production. Coconuts are very high in saturated fat, however, which increases the risk for certain diseases, heart attack, stroke, narrowed arteries, and obesity. Various governmental agencies, including the United States Food and Drug Administration, recommend against the consumption of significant amounts of coconut oil due to its high levels of saturated fat.

Eggs, like dairy ingredients, are another important ingredient in all baked products. Finding a good egg substitute is a challenge as many egg substitutes do not have the same components in eggs. Thus, the baking, binding, the rise in the product, and texture cannot be truly replicated.

Despite their importance in baking, eggs do not have a reputation as the healthiest ingredient for our bodies. One egg has about 213 mg of cholesterol, which causes an estimated one-fourth of Americans to avoid eggs. Nevertheless, Americans annually eat 257 eggs each, according to the U.S. Department of Apiculture. Eggs have been recalled many times due to salmonella contamination. According to the Centers for Disease Control and Prevention (CDC), raw or undercooked eggs are responsible for more than 118,000 cases of salmonella poisoning annually, and many cases presumably go unreported or undiagnosed.

Eggs also contain much sulfur, which strains the liver and kidneys and tends to acidify the blood. The body performs best in a slightly alkaline environment, so the body regains its alkalinity by mobilizing alkaline (base) minerals, such as calcium and magnesium, to buffer the acidity. These two minerals are normally stored in bones, and their mobilization can contribute to diseases such as osteoporosis.

### The Roles of Ingredients in Traditional Baking

The most common baking ingredients in nearly every baked product include flour, milk, eggs, butter or shortening, baking powder, baking soda, sugar, salt, and yeast. As discussed above, wheat flour, milk, eggs, and butter are major allergens and have various undesirable characteristics, such as being rich in saturated fats. Finding adequate substitutions for these ingredients is difficult, because each ingredient has a unique function that cannot easily be replicated to maintain the same texture, rise, color, taste, and smell.

In general, baking ingredients can be divided into two types, tougheners/strengtheners (e.g., flour and eggs) and tenderizers/weakeners (e.g., sugar and fat), which sometimes overlap. For a recipe to bake with all of the qualities we like, such as being tender, fluffy, moist, chewy, dense, etc, there needs to be a balance between the two. If one is increased, the other must be decreased, but there is more to it than that. Recipes also vary by the amounts of each ingredient and the mixing techniques used to combine them. Professional bakers use bakers' percentages to express the relationship of one ingredient to another, whereas home bakers use recipes with ingredient amounts. Cooking temperatures and times also affect the final baked good. These relationships affect the color, flavor, texture, shape, and volume.

Wheat flour, present in allergen-containing food compositions, can perform multiple functions: thickening, binding, adding, flavor, changing texture, and absorbing moisture. Two proteins found in wheat flour, glutenin and gliadin, form an elastic substance known as gluten when stirred with moisture. There are as many as 30 different types of protein in wheat, but only these two proteins have gluten-forming potential. No single alternative to Wheat flour can do all these things in the same way as wheat flour. Other grains like corn and oats, and therefore products like cornmeal and oatmeal, do not provide gluten. They provide only flavor and bulk, so the functions of gluten must be provided by other components.

When wheat flour is moistened and manipulated through stirring, beating, kneading, and/or handling, glutenin and gliadin gab water and connect and cross-connect to form elastic gluten strands. If a flour has a lot of these proteins, it grabs up water faster, making strong and springy gluten. The elastic gluten network serves many functions in allergen-containing recipes. Like a net, gluten traps and holds air bubbles, which later expand from the gas from the leavening upon baking, causing the dough or batter to rise. During baking, the stretched gluten becomes rigid as the moisture evaporates from the heat of the oven, and sets the baked goods' structure. The viscoelastic properties of gluten thus provide an advantageous combination of elasticity and rigidity by expanding with the gas while still holding its shape. No other grain has been able to replace this function of wheat in baking.

A traditional flour's strength is determined by mixing, as well as gluten. Both work in concert together. If a batter or dough is mixed too much, the product texture toughens; mixed too little and the product fails. If the gluten is too strong for a recipe, it toughens and may not rise. If there is too little gluten, the recipe will collapse when taken from the oven or be mushy. If there is the right amount of gluten, but the batter or dough is stirred too much, the recipe will be tough and dry. So when one flour type is substituted for another, the recipe is always affected, no matter how much or little the batter or dough is stirred.

Liquid in a traditional, allergen-containing recipe is usually supplied by cow milk and eggs, which are both major food allergens. The amount of liquid determines whether a dough or batter is produced. Liquids also serve to hydrate the flour for gluten formation and to hydrate the starch for gelatinizing, which affect the basic structure of the baked product. Liquids also dissolve the sugar and salt, making possible the leavening action of baking powder, soda and acid, or yeast. Liquids contribute moistness to the texture and improve the taste of baked products. When water vaporizes in a batter or dough, the steam expands the air cells, increasing the final volume of the product. In addition to water, milk contains fats and proteins, which contribute valuable nutrients to baked goods. Milk also helps browning to occur and adds flavor. Dairy products also add flavor and moisture to baked foods, and help to promote browning.

The three basic leavening gases commonly found in baking recipes are (1) air from whipped eggs, or beating, stirring, creaming, and kneading; (2) water vapor or steam from liquids; and (3) carbon dioxide from chemical leaveners, baking soda and baking powder, and yeast, both packaged or from a starter (sourdough or sponge). In many baked items, all three of these agents participate in the leavening process.

A leavening agent provides a source of gas to the recipe. When moistened, fermented and/or heated, water vapor and/or carbon dioxide expand the millions of air bubbles previously created in a batter or dough from mixing, creaming, beating, folding, whipping, and kneading, which are trapped in the gluten framework. If the batter is over mixed or not baked promptly, the gas will escape and the final recipe will have poor texture and low volume. While some baked products are still unleavened, such as pie crusts, Mexican tortillas, and the similar chapatis from India, many recipes require leavening which is central to both their taste and texture.

Some air is always incorporated into a dough or batter during mixing. Although trapped air is usually not the major leaven, it plays an important role. Beaten eggs aerate recipes due to their ability to foam and by contributing water for steam, such as with sponge or angel food cakes. A foam is created by incorporating air into a mixture through beating. Whole eggs, egg whites or egg yolks can each be beaten into a foam, with egg whites having the potential of producing the most trapped air. Air is also incorporated into cakes when fat and sugar are beaten together. The leavening source used in a baked product may serve to produce gas by physical, chemical or biological methods. The leavening selected usually depends on the balance and kind of ingredients in the recipe and the mixing and kneading methods used.

Steam is produced when water in the recipe is heated by baking. Most batter recipes are to some degree leavened by steam. To get maximum steam production in a system, a 1:1 ratio of liquid to flour is needed. As the amount of water relative to flour decreases, less leavening from steam occurs. In steam-leavened products, the changes that occur in the volume occur at the end of the baking cycle. Popovers are a good example of the rapid volume expansion which leavens a product late in the baking period.

Chemical leaveners include baking soda (bicarbonate of soda) which produces carbon dioxide gas when moistened and/or heated. The pH of the baked product is affected by the leavener. Alkaline leaveners contact acidic ingredients like applesauce, buttermilk, honey, brown sugar, molasses, and lemon juice to create carbon dioxide. In some recipes, depending on the quantity of acidic ingredients included, a combination of baking soda and baking powder may be used for better flavor and texture.

Baking powder, another chemical leavener, does not need an acidic ingredient to release its leavening power. Double-acting baking powder begins releasing carbon dioxide as soon as it is moistened, and again when heated in the oven. If there is not enough acid, color and flavor changes may appear.

Eggs are binders which help hold all the ingredients together. Eggs also contribute liquid to a recipe and thus serve as a toughener, especially the egg white portion. But too many egg whites, as in a reduced-fat cake recipe, can make a recipe dry. Including at least one whole egg helps to tenderize the recipe. Eggs can act as leaveners, especially when egg whites are beaten separately. Eggs also contribute to the structure of a baked product through contributing heat denatured proteins, steam for leavening, or moisture for starch gelatinization. Egg yolk is also a rich source of emulsifying agents due to its lecithin content. Eggs thus facilitate the incorporation of air, inhibit starch gelatinization, and contribute to flavor.

Most bakers are very familiar with traditional shorteners, such as butter, margarine, or vegetable shortening. Shorteners coat the flour proteins or water-proof them, contributing to a tender baking recipe by reducing the contact between flour proteins and moisture in the recipe and preventing gluten from forming. Shorteners also shorten the length of the gluten strands when the flour is stirred with moisture (hence their name), thereby making the product more tender. When a shortener is removed or reduced, it increases the chances that the end product will lack flavor and be tough and full of tunnels.

Fat in the shortener coats the flour particles so the elastic formation slows down, makes the gluten strands slippery so the gas bubbles can move easily, and gives the final recipe a finer gain. Generally, when people refer to “moist” in a baked product, they are referring to its fat content. Different types of fat do different jobs in baking. The most common shortener is butter. A well-known baking fat, butter makes a very important flavor and aroma contribution. Butter can be substituted a butter-margarine blend in diets with reduced saturated fats, but margarine does not have as fine a texture and taste. Fat can be found in other baking ingredients, such as the egg yolk, which serves as both a tenderizer and emulsifier due to its fat and lecithin content. Oils do not act as a shortener, because it is a liquid and will not cream with crystalline sugar in the same way that solid fat. Oils also tend to coat each particle of flour, which causes a lack of contact of moisture and helps prevent gluten development. Oils reduce dryness and enhance flavor. Oils, however, have the same amount of calories and fat as butter, even though oils have less saturated fat.

Sugar combined with yeast is essential in traditional bread making. In small amounts, added sugar helps yeast begin producing gas for raising yeast dough. Sugar in large amounts slows yeast fermentation; in a very sweet dough the rising time is longer. During the mixing phase, sugar absorbs a high proportion of water, delaying gluten formation. The delayed gluten formation makes the bread dough's elasticity ideal for trapping gases and forming a good structure. Sugar contributes to the brown crust and delicious aromatic odor of bread. Also, some of the yeast fermentation by-products and proteins from the flour react with sugar contributing to bread's color and flavor.

Salt is also necessary in traditional baking. Salt not only sharpens brightens the flavor in baked products and helps prevent staleness, it promotes gluten structure and even browning. But the most important baking purpose of salt is to slow the rise of yeasted baked products, leading to an even, stable texture.

Yeast, used in traditional bread baking, is either packaged or created through a sourdough or sponge starter. Yeast, a single-celled live organism, feeds off of the flour's starches and sugars, fermenting them to carbon dioxide and ethanol (alcohol). Carbon dioxide is the primary leavening gas that makes yeast breads rise. The alcohol evaporates during baking, leaving behind flavor.

### Problems in Replacing Food Allergens in Baking

In the Western world, leavened bread has been a staple food for many centuries. Today, Western-style bread is consumed all over the world. Healthy, gluten-free bread requires the use of flour from gluten-free grains, such as rice, sorghum, buckwheat, amaranth, or bean flour. These ingredients contribute to fiber, protein, vitamins, and minerals. The drawback is that the resulting bread is less fluffy. As a compromise, isolated starches, such as potato starch and tapioca starch, often are mixed in. Gluten-free baked products are best using varied flours for better texture. However, some flours may have a grainy taste (e.g., amaranth flour) or pungent smell (e.g., bean flour), or the flour may leave specks (e.g., sorghum flour).

There are other problems associated with gluten-free baking. Gluten-free dough is heavy and dense and lacks the stability of wheat dough. Gluten-free dough also tends to be runnier than wheat dough. Many gluten-free recipes may not work for a number of reasons. Flours from different manufacturers may differ considerably in particle size, protein content, starch properties, etc. Flours may be labeled in the same way, e.g. brown rice flour, but they may react completely differently. The amount of water thus may need to be adapted, or the brand of gluten-free flour may need to be changed.

Additives are another possible source of problems with gluten-free baking. The amount of additives, e.g., gum, can vary substantially from one recipe to another. Exemplary gums include guar gum, xanthan gum, agar-agar gum, gelatin, cellulose, pectin, and locust bean gum. Any gum must be tested and mixed very well with the other dry ingredients.

What works in traditional baking often does not work in gluten-free baking. For example, gluten-free cookies can become one giant cookie because they spread during baking. Cakes cook differently and may not get quite done in the center, yet the edges will be very done. Gluten-free baked products brown prematurely on the outside before fully cooked on the inside. Gluten-free cakes and breads may rise, then fall as they cool. They often are too wet and not fully cooked in the center. If the dough is not moist enough, however, it will not rise well. So while regular bread dough benefits from rising twice, it seems to work better to let gluten-free bread dough rise only once before baking it. Gluten-free dough also can be too dry (i.e., too much flour to liquid), causing the gluten-free recipe to be too crumbly. And if there are no preservatives in the bread, the gluten-free products can dry out and get stale quickly. If there is too much yeast or baking powder, large air pockets form in gluten-free cakes and bread. And if there is too little liquid or yeast, the result is an exterior rough, rocky surface. Gluten-free batter and dough also can be gummier and stickier. Gluten-free baked items need more leavening, so baking powder and baking soda are often increased. However, baking soda is alkaline and will react with acid ingredients in buttermilk, sour cream, yogurt, bananas, cocoa, and vinegars in a batter. Other ingredients, such as vanilla and other spices, may need to be increased for the best, full flavor in gluten-free baked good. Finally, bread machines and quick rise yeast are not always conducive for gluten-free baking recipes.

Another problem with gluten-free foods is associated with milk. Milk sugar (lactose) cannot be broken down when the intestine is severely damaged by untreated celiac disease. Lactose remains intact, is not absorbed, and causes bloating and/or diarrhea. Once a person is on a gluten-free diet and their intestine is healed, they usually can absorb and thus tolerate lactose again. Newly diagnosed celiac patients thus might prefer gluten-free bread without milk.

Butter is another allergen that must be substituted in allergen-free baking. Butter is a main ingredient in almost all traditional baking recipes, e.g., breads, brownies, cakes, cookies, cupcakes, quick breads, and most other baked products. In most recipes for cakes, cupcakes, and quick breads, the process of creaming butter with granulated sugar is extremely important to achieving the even-rising, rich, spongy texture that is so definitive of these products. During the 3-5 minutes of beating the sugar into the butter (“creaming”), the sugar granules cut into the butter and aerate the dense fat to give cakes a rich texture and flavor. Substituting butter for oil is not a true substitute in baking, because the oils will not cream with sugar to produce the same aeration. Oils thus generally work best in recipes that use liquid sugars such as honey, maple syrup, molasses or other syrups along with baking agents.

Many dairy-free substitutions call for soy based ingredients, e.g., vegan margarine, in recipes. Vegan margarine is a nondairy substitute for butter, but contains soy, another common allergen. Cream, yogurt, and cheese all made from cow's milk are often substituted for soy based ingredients in dairy free products; however, both dairy and soy are major food allergens. Other dairy substitutions include butter, yogurt, and milks made from rice and coconut. In these cases the substitution is not exact, and the substitution percentages need to be tested and adjusted for the best and optimal result. Some claim that ghee is a dairy substitute; however, ghee it is not an option in allergen-free baking. Ghee is a clarified butter, and it may contain sufficient proteins from butter to induce an allergic reaction.

Fats, like oils, butter, and shortening, add texture, moisture, and flavor to bread. Fats in baked goods delay the process of moisture loss that causes baked goods to go stale. Fats also help produce the fluffiness in baked goods. Many different types of oils are available. Each type of oil provides its own distinct taste, health benefits, and different resistance to heat. Butter and/or coconut oil (a tree nut), or a combination of the two, are the best types of fats to use in baking. Both, however, are major food allergens. Vegetable oil is made from soybeans and likewise cannot be used in allergen-free baking.

Acceptable substitutes for allergens like butter include olive oil, canola oil, and safflower oil. Olive oil is an antioxidant, which generally have a host of beneficial effects from lowering cholesterol, lowering blood pressure, and reducing the risk of coronary disease. Olive oil dramatically cuts back on the cholesterol and saturated fat content of desserts. It produces lighter tasting baked products and allows the flavor of the other ingredients to come forth. Because olive oil contains vitamin E, it helps to naturally maintain the freshness of baked products and creates moist cakes, biscuits, and muffins. Olive oil would be the slightly healthier choice in many baked products, but it will add a different flavor that does not work as well unless the desired result is a savory pancake, more like a crepe.

Safflower oil, which is made from the seeds of a hybrid variety of the rapeseed plant is slightly different from canola oil. Safflower oil, like canola oil, has a very mild taste. They can both be used in cooking without interfering with the flavors of the other foods. Safflower oil has a smoke point of 450° F., while canola has a smoke point of 400° F. They both are good for high heat cooking, but safflower will do better in high-heat situations, such as when using a wok.

Eggs are the most difficult and problematic ingredient to replace in allergen-free baking. There is a chemistry to baking that allows very little room for improvisation, unlike cooking, which allows mixing different ingredients and sampling the result along the way. With baking, each ingredient in the recipe plays an integral role to the success of the final product, most especially with the ingredient eggs. In every case, there is no true substitute that reacts exactly the same as eggs, from the moisture content, ability to act as a binder, leavener, and protein source. For example, tofu (which contains soy, a major food allergen) contains sufficient protein and will not alter the flavor of the recipe, but it produces a much heavier, denser, and thicker texture. Tofu does not work well as an egg substitute in brownies, pancakes, and cakes, for example, which need to be lighter and fluffier.

Flaxseed powder is another gluten-free egg substitute. When ground flaxseed is whisked together with water, it creates a lightly thick liquid very similar to whisked egg's consistency. But unlike tofu, flaxseed has a distinct flavor; baked products with added flaxseed taste nuttier and denser than usual. Those qualities are best used in cornbread, but not in cakes and cookies. Other egg substitutes include a half a banana for ¼ cup applesauce. Bananas and applesauce add the same amount of thick moisture as eggs, but they will not help baked items rise and turn out light and fluffy. A mixture of vinegar and baking soda create ample leavening in baked products and create a light fluffy texture. However, too much baking soda and too much vinegar give the food a bitter taste. For recipes requiring more than one egg, vinegar and baking soda are not a good egg substitute. Generally, when recipes call for more than one egg, eggs fulfill more than one role, such as a leavening agent and binder. But using egg substitutes in recipes that call for more two eggs do not respond well to that many ingredient substitutions.

### Binders, Thickeners, and Gelling Agents

Food binders act as thickeners and are necessary in baking. Gluten is one such binder, so gluten-free breads require polymeric substances that mimic the viscolelastic properties of gluten. Binders are based on either polysaccharides (e.g., starches, vegetable gums, and pectin) or proteins. Starches included arrowroot, cornstarch, katakuri starch, potato starch, sago, and tapioca starch (tapioca flour means the same as tapioca starch). Different thickeners may be more or less suitable in a given application, due to differences in taste, clarity, and their responses to chemical and physical conditions. For example, for acidic foods, arrowroot is generally considered a better choice than cornstarch, which loses thickening potency in acidic mixtures. Below pH4.5 guar gum has sharply reduced aqueous solubility, thus also reducing its thickening capability. If the food is to be frozen, tapioca or arrowroot are generally considered preferable over cornstarch. Baked products that are frozen after being fully cooked will turn spongy when frozen. Freezing causes cornstarch thickened foods to thin out, so foods thickened with cornstarch are generally frozen before baking.

Many thickening agents require extra care in cooking. Some starches lose their thickening quality when cooked for too long or at too high a temperature; on the other hand, undercooked starches may have an unpleasant starchy taste or cause water to seep out of the finished product after cooling. Also, higher viscosity causes foods to burn more easily during cooking. As an alternative to adding more thickener, recipes may call for reduction of the food's water content by lengthy simmering. When cooking, it is generally better to add thickener cautiously; however, if over-thickened more water may be added, but loss of flavor and texture may result.

Gelling agents, e.g., jellies, desserts and candies, are food additives used to thicken and stabilize various foods. Gelling agents provide the foods with texture through formation of a gel. Some stabilizers and thickening agents are also gelling agents. Typical gelling agents include natural gums, starches, pectins, agar-agar, and gelatin. Often they are based on polysaccharides or proteins. Proteins used as food thickeners include collagen, egg whites, furcellaran, and gelatin.

The Food Additives Council include the following list of (gluten-free) food gums that have binding properties similar to eggs: agar-agar, carrageenan, cassia, cellulose gum, gellan gum, guar gum, hydroxypropyl cellulose, konjac, locust bean guru, methylcellulose or hydroxypropyl methylcellulose, pectin, and xanthan gum. They act as thickening agents; however, substituting eggs for any one of these gum ingredients will result in a heavier, thicker product that may have a gummy texture. Few people will want to eat a gelatin-like cookie, for example. Many of these gums thus are best used in jams and jellies.

Methylcellulose and hydroxypropyl methylcellulose have been used as a gluten replacement in gluten-free bread. The purpose of methylcellulose in as a gluten-free replacement can prevent collapsing, increase moisture, and control the crumb structure. Methylcellulose is a chemical compound derived from cellulose. It is a hydrophilic white powder in pure form and dissolves in cold (but not in hot) water, forming a clear viscous solution or gel. With any baked product using methylcellulose or hydroxypropyl methylcellulose, the product will becoming more firm. Methylcellulose is an affective binder that works best in bread with higher temperatures and longer cooking time. Using methylcellulose in other products, however, can produce an undesirable texture in the final product. When using this ingredient in cakes and cookies, the product may continue to gel and become very chewy even after it is cooled. Within minutes to hours, a good cookie taken out of the oven may turn into a chewy, gummy cookie. Similarly, pancakes may become too chewy over several hours after being baked.

### Controlling Moisture and pH

When eggs are removed, other sources of liquid and ingredients that hold moisture must be used. Olive oil, for example, will prevent bread and pizza from drying out too quickly. Sugar holds moisture, as well as reacts to yeast. Other sweeteners, such as honey, can be used (although honey is not considered vegan). Molasses, a by-product of refined sugar production, is made up of sucrose, glucose and fructose as well as small amounts of Vitamin B, calcium and iron. It is not as sweet as sugar and imparts a dark color and stronger flavor to baked foods. Molasses produces moist baked goods and provides a wonderful taste and aroma in breads. Maple syrup, the sumptuous liquid most famous for sweetening hotcakes, waffles, and French toast, is also very good when baked into cookies, pies, and cakes. Grade B maple syrup has a vibrant flavor conducive to eliciting exquisitely baked products.

Insufficient moisture is a common problem in gluten-free baking, and with allergen-free foods the problem is worse. Milk and eggs provide much of the necessary moisture for baked products to hold together and bake correctly. When these major food allergens are absent, the following ingredients, for example, can aid in adding moisture: powdered ascorbic acid (vitamin C) to dry ingredients, mayonnaise (although it contains eggs), light or full flavor olive oil, fruit pectin, and modified tapioca starch. In allergen-free baking, cooking times and water content may vary depending on humidity. For example, locations with higher humidity may require more water and longer cooking times.

Having the right combination of alkaline and acidic ingredients also is necessary in baking. Baking powder and/or baking soda is used as leavening in many recipes. Baking soda helps neutralize acidic ingredients. Baking powder and baking soda are not interchangeable, and there is no substitution for baking soda. Baking soda (sodium bicarbonate) is used as a leavening agent when a recipe contains acidic ingredients. Baking soda, an alkaline ingredient, form carbon dioxide gas in the presence of an acidic ingredient to cause a baked product to rise and become light and porous. For example, buttermilk is acidic and releases gas when used with baking soda. If buttermilk is substituted with regular milk, the biscuits may not rise. Heat is not necessary for the chemical reaction, so the reaction begins as soon as liquid ingredients are added. Therefore, products leavened with baking soda should be baked immediately after mixing or the gases will escape and the product will not rise. Without both baking soda and baking powder with another leavener like yeast or beaten egg whites, all of the breads and cakes would be very flat and dense.

Allergen-free products must have acceptable texture, rise, color, and taste. The Maillard reaction, a non-enzymatic browning caused by a heat-induced chemical reaction, results in the production of flavors, so it is extremely important to the final color and taste of the baked product. The Maillard reaction can be accelerated by high temperature, low moisture, and alkaline conditions, which may lead to an unacceptable and possibly toxic over-browning and a hard, unappealing texture. See, e.g., “Maillard reaction,” at hypertext transfer protocol en.wikipedia.org/wiki/Maillard_reaction. The rate of the Maillard reaction can be easily controlled in gluten-free products, where milk and eggs, for example, can be used to balance alkalinity and moisture. The Maillard reaction, however, is much more difficult to control with allergen-free products. Allergen-free bread is especially problematic, because of higher temperature and longer baking time to achieve a desired rise. An allergen-free bread thus might become dark brown throughout the bread, and have a hard texture, once baked sufficiently. Further, the final product must not be too acidic so that yeast can be activated, but it must not be too moist or alkaline to avoid accelerating the Maillard reaction, and it must contain sufficient sugar and moisture to achieve an acceptable rise, volume, and texture. Simply adding baking powder and/or baking soda is insufficient to overcome this problem. A successful baked product must achieve an acceptable balance between the Maillard reaction and moisture, texture, and rise in the final product. Also, simply increasing the amount of water will only worsen this effect, because the rate of the Maillard reaction increases as the water activity increases. In cooking, low moisture levels are necessary mainly because water boils into steam at 212° F. (100° C.), whereas the Maillard reaction happens noticeably around 310° F. (154° C.); significant browning of food does not occur until all surface water is vaporized. The compositions and methods disclosed below solve the problems associated with the Maillard reaction.

### Allergen-Free Baking Solutions

Wheat flour contains gluten and must be replaced with a combination of gluten-free flours. There are several options available, but not every gluten-free flour or gluten-free flour combination will produce the desired result. Heat intensifies tastes and smells sometimes not in a good way. Bean flours give off a pungent taste and smell, to which Americans are unaccustomed. Quinoa may be described as having a nutty flavor, but in baked products, the resulting flavor may be too intense to be desirable. Using sorghum flour results in cakes having many small specks. Teff and amaranth will produce dark and often gray colored cake. (For birthdays or weddings, no one wants to eat a gray cake that is supposed to brilliant white.)

A combination of gluten-free flours may be necessary. White rice flour can be selected as the main ingredient because it is white, tasteless, and odorless. Rice can make a product sticky, but a sticky gluten-free dough works best. A smaller amount of brown rice flour can be used to create a product with a different consistency. Brown rice flour is heavier than white rice flour. It is milled from unpolished brown rice, so it has a higher nutritional value than white rice flour, and it contains it has a higher fiber content. This also gives brown rice flour a noticeable grainy texture. Brown rice flour has a slightly nutty taste, which will sometimes come out in recipes depending on the other ingredients. The grainy texture will also contribute to a heavier product than recipes made with white rice flour. Brown rice flour is not often used completely on its own because of its heavier nature. The color of brown rice is darker than white rice, and the baking result will produce a darker food product.

A small amount of potato flour can be used in some formulations to balance other gluten-free gains. Potato flour should not be confused with potato starch flour. Potato flour has a stronger potato flavor. It is also a heavy flour, so a little goes a long way. Bulk buying is not recommended, unless you are using it on a very regular basis for a variety of recipes as it does not have a very long shelf life.

Potato starch, tapioca starch, cornstarch, and arrowroot are good starch options. Cornstarch typically works the best among these starches in allergen-free compositions. Cornstarch in particular provides protein without gluten and is regarded as safe for people with celiac disease. Starch and gums may be used to bind the ingredients together in the absence of gluten. As noted above, gluten in traditional recipes thickens dough and batters and traps air bubbles to make baked goods light and fluffy. Xanthan gum tends to help starches combine to trap air, while guar gum helps keep large particles suspended in the mix. Xanthan gum reacts better than guar gum (a similar gum) in baked products, while guar gum works better in cold products, such as ice cream and pastry fillings. Xanthan gum may be combined with cornstarch in allergen-free products. Cornstarch is made from the endosperm of the corn kernel. Cornstarch is a leavener, absorbs moisture, and prevents the baking soda and acid from reacting with other ingredients too soon.

With the removal of gluten in allergen-free baking, alternative sources of protein can be used to ensure that the food product is healthy and provides a balanced diet. In allergen-free baking, it is important to find good protein sources and insure that they interact well with the other ingredients in the mix. Rice milk is a good example of such a protein source. Rice milk additionally acts as a binder and a source of a small amount of fat, both important functions in allergen-free baking. Rice milk also can substitute for cow's milk. Rice milk performs the same functions, whether in powder or liquid form. Original rice milk is not flavored and is tasteless. It produces a similar result to regular milk, but is less heavy, very low in fat, and cholesterol free. Rice milk in fact is the healthiest of the milks, because it is cholesterol free and still provides a very small amount of protein and fat important for allergen-free baking.

Olive oil may be used in pizzas and breads for its health benefits, flavor, and ability to moisten and keep the bread dough together. Many people enjoy the taste and aroma of olive oil in these baked products. Canola oil may be used for pancakes, waffles, and crêpes for its ability to moisten and keep the final products light. Safflower oil also can be used, but canola oil is preferred for these products.

Dairy-free, soy-free butter can be used in the cookie compositions. The primary ingredient of one exemplary soy-free buttery spread is a natural blend of palm oil, canola, safflower, and olive oil. Butter, in contrast to oil, works the best in cookies because of its consistency. Using oil instead of butter (or shortening) in cookies produces an undesirable oily and flat result. Margarine works just as well in allergen-free cookies, but some margarines use soy in their products. Check the ingredients carefully for the use of soy in allergen-free products. Soy-free shortening also can be used in cakes and pie crust compositions for its great ability to produce fluffy and flaky products. Soy-free shortening does not contain soy, which is the ingredient used in vegetable shortening. Soy-free shortening comes from mechanically pressed palm oil.

Sugar, salt, baking powder and/or baking soda remain important ingredients in allergen-free compositions, as in all baking recipes. One or both can be used in the disclosed compositions. The benefit obtained is the rise in allergen-free baked products. Finding the right percentages of each is important in allergen baking. Using too much or too little will throw off the combination of alkaline to acidic ingredients in the mix and detract from the final result. And using too much baking soda will produce a highly bitter taste.

As mentioned previously, eggs cannot be substituted nor replicated exactingly in baking. There is no true substitute for eggs. In some bread compositions, the combination of rice milk, xanthan gum, baking powder, baking soda, cornstarch, and methylcellulose functions as if eggs were present. The result is a light, fluffy, great tasting product with excellent volume and texture. Each ingredient serves several functions, but it is the unique combination and relative amounts of each that produce the desired result.

The mixes can be “shelf stable.” “Shelf stable” food would normally be stored refrigerated but has been processed so that it can be safely stored in a sealed container at room or ambient temperature. Once baked, these products are best served within 1-3 days. The final baked products can be refrigerated, but the result is a firmer texture. Products should not be frozen, if they contain cornstarch in the compositions.

Accordingly, the present disclosure provides allergen-free flours, dough, and baked products made without eggs or any other major food allergen. Also provided are food compositions, where multiple food allergens are replaced. The disclosed baked products have a flavor, moisture, texture, protein, nutrient content, and structure comparable to traditional baked products.

The disclosed allergen-free flours, dough, and batters overcome the various problems associated with allergen-free baking by appropriate adjustment of the relative amounts of various components that contribute moisture, alkalinity, texture, etc., to the final product. Baked products produced using the allergen-free flours thus have a moistness, springiness, rise, texture, and flavor comparable to products containing major food allergens. When major food allergens are removed, the amounts of other ingredients, e.g., flour, protein, oil, starch, sugar, gum, and water, and the preparing conditions, e.g., the temperature and duration of baking, are adjusted to reach a desirable balance. For example, in the disclosed baked products, an acceptable texture can be coupled with an appropriate amount browning.

The present baked products are a healthy alternative to foods containing food allergens. The disclosed baked products advantageously are low-fat. Indeed, in some embodiments, the food compositions are cholesterol-free. The disclosed baked products further provide a sufficient nutritive content to be used regularly in an allergen-free or reduced allergen diet. The disclosed baked products thus can be used as part of a diet requiring the complete removal of all or multiple major food allergens. Alternatively, the baked products can be used in a diet where the intake of major food allergens is reduced.

Baked products according to the disclosure run the entire range of products included in a normal diet, including, but not limited to, cookies (e.g., chocolate chunk/chip cookies), cakes (e.g., cupcakes), muffins, pancakes, waffles, pizza crust, pie crust, and bread products. The packaging size for the described allergen-free compositions is not limited. For example, the allergen-free compositions may have a package size of about 1 pound for retail or 50 pounds (or more) for whole sale.

### 1. First Flour Composition:

Accordingly, allergen-free flours include a first flour composition. The first flour composition comprises the following components added in the indicated number of parts (by weight):

| | | | |
|---|---|---|---|
| (1) | tapioca starch and/or tapioca flour: | 0.450 | parts; |
| (2) | potato starch: | 0.270 | parts; |
| (3) | brown rice flour and/or white rice flour: | 0.300 | parts; |
| (4) | potato flour: | 0.150 | parts; |
| (6) | teff flour and/or sorghum flour: | 0.100 | parts; |
| (7) | pea protein and/or rice protein (plain): | 0.100 | parts; and |
| (8) | gum: | 0.0130 | parts, |

wherein the indicated parts may vary by up to ±5 percent. In one embodiment, the tapioca starch and/or tapioca flour component may be all tapioca starch. In another embodiment, the brown rice flour and/or white rice flour component may contain brown rice flour to white rice flour at a 2:1 ratio of for optimal color of the baked goods. The first flour composition may be used for making allergen-free cookies (e.g., chocolate chunk/chip cookies), cakes (e.g., vanilla cake, chocolate cake, coconut cake, lemon cake), cupcakes (e.g., vanilla and chocolate cupcakes), and muffins (e.g., apple, banana, blueberry, berry, carrot raisin, chocolate chip, cinnamon sugar, dried cranberry apple, poppy seed, pumpkin raisin, tropical, and zucchini muffins), for example.

A cookie mix may comprise the following components added in the indicated number of parts (by weight):

| | | | |
|---|---|---|---|
| (a) | first flour composition: | 0.661 | parts; |
| (b) | baking soda: | 0.0122 | parts; |
| (c) | salt: | about 0.0147 | parts; |
| (d) | pure vanilla powder: | 0.00625 | parts; |
| (e) | sugar: | 0.377 | parts; and |
| (f) | brown sugar: | 0.270 | parts, |

wherein the indicated parts may vary by up to ±5 percent. A chocolate chunk/chip cookie dough may comprise the following components added in the indicated number of parts (by weight):

| | | | |
|---|---|---|---|
| (i) | cookie mix: | 1.341 | parts; |
| (ii) | dairy- and soy-free chocolate chunks/chips | 0.300-0.756 | parts; |
| | or chunks: | | |
| (iii) | dairy-free, soy-free butter or margarine: | 0.493 | parts; and |
| (iv) | egg substitute: | 0.267 | parts, |

wherein the egg substitute is 0.0900 parts ground flax (regular flax or golden flax) mixed with 0.177 parts water, and wherein the indicated parts may vary by up to ±5 percent. The dough requires no eggs and no additional water. When 1 part by weight=1 pound, the chocolate chunk/chip cookie dough makes about 4 dozen cookies.

A method of making a cookie dough may comprise: (1) beating the dairy-free, soy-free butter or margarine with the ground flax and water to form an egg substitute and; (2) blending the egg substitute with the cookie mix and the dairy- and soy-free chocolate chunks/chips or chunks to form a cookie dough, wherein step (2) is conducted without a hand mixer. In one embodiment, the method is conducted at high altitude without changes. In another embodiment, the cookie dough may be refrigerated. Also provided is a method of making cookies comprising baking the cookies at 325° F. for 10-15 minutes or until golden brown to produce a batch of cookies. Also provided are allergen-free cookies made by the disclosed method.

A cake mix may comprise the following components at the indicated added in the indicated number of parts (by weight):

| | | | |
|---|---|---|---|
| (a) | first flour composition: | 0.610 | parts; |
| (b) | sugar: | 0.580 | parts; |
| (c) | powder or liquid rice milk base: | 0.0877 | parts; |
| (d) | baking powder: | 0.0328 | parts; |
| (e) | salt: | about 0.0081 | parts; |
| (f) | cream of tartar: | 0.0078 | parts; |
| (g) | pure vanilla extract or powder: | 0.00625 | parts; and |
| (h′) | dextrose and/or titanium dioxide: | 0.0050 | parts; or |
| (h″) | cocoa powder: | 0.070 | parts, |

wherein the indicated parts may vary by up to ±5 percent. The cake having 0.0050 parts dextrose and/or titanium dioxide component h′) is a vanilla cake, and the cake having 0.070 parts cocoa powder (i.e., component h″) is a chocolate cake. A cake batter may comprise the following components at the indicated relative parts (weight):

| | | | |
|---|---|---|---|
| (i′) | vanilla cake mix: | 1.338 | parts; or |
| (i″) | chocolate cake mix: | 1.406 | parts; and |
| (ii) | all soy-free shortening | 0.178 | parts; |
| (iii) | egg substitute: | 0.267 | parts; and |
| (iv) | water: | 0.523 | parts, |

wherein the indicated parts may vary by up to ±5 percent. The cake batter requires no eggs. When 1 part=1 pound, the batter makes one layer cake. In one embodiment, the cake batter is refrigerated.

Rice milk can be obtained in powdered and liquid form, “Powder rice milk” is used in the composition above and in other compositions disclosed below. Powdered rice milk is a composition including rice syrup powder, rice starch, and rice flour. “Liquid rice milk” can be used in place of powdered rice milk and will produce the same result.

A method of making a cake batter may comprise: (1) beating the soy-free shortening, egg substitute, and water; and (2) beating in the cake mix to produce a cake batter. In another embodiment, a method of making a cake product comprises baking the batter at 300° F. for 35-40 minutes or until baked through to produce a cake product. In one embodiment, the method is conducted at high altitude without changes. Also provided are allergen-free cakes (e.g., vanilla cake, chocolate cake, cupcakes) made by the presently disclosed method.

In one embodiment, the method of using the batter further comprises adding ¼ tsp coconut butter (where 1 part=1 pound) to make a coconut cake batter. In another embodiment, a method of making the batter comprises replacing ½ cup of the water in the cake batter with ½ cup lemon juice (where 1 part=1 pound). In this embodiment, 1 TBSP grated lemon zest may be added to make a lemon cake batter. In another embodiment, the allergen-free cake product is a cupcake, and the method comprises baking at 300° F. until baked through, wherein the duration of baking may be 20-25 minutes.

A muffin mix may comprise the following components at the indicated relative parts (weight):

| | | | |
|---|---|---|---|
| (a) | first flour composition: | 0.517 | parts; |
| (b) | baking powder: | 0.032 | parts; |
| (c) | salt: | about 0.016 | parts; |
| (d) | sugar: | 0.126 | parts; and |
| (e) | powdered or liquid rice milk base: | 0.535 | parts, |

wherein the indicated parts may vary by up to ±5 percent. A muffin batter may comprise the following components at the indicated relative parts (weight):

| | | | |
|---|---|---|---|
| (i) | muffin mix: | 1.226 | parts; |
| (ii) | egg substitute: | 0.267 | parts; |
| (iii) | oil: | 0.295 | parts; and |
| (iv) | water: | 0.78 | parts, |

wherein the indicated parts may vary by up to ±5 percent. In an apple muffin batter, the component (iv) water can be replaced with applesauce or apple juice, and the batter further comprises apples (e.g., shredded). In other muffin batters, additional ingredients may be added as appropriate to make batters for allergen-free banana muffins, blueberry muffins, berry muffins, carrot raisin muffins, chocolate chip muffins, cinnamon sugar muffins, dried cranberry muffins, poppy seed muffins, pumpkin raisin muffins, zucchini muffins, tropical fruit muffins, etc. When 1 part=1 pound, the batter makes about a dozen medium muffins.

A method of making a muffin batter may comprise (1) beating the egg substitute, oil, and water; and (2) beating in the muffin mix to produce a muffin batter. In one embodiment, the batter is refrigerated. A method of making allergen-free muffins may comprise baking the muffin batter at 320° F. for 25-30 minutes or until baked through. In one embodiment, the methods are conducted at high altitude without changes. Also provided are allergen-free muffins (e.g., apple muffins, banana muffins, blueberry muffins, berry muffins, carrot raisin muffins, chocolate chip muffins, cinnamon sugar muffins, dried cranberry muffins, poppy seed muffins, pumpkin raisin muffins, zucchini muffins, and tropical fruit muffins) made by the presently disclosed method.

### 2. Second Flour Composition:

Allergen-free flour compositions include a second flour composition. The second flour composition comprises the following components added in the indicated number of parts (by weight):

| | | | |
|---|---|---|---|
| (1) | brown rice flour and/or white rice flour: | 0.931 | parts; |
| (2) | potato starch: | 0.207 | parts; |
| (3) | tapioca starch and/or tapioca flour: | 0.115 | parts; and |
| (4) | gum: | 0.007 | parts, |

wherein the indicated parts may vary by up to ±5 percent. In one embodiment, the brown rice flour and/or white rice flour component may contain all white rice flour. In another embodiment, the tapioca starch and/or tapioca flour component may be all tapioca flour. The second flour composition may be used for making pancakes, waffles, and crêpes, for example.

A baking mix may comprise the following components at the indicated relative parts (weight):

| | | | |
|---|---|---|---|
| (a) | second flour composition: | 1.862 | parts; |
| (b) | powdered or liquid rice milk powder: | 0.1045 | parts; |
| (c) | sugar: | 0.0544 | parts; |
| (d) | baking powder: | 0.0310 | parts; |
| (e) | salt: | about 0.0156 | parts; and |
| (f) | baking soda: | 0.0125 | parts, |

wherein the indicated parts may vary by up to ±5 percent. A baking batter may comprise the following components at the indicated relative parts (weight):

| | | |
|---|---|---|
| (i) | baking mix: | 2.080 parts; |
| (ii) | egg substitute: | 0.134 parts; |
| (iii) | water: | 0.378 parts; and |
| (iv) | oil: | 0.055 parts, |

wherein the egg substitute is 0.0450 parts ground flax (regular flax or golden flax) mixed with 0.0887 parts water, and wherein the indicated parts may vary by up to ±5 percent. In one embodiment, the batter may be refrigerated.

The baking mix may be used in a method of making baking batter comprising mixing the baking mix with the egg substitute, water, and oil to form a baking batter. In a method of making a baked product, the batter may be baked on a griddle until baked. Also included are allergen-free baked products, e.g., pancakes or waffles, made by the disclosed method. When 1 part=1 pound, the batter makes six 4-inch pancakes or six 4-inch waffles. In one embodiment, the baked products, e.g., pancakes or waffles, made with the baking batter are frozen or refrigerated after cooking.

In another embodiment, a crêpe batter may comprise the following components at the indicated relative parts (weight):

| | | |
|---|---|---|
| (i) | baking mix: | 2.080 parts; |
| (ii) | egg substitute: | 0.134 parts; |
| (iii) | water: | 0.523 parts; |
| (iv) | oil: | 0.055 parts; |
| (v) | sugar: | 0.0092 parts; and |
| (vi) | vanilla extract or powder: | 0.0142 parts, |

wherein the indicated parts may vary by up to at, 0.5 percent. The baking mix may be used in a method of making allergen-free crêpes, for example comprising mixing the baking mix with the ingredients above to form a crêpe batter, and cooking the batter until baked. In one embodiment, the method is conducted at high altitude without changes. Also included are baked products, e.g., crêpes, made by the disclosed method. The baked products may further comprise jam, honey, sugar, chocolate hazelnut spread, peanut butter, bananas, and the like. When 1 part=1 pound, the batter makes six to eight crêpes. In one embodiment, the baked products made with the baking batter, e.g., crêpes, are frozen or refrigerated after cooking.

### 3. Third Flour Composition (Pizza Crust):

Allergen-free flour compositions include a third flour composition. The third flour composition comprises the following components added in the indicated number of parts (by weight):

| | | | |
|---|---|---|---|
| (1) | brown rice flour and/or white rice flour: | 0.630 | parts; |
| (2) | tapioca starch and/or tapioca flour: | 0.258 | parts; |
| (3) | teff flour and/or sorghum flour: | 0.156 | parts; |
| (4) | arrowroot starch and/or cornstarch: | 0.114 | parts; |
| (5) | sugar: | 0.0835 | parts; |
| (6) | salt: | about 0.0264 | parts; |
| (7) | gum: | 0.0274 | parts; |
| (8) | molasses powder: | about 0.0150 | parts; and |
| (9) | vinegar powder (apple cider): | 0.0090 | parts, |

wherein the indicated parts may vary by up to it ±5 percent. In one embodiment, the tapioca starch and/or tapioca flour component may be all tapioca flour. In another embodiment, the brown rice flour and/or white rice flour component may contain all white rice flour. The third flour composition may be used for making pizza crust, for example.

A pizza dough may comprise may comprise the following components at the indicated relative parts (weight):

| | | |
|---|---|---|
| (i) | third flour composition: | 1.465 parts; |
| (ii) | egg substitute: | 0.401 parts; |
| (iii) | water: | 0.773 parts; |
| (iv) | olive oil: | 0.111 parts; and |
| (v) | yeast: | 0.0164 parts, |

wherein the egg substitute is 0.135 parts ground flax (regular flax or golden flax) mixed with 0.266 parts water, and wherein the indicated parts may vary by up to ±5 percent. The parts yeast refer to active, dry yeast. An average package of commercially sold yeast contains 0.01640 lb, which is equivalent to 7 grams.

The pizza dough may be used in a method of making pizza crust comprising (1) beating the egg substitute, olive oil, and water; (2) mixing in the yeast and third flour composition to form a pizza dough; (3) baking the pizza dough at 400° F. for 8-12 minutes or until the top sets and the bottom begins to brown, (4) adding toppings, if any; and (5) baking at 400° F. for 6-10 minutes or until the bottom is browned and the toppings are cooked. In one embodiment, the method is conducted at high altitude without changes. Also included are pizzas made by the disclosed method. When 1 part 1 pound, the dough makes one 14″ pizza or two medium pizzas. In one embodiment, the pizza may be frozen.

Baking allergen-free breads at a lower temperature (350-375° F.) creates a thicker, chewier crust, while baking breads at a higher temperature (400-425° F.) produces thinner, crisper crusts.

### 4. Fourth Flour Composition (Pie Crust):

Allergen-free flour compositions include a fourth flour composition. The fourth flour composition comprises the following components added in the indicated number of parts (by weight):

| | | |
|---|---|---|
| (1) | brown rice flour and/or white rice flour: | 0.737 parts; |
| (2) | potato starch: | 0.322 parts; and |
| (3) | gum: | 0.260 parts, |

wherein the indicated parts may vary by up to ±5 percent. In one embodiment, the brown rice flour to white rice flour ratio may be 1:4.8, which ratio may vary by up to ±50, ±20, or ±10 percent. The fourth flour composition may be used for making pie crust, for example. For example, a pie crust mix may comprise the following components at the indicated relative parts (weight):

| | | | |
|---|---|---|---|
| (a) | fourth flour composition: | 1.319 | parts; |
| (b) | sugar: | 0.220 | parts; |
| (c) | vinegar powder (apple cider): | 0.016 | parts; and |
| (d) | salt: | about 0.010 | parts, |

wherein the indicated parts may vary by up to ±5 percent. A pie dough may comprise the following components at the indicated relative parts (weight):

| | | |
|---|---|---|
| (i) | pie crust mix: | 1.565 parts; |
| (ii) | egg substitute: | 0.267 parts; |
| (iii) | all soy-free shortening: | 0.356 parts; and |
| (iv) | water: | 0.523 parts, |

wherein the egg substitute is 0.0900 parts ground flax (regular flax or golden flax) mixed with 0.1774 parts water, and wherein the indicated parts may vary by up to ±5 percent. In one embodiment, the pie dough may be frozen or refrigerated.

The pie dough may be used in a method of making a pie crust comprising (1) beating the egg substitute, soy-free shortening, and water; (2) mixing in the pie crust mix to form a pie dough; (3) forming a pie crust from the pie dough; (4) baking at 400° F. for about 10 minutes; (5) adding fillings; and (6) baking at 350° F. for 12-45 minutes or until the pie crust begins to turn golden. In one embodiment, the method is conducted at high altitude without changes. In another embodiment, white rice flour is used to prevent the pie crust from sticking, prior to baking. Also included are refrigerated pie crusts made by the disclosed method. When 1 part=1 pound, the dough makes one 9″ pie.

### 5. Fifth Flour Composition (Bread Products):

Allergen-free flour compositions include a fifth flour composition. The fifth flour composition comprises the following components added in the indicated number of parts (by weight):

| | | | |
|---|---|---|---|
| (1) | potato starch: | 0.450 | parts; |
| (2) | tapioca starch and/or tapioca flour: | 0.400 | parts; |
| (3) | brown rice flour and/or white rice flour: | 0.350 | parts; |
| (4) | arrowroot starch and/or cornstarch: | 0.300 | parts; |
| (5) | sugar: | 0.114 | parts; |
| (6) | teff flour and/or sorghum flour: | 0.0674 | parts; |
| (7) | baking powder: | 0.0500 | parts; |
| (8) | powdered or liquid rice milk base: | 0.0430 | parts; |
| (9) | vinegar powder (apple cider): | 0.0400 | parts; |
| (10) | molasses powder: | about 0.0400 | parts; |
| (11) | salt: | about 0.0306 | parts; and |
| (12) | gum: | 0.0130 | parts, |

wherein the indicated parts may vary by up to ±5 percent. In one embodiment, the brown rice flour and/or white rice flour component may contain all white rice flour. In another embodiment, the tapioca starch and/or tapioca flour component may be all tapioca flour.

The fifth flour composition may be used for making bread products. A bread dough may comprise the following components at the indicated relative parts (weight):

| | | |
|---|---|---|
| (i) | fifth flour composition: | 1.260 parts; |
| (ii) | yeast: | 0.0164 parts; |
| (iii) | oil: | 0.0104 parts; |
| (iv) | egg substitute: | 0.267 parts; and |
| (v′) | water: | 0.559 parts, or |
| (v″) | water: | 0.523 parts, |

wherein the egg substitute is 0.0900 parts ground flax (regular flax or golden flax) mixed with 0.1774 parts water, and wherein the indicated parts may vary by up to ±5 percent, and wherein component (v′) (water) is used at low altitude, and component (v″) (water) is used at high altitude. The parts yeast refer to active, dry yeast. An average package of commercially sold yeast contains 0.01640 lb, which is equivalent to 7 grams.

A method of making bread dough may comprise (1) mixing the fifth flour composition and yeast; (2) mixing the oil, water, and egg substitute; (3) and blending the mixes from steps (1) and (2) together to form a bread dough. In one embodiment, the bread dough may further comprise preservatives, flavorings, or other additives, including, but not limited to, Italian herbs, onion powder, sesame seeds, sunflower seeds, and poppy seeds.

A method of using the bread dough to make a bread product may comprise (1) warming the bread dough for about one hour; and (2) baking the bread dough at 350° F. for 25-30 minutes or until baked through to form a bread product. When 1 part=1 pound, the dough makes one loaf of bread. A method of using the bread dough to make a cinnamon bread product may further comprise before step (1): (1′) mixing 2 tsp cinnamon and ½ cup sugar to make a cinnamon/sugar mix (where 1 part=1 pound); (2′) folding the cinnamon/sugar mix into the bread dough; and (3′) resting the dough for about an hour. A method of using the bread dough to make croutons or toasts may further comprise after step (2): (1″) cutting pieces of the bread product; and (2″) baking the pieces for about two hours at 200° F. Also provided are allergen-free bread products made by the present methods, including but not limited to loafs of bread, buns, bread crumbs and rolls.

### 6. Sixth Composition (Pizza Crust Mix):

Allergen-free food compositions also can include a pizza crust mix comprising the following components added in the indicated number of parts (by weight):

| | | | |
|---|---|---|---|
| (1) | white rice flour: | 11.032 ± 1.103 | parts; |
| (2) | powdered or liquid rice milk: | 2.100 ± 0.210 | parts; |
| (3) | brown rice flour: | 2.000 ± 0.200 | parts; |
| (4) | cane sugar: | 1.000 ± 0.100 | parts; |
| (5) | salt: | 0.300 ± 0.030 | parts; |
| (6) | baking powder: | 0.200 ± 0.010 | parts; |
| (7) | molasses powder: | 0.200 ± 0.010 | parts; |
| (8) | powdered sugar: | 0.150 ± 0.008 | parts; |
| (9) | methylcellulose: | 0.006 | parts; and |
| (10) | yeast: | 0.262 ± 0.013 | parts. |

In one example, the white rice flour may be replaced by tapioca starch and/or tapioca flour. In another example, the white rice flour component may be replaced by a mixture of brown rice flour and white rice flour, or all brown rice flour. The sixth composition may be used for making pizza crust, for example. One (1) part may mean 1 oz. Alternatively, 1 part may mean 1 lb. When 1 part=1 ounce, the above composition makes a package suitable for retail.

A pizza dough may comprise may comprise the following components at the indicated relative parts (weight):

| | | | |
|---|---|---|---|
| (i) | sixth composition: | 26.7 | parts; |
| (ii) | warm water: | 10.667 ± 1.600 | parts; and |
| (iv) | olive oil: | 1.500 ± 0.225 | parts. |

When 1 part 1 ounce, the above composition makes a 14 inch pizza or two medium pizzas.

The pizza dough may be used in a method of making pizza crust comprising (1) beating olive oil and water; (2) mixing in the sixth composition to form a pizza dough; (3) baking the pizza dough at 400° F. for 8-12 minutes or until the top sets and the bottom begins to brown, (4) adding toppings, if any; and (5) baking at 400° F. for 6-10 minutes or until the bottom is browned and the toppings are cooked. The method can be conducted at high altitude without changes. Also included are pizzas made by the disclosed method. In one embodiment, the pizza may be frozen.

### 7. White Cake Mix

Allergen-free food compositions also include a white cake mix comprising the following components added in the indicated number of parts (by weight) wherein each ingredient may vary by up to the indicated percentage:

| | | |
|---|---|---|
| (1) | sugar | 9.80 parts ± 15%; |
| (2) | white rice flour and/or brown rice flour | 9.10 parts ± 15%; |
| (3) | baking powder, tapioca flour, | 2.30 parts ± 35%; |
| | tapioca starch, potato starch, | |
| | arrowroot powder and/or cornstarch | |
| (4) | gum | 0.20 parts ± 40%; |
| (5) | salt | 0.15 parts ± 40%; and |
| (6) | cream of tartar | 0.12 parts ± 65%. |

A further embodiment may include a white cake mix comprising

| | | |
|---|---|---|
| (1) | sugar | 9.80 parts ± 15%; |
| (2) | white rice flour | 7.70 parts ± 15%; |
| (3) | baking powder | 1.80 parts ± 35%; |
| (4) | brown rice flour | 1.40 parts ± 25%; |
| (5) | tapioca flour | 0.50 parts ± 40%; |
| (6) | xanthan gum | 0.20 parts ± 40%; |
| (7) | salt | 0.15 parts ± 40%; and |
| (8) | cream of tartar | 0.12 parts ± 65%. |

The white cake mix may further comprise 0.08 parts dextrose and/or titanium dioxide powder, wherein the dextrose and/or titanium dioxide powder may vary by up to ±80%. The white cake mix may also comprise 0.30 parts natural vanilla flavor, in an extract or powder, wherein the natural vanilla flavor may vary by up to ±40%.

A white cake batter may comprise the following components at the indicated relative parts (weight) wherein each ingredient may vary by up to the indicated percentage:

| | | |
|---|---|---|
| (i) | white cake mix | 3.75 parts ± 10%; |
| (ii) | soy free shortening | 0.33 parts ± 10%; and |
| (iii) | rice milk (liquid or powdered) | 1.25 parts ± 10%; and |
| (iv) | water and/or carbonated beverage | 0.25 parts ± 10%. |

A method of making a white cake batter may comprise: (1) beating the shortening, rice milk, and water and/or carbonated beverage; and (2) beating in the white cake mix to produce a white cake batter. In another embodiment, a method of making a white cake product comprises baking the white cake batter at 350° F. for 25-30 minutes or until baked through to produce a white cake product. In one embodiment, the method is conducted at high altitude without changes. Also provided are allergen-free white cakes made by the presently disclosed method.

### 8. Chocolate Cake Mix

Allergen-free food compositions also include a chocolate cake mix comprising the following components added in the indicated number of parts (by weight) wherein each ingredient may vary by up to the indicated percentage:

| | | |
|---|---|---|
| (1) | sugar | 9.80 parts ± 5%; |
| (2) | white rice flour and/ | 8.90 parts ± 15%; |
| | or brown rice flour | |
| (3) | baking powder, tapioca | 2.00 parts ± 35%; |
| | flour, tapioca | |
| | starch, potato starch, | |
| | arrowroot powder | |
| | and/or cornstarch | |
| (4) | cocoa | 1.00 parts ± 25%; |
| (5) | gum | 0.20 parts ± 40%; |
| (6) | cream of tartar | 0.10 parts ± 65%; and |
| (7) | salt | 0.15 parts ± 65%. |

A further embodiment may include a chocolate cake mix comprising

| | | |
|---|---|---|
| (1) | sugar | 9.80 parts ± 15%; |
| (2) | white rice flour | 7.90 parts ± 15%; |
| (3) | baking powder | 1.80 parts ± 35%; |
| (4) | cocoa | 1.00 parts ± 25%; |
| (5) | brown rice flour | 1.00 parts ± 25%; |
| (6) | xanthan gum | 0.20 parts ± 40%; |
| (7) | cream of tartar | 0.10 parts ± 65%; |
| (8) | salt | 0.15 parts ± 65%; and |
| (9) | potato starch | 0.20 parts ± 40%. |

The chocolate cake mix may further comprise 030 parts natural vanilla flavor, in an extract or powder, wherein the natural vanilla flavor may vary by up to ±40%.

A chocolate cake batter may comprise the following components at the indicated relative parts (weight) wherein each ingredient may vary by up to the indicated percentage:

| | | |
|---|---|---|
| (i) | the chocolate cake mix | 3.75 parts ± 10%; |
| (ii) | soy free shortening | 0.33 parts ± 10%; |
| (iii) | rice milk (liquid or powdered) | 1.33 parts ± 10%; and |
| (iv) | water and/or carbonated beverage | 0.25 parts ± 10%. |

A method of making a chocolate cake batter may comprise: (1) beating the shortening, rice milk, and water and/or carbonated beverage; and (2) beating in the chocolate cake mix to produce a cake batter. In another embodiment, a method of making a chocolate cake product comprises baking the cake batter at 350° F. until baked through to produce a chocolate cake product. In one embodiment, the method is conducted at high altitude without changes. Also provided are allergen-free chocolate cakes made by the presently disclosed method.

### 9. Muffin Mix

Allergen-free food compositions also include a muffin mix comprising the following components added in the indicated number of parts (by weight) wherein each ingredient may vary by up to the indicated percentage:

| | | |
|---|---|---|
| (1) | white rice flour and/or brown rice flour | 11.58 parts ± 20%; |
| (2) | sugar | 2.30 parts ± 35%; |
| (3) | baking powder, tapioca flour, tapioca | 1.70 parts ± 25%; |
| | starch, potato starch, arrowroot | |
| | powder and/or cornstarch | |
| (4) | sodium bicarbonate | 0.18 parts ± 50%; |
| (5) | gum | 0.18 parts ± 40%; and |
| (6) | salt | 0.10 parts ± 65%. |

A further embodiment may include a muffin mix comprising

| | | |
|---|---|---|
| (1) | white rice flour | 10.38 parts ± 20%; |
| (2) | sugar | 2.30 parts ± 35%; |
| (3) | baking powder | 1.70 parts ± 25%; |
| (4) | brown rice flour | 1.20 parts ± 20%; |
| (5) | sodium bicarbonate | 0.18 parts ± 50%; |
| (6) | xanthan gum | 0.18 parts ± 40%; and |
| (7) | salt | 0.10 parts ± 65%. |

The muffin mix may further comprise 0.16 parts natural vanilla flavor, in an extract or powder, wherein natural vanilla flavor may vary by up to ±40 percent.

A muffin batter may comprise the following components at the indicated relative parts (weight) wherein each ingredient may vary by up to the indicated percentage:

| | | |
|---|---|---|
| (i) | the muffin mix | 3.250 parts ± 10%; |
| (ii) | oil | 0.333 parts ± 10%; |
| (iii) | rice milk (liquid or powdered) | 1.250 parts ± 10%; |
| (iv) | water and/or carbonated beverage | 1.385 parts ± 10%; and |

In an apple muffin batter, the water component can be replaced with applesauce or apple juice, and the batter further comprises apples (e.g., shredded). In other muffin batters, additional ingredients may be added as appropriate to make batters for allergen-free banana muffins, blueberry muffins, berry muffins, carrot raisin muffins, chocolate chip muffins, cinnamon sugar muffins, dried cranberry muffins, poppy seed muffins, pumpkin raisin muffins, zucchini muffins, tropical fruit muffins, etc.

A method of making a muffin batter may comprise: (1) beating the shortening, rice milk, water and/or carbonated beverage; and (2) beating in the muffin mix to produce a muffin batter. In one embodiment, the batter is refrigerated. In another embodiment, a method of making a muffin product comprises baking the muffin batter at 350° F. for 10-12 minutes or until baked through to produce a muffin product. In one embodiment, the method is conducted at high altitude without changes. Also provided are allergen-free muffins (e.g., apple muffins, banana muffins, blueberry muffins, berry muffins, carrot raisin muffins, chocolate chip muffins, cinnamon sugar muffins, dried cranberry muffins, poppy seed muffins, pumpkin raisin muffins, zucchini muffins, and tropical fruit muffins) made by the presently disclosed method.

### 10. Brownie Mix

Allergen-free food compositions also include a brownie mix comprising the following components added in the indicated number of parts (by weight) wherein each ingredient may vary by up to the indicated percentage:

| | | |
|---|---|---|
| (1) | sugar | 6.50 parts ± 15%; |
| (2) | white rice flour and/or brown rice flour | 4.42 parts ± 15%; |
| (3) | brown sugar | 0.75 parts ± 35%; |
| (4) | cocoa | 0.45 parts ± 25%; |
| (5) | baking powder, tapioca flour, tapioca | 0.33 parts ± 35%; |
| | starch, potato starch, arrowroot | |
| | powder and/or cornstarch | |
| (6) | gum | 0.15 parts ± 40%; |
| (7) | sodium bicarbonate | 0.10 parts ± 40%; and |
| (8) | salt | 0.10 parts ± 65%, |

A further embodiment may include a muffin mix comprising

| | | |
|---|---|---|
| (1) | sugar | 6.50 parts ± 15%; |
| (2) | white rice flour | 4.32 parts ± 15%; |
| (3) | brown sugar | 0.75 parts ± 35%; |
| (4) | cocoa | 0.45 parts ± 25%; |
| (5) | baking powder | 0.18 parts ± 35%; |
| (6) | tapioca flour | 0.15 parts ± 40%; |
| (7) | xanthan gum | 0.15 parts ± 40%; |
| (8) | brown rice flour | 0.10 parts ± 40%; |
| (9) | sodium bicarbonate | 0.10 parts ± 40%; and |
| (10) | salt | 0.10 parts ± 65%. |

The brownie mix may further comprise 1.85 parts chocolate chips or chunks, wherein chocolate chips or chunks may vary by up to ±80%. The brownie mix may also comprise 0.10 parts natural vanilla flavor, in an extract or powder, wherein natural vanilla flavor may vary by up to ±40%.

A brownie batter may comprise the following components at the indicated relative parts (weight) wherein each ingredient may vary by up to the indicated percentage:

| | | |
|---|---|---|
| (i) | the brownie mix | 2.00 parts ± 10%; |
| (ii) | oil | 0.25 parts ± 10%; and |
| (iii) | rice milk (liquid or powdered) | 0.75 parts ± 10%. |

A method of making a brownie batter may comprise: (1) beating the canola oil and rice milk; and (2) beating in the brownie mix to produce a brownie batter. In one embodiment, the batter is refrigerated. In another embodiment, a method of making a brownie product comprises baking the muffin batter at 350° F., for 25-30 minutes or until baked through to produce a brownie product. In one embodiment, the method is conducted at high altitude without changes. Also provided are allergen-free brownie made by the presently disclosed method.

### 11. Cornbread and Muffin Mix

Allergen-free food compositions also include a cornbread and muffin mix comprising the following components added in the indicated number of parts (by weight) wherein each ingredient may vary by up to the indicated percentage:

| | | |
|---|---|---|
| (1) | cornmeal | 5.15 parts ± 30%; |
| (2) | sugar | 4.10 parts ± 40%; |
| (3) | tapioca flour, baking powder, tapioca | 3.65 parts ± 40%; |
| | starch, potato starch, arrowroot | |
| | powder and/or cornstarch | |
| (4) | white rice flour and/or brown rice flour | 1.15 parts ± 40%; |
| (5) | gum | 0.20 parts ± 65%; and |
| (6) | salt | 0.10 parts ± 65%. |

A further embodiment may include a muffin mix comprising

| | | |
|---|---|---|
| (1) | cornmeal | 5.15 parts ± 30%; |
| (2) | sugar | 4.10 parts ± 40%; |
| (3) | tapioca flour | 1.45 parts ± 40%; |
| (4) | white rice flour | 1.15 parts ± 40%; |
| (5) | cornstarch | 1.10 parts ± 40%; |
| (6) | baking powder | 0.90 parts ± 40%; |
| (7) | potato starch | 0.20 parts ± 40%; |
| (8) | xanthan gum | 0.20 parts ± 65%; and |
| (9) | salt | 0.10 parts ± 65%. |

The cornbread and muffin mix may further comprise 0.15 parts natural vanilla flavor, in an extract or powder, wherein natural vanilla flavor may vary by up to ±40 percent.

A cornbread dough may comprise the following components at the indicated relative parts (weight) wherein each ingredient may vary by up to the indicated percentage:

| | | |
|---|---|---|
| (i) | the cornbread and muffin mix | 2.75 parts ± 10%; |
| (ii) | dairy free, soy-free butter | 0.50 parts ± 10%; |
| (iii) | rice milk (liquid or powdered) | 0.75 parts ± 10%; and |
| (iv) | water and/or carbonated beverage | 0.13 parts ± 10%. |

A method of making a cornbread dough may comprise: (1) beating melted dairy free, soy-free butter, rice milk, water and/or carbonated beverage; and (2) beating in the cornbread and muffin mix to produce the cornbread dough. In one embodiment, a method of making a cornbread product comprises baking the cornbread dough at 400° F. for 25-30 minutes or until baked through to produce a cornbread product. In one embodiment, the method is conducted at high altitude without changes. Also provided are allergen-free cornbread made by the presently disclosed method.

### 12. Bread Mix or Roll Mix

Allergen-free food compositions also include a bread mix comprising the following components added in the indicated number of parts (by weight) wherein each ingredient may vary by up to the indicated percentage:

| | | |
|---|---|---|
| (1) | white rice flour and/or brown rice flour | 4.96 parts ± 15%; |
| (2) | tapioca flour, tapioca starch, potato | 9.93 parts ± 15%; |
| | starch, cornstarch arrowroot | |
| | powder and/or baking powder | |
| (3) | sugar | 1.85 parts ± 40%; |
| (4) | powdered rice milk | 0.65 parts ± 40%; |
| (5) | salt | 0.60 parts ± 65%; |
| (6) | potato flour | 0.18 parts ± 50%; |
| (7) | gum | 0.18 parts ± 65%; |
| (8) | methylcellulose | 0.10 parts ± 75%; and |
| (9) | yeast | 0.3439 parts ± 60%. |

A further embodiment may include a bread mix comprising

| | | |
|---|---|---|
| (1) | potato starch | 4.18 parts ± 15%; |
| (2) | white rice flour | 3.96 parts ± 15%; |
| (3) | tapioca flour | 2.75 parts ± 20%; |
| (4) | sugar | 1.85 parts ± 40%; |
| (5) | cornstarch | 1.50 parts ± 40%; |
| (6) | baking powder | 1.50 parts ± 40%; |
| (7) | brown rice flour | 1.00 parts ± 40%; |
| (8) | powdered rice milk | 0.65 parts ± 40%; |
| (9) | salt | 0.60 parts ± 65%; |
| (10) | potato flour | 0.18 parts ± 50%; |
| (11) | xanthan gum | 0.18 parts ± 65%; |
| (12) | methylcellulose | 0.10 parts ± 75%; and |
| (13) | yeast | 0.3439 parts ± 60%. |

The bread mix may further comprise 0.13 parts molasses powder, wherein the molasses powder may vary by up to ±75%. The bread mix may also comprise 0.18 parts teff gain, wherein the teff grain may vary by up to ±50%. Methylcellulose may be methylcellulose F4M, for example.

The parts yeast refer to active, dry yeast. An average package of commercially sold yeast contains 0.01640 lb, which is equivalent to 7 grams.

A bread dough may comprise the following components at the indicated relative parts (weight) wherein each ingredient may vary by up to the indicated percentage:

| | | |
|---|---|---|
| (i) | the bread mix | 4.00 parts ± 10%; |
| (ii) | oil | 0.33 parts ± 10%; and |
| (iii) | warm water | 1.75 parts ± 15%. |

A method of making bread dough may comprise (1) mixing the bread mix; (2) mixing oil and warm water; (3) and blending the mixes from steps (1) and (2) together to form a bread dough. In one embodiment, the bread dough may further comprise preservatives, flavorings, or other additives, including, but not limited to, Italian herbs, onion powder, sesame seeds, sunflower seeds, and poppy seeds.

A method of using the bread dough to make a bread product may comprise (1) warming the bread dough for about one hour; and (2) baking the bread dough at 350° F. for 25-30 minutes or until baked through to form a bread product. When 1 part=1 cup, the dough makes one loaf of bread. A method of using the bread dough to make a cinnamon bread product may further comprise before step (1): (1′) mixing 2 tsp cinnamon and ½ cup sugar to make a cinnamon/sugar mix (where 1 part=1 pound); (2′) folding the cinnamon/sugar mix into the bread dough; and (3) resting the dough for about an hour. A method of using the bread dough to make croutons or toasts may further comprise after step (2): (1″) cutting pieces of the bread product; and (2″) baking the pieces for about two hours at 200° F. Also provided are allergen-free bread products made by the present methods. Exemplary allergen-free bread products may include bread loaves, buns, bread rolls, and bread crumbs.

### 13. Pizza Crust Mix

Allergen-free food compositions also include a pizza crust mix comprising the following components added in the indicated number of parts (by weight) wherein each ingredient may vary by up to the indicated percentage:

| | | |
|---|---|---|
| (1) | white rice flour and/or brown rice flour | 13.96 parts ± 15%; |
| (2) | baking powder, tapioca flour, tapioca | 2.20 parts ± 40%; |
| | starch, potato starch, arrowroot | |
| | powder and/or cornstarch | |
| (3) | sugar | 0.60 parts ± 40%; |
| (4) | salt | 0.30 parts ± 65%; |
| (5) | powdered rice milk | 0.40 parts ± 40% |
| (6) | molasses powder | 0.25 parts ± 75%; |
| (7) | gum | 0.25 parts ± 65%; |
| (8) | vinegar | 0.06 parts ± 80%; and |
| (9) | yeast | 0.3439 parts ± 60%. |

A further embodiment may include a pizza crust mix comprising

| | | |
|---|---|---|
| (1) | white rice flour | 12.96 parts ± 15%; |
| (2) | baking powder | 1.60 parts ± 40% |
| (3) | brown rice flour | 1.00 parts ± 40%; |
| (4) | sugar | 0.60 parts ± 40%; |
| (5) | tapioca flour | 0.60 parts ± 40%; |
| (6) | salt | 0.30 parts ± 65%; |
| (7) | powdered rice milk | 0.40 parts ± 40% |
| (8) | molasses powder | 0.25 parts ± 75%; |
| (9) | xanthan gum | 0.25 parts ± 65%; |
| (10) | vinegar | 0.06 parts ± 80%; and |
| (11) | yeast | 0.3439 parts ± 60%. |

The pizza crust mix may further comprise 0.10 parts teff gain, wherein the teff grain may vary by up to ±60%.

The parts yeast refer to active, dry yeast. An average package of commercially sold yeast contains 0.01640 lb, which is equivalent to 7 grams.

A pizza dough may comprise the following components at the indicated relative parts (weight) wherein each ingredient may vary by up to the indicated percentage:

| | | |
|---|---|---|
| (i) | the pizza crust mix | 4.00 parts ± 10%; |
| (ii) | oil | 0.33 parts ± 10%; |
| (iii) | rice milk (powdered or liquid) | 0.25 parts ± 10%; and |
| (iv) | warm water | 1.75 parts ± 10%. |

A method of making an allergen-free pizza may comprise baking the pizza dough at 300-350° F. in one embodiment, the method is conducted at high altitude without changes. Also included are pizzas made by the disclosed method. When 1 part=1 cup, the dough makes one large pizza or two medium pizzas. In one embodiment, the pizza may be frozen.

### 14. Cookie Mix

Allergen-free food compositions also include a cookie mix comprising the following components added in the indicated number of parts (by weight) wherein each ingredient may vary by up to the indicated percentage:

| | | |
|---|---|---|
| (1) | sugar | 3.20 parts ± 30%; |
| (2) | brown sugar | 2.40 parts ± 35%; |
| (3) | white rice flour and/or brown rice flour | 4.53 parts ± 15%; |
| (4) | tapioca flour, baking powder, tapioca | 0.75 parts ± 35%; |
| | starch, potato starch, arrowroot | |
| | powder and/or cornstarch | |
| (5) | potato flour | 0.60 parts ± 30%; |
| (6) | gum | 0.15 parts ± 65%; |
| (7) | sodium bicarbonate | 0.06 parts ± 75%; and |
| (8) | salt | 0.10 parts ± 65%. |

A further embodiment may include a cookie mix comprising

| | | |
|---|---|---|
| (1) | sugar | 3.20 parts ± 30%; |
| (2) | brown sugar | 2.40 parts ± 35%; |
| (3) | white rice flour | 4.38 parts ± 15%; |
| (4) | tapioca flour | 0.20 parts ± 40%; |
| (5) | potato flour | 0.60 parts ± 30%; |
| (6) | baking powder | 0.40 parts ± 35%; |
| (7) | brown rice flour | 0.15 parts ± 40%; |
| (8) | potato starch | 0.15 parts ± 40%; |
| (9) | xanthan gum | 0.15 parts ± 65%; |
| (10) | sodium bicarbonate | 0.06 parts ± 75%; and |
| (11) | salt | 0.10 parts ± 65%. |

The cookie mix may further comprise 0.15 parts natural vanilla flavor, in an extract or powder, wherein the natural vanilla flavor may vary by up to ±40%. The cookie mix may also comprise 3.56 parts chocolate chips or chunks, wherein the chocolate chips or chunks may vary by up to ±15 percent. The cookie mix may also comprise 3.56 parts carob chips or chunks, wherein the carob chips or chunks may vary by up to ±15 percent.

A cookie dough may comprise the following components at the indicated relative parts (weight) wherein each ingredient may vary by up to the indicated percentage:

| | | |
|---|---|---|
| (i) | cookie mix | 2.00 parts ± 10%; |
| (ii) | dairy free, soy-free butter | 0.50 parts ± 10%; and |
| (iii) | water and/or carbonated water | 0.25 parts ± 10%. |

A method of making the cookie dough may include mixing the cookie mix, butter and water and/or carbonated water. A method of making an allergen-free cookie may comprise baking the cookie dough at 350° F. to produce the allergen-free cookie. Also included are allergen-free cookies made by the disclosed method.

### 15. Oatmeal Cookie Mix

Allergen-free food compositions also include an oatmeal cookie mix comprising the following components added in the indicated number of parts (by weight) wherein each ingredient may vary by up to the indicated percentage:

| | | |
|---|---|---|
| (1) | white rice flour and/or brown rice flour | 5.15 parts ± 15%; |
| (2) | gluten free rolled oats | 2.60 parts ± 30%; |
| (3) | brown sugar | 2.60 parts ± 15%; |
| (4) | sugar | 2.25 parts ± 15%; |
| (5) | tapioca flour, baking powder, tapioca | 1.05 parts ± 35%; |
| | starch, potato starch, arrowroot | |
| | powder and/or cornstarch | |
| (6) | potato flour | 0.10 parts ± 65%; |
| (7) | gum | 0.15 parts ± 65%; |
| (8) | sodium bicarbonate | 0.06 parts ± 75%; and |
| (9) | salt | 0.10 parts ± 65%. |

A further embodiment may include an oatmeal cookie mix comprising the following ingredients:

| | | |
|---|---|---|
| (1) | white rice flour | 5.05 parts ± 15%; |
| (2) | gluten free rolled oats | 2.60 parts ± 30%; |
| (3) | brown sugar | 2.60 parts ± 15%; |
| (4) | sugar | 2.25 parts ± 15%; |
| (5) | tapioca flour | 0.50 parts ± 40%; |
| (6) | potato flour | 0.10 parts ± 65%; |
| (7) | baking powder | 0.40 parts ± 35%; |
| (8) | brown rice flour | 0.10 parts ± 65%; |
| (9) | potato starch | 0.15 parts ± 40%; |
| (10) | xanthan gum | 0.15 parts ± 65%; |
| (11) | sodium bicarbonate | 0.06 parts ± 75%; and |
| (12) | salt | 0.10 parts ± 65%. |

The cookie mix may further comprise 2.60 parts raisins or other dried fruit, wherein the raisins or other dried fruit may vary by up to ±15%. The oatmeal cookie mix may further comprise 0.15 parts natural vanilla flavor, in an extract or powder, wherein natural vanilla flavor may vary by up to ±40%. The oatmeal cookie mix may also comprise 0.12 parts molasses powder, wherein the molasses powder may vary by up to ±75%. In addition, the oatmeal cookie mix may also comprise 0.07 parts ground cinnamon, wherein the ground cinnamon may vary by up to ±65%.

An oatmeal cookie dough may comprise the following components at the indicated relative parts (weight) wherein each ingredient may vary by up to the indicated percentage:

| | | |
|---|---|---|
| (i) | oatmeal cookie mix | 2.50 parts ± 10%; |
| (ii) | soy free, dairy free butter | 0.50 parts ± 10%; and |
| (iii) | water and/or carbonated beverage | 0.50 parts ± 10%; |

A method of making the cookie dough may include mixing the cookie mix, butter and water and/or carbonated water. A method of making an allergen-free oatmeal cookie may comprise baking the oatmeal raisin cookie dough at 350° F. to produce the allergen-free oatmeal raisin cookie. Also included are allergen-free oatmeal raisin cookie made by the disclosed method.

### 16. Sugar Cookie Mix

Allergen-free food compositions also include a sugar cookie mix comprising the following components added in the indicated number of parts (by weight) wherein each ingredient may vary by up to the indicated percentage:

| | | |
|---|---|---|
| (1) | sugar | 7.00 parts ± 30%; |
| (2) | white rice flour and brown rice flour | 6.30 parts ± 25%; |
| (3) | potato flour | 0.60 parts ± 40%; |
| (4) | tapioca flour, baking powder, tapioca starch, | 0.75 parts ± 40%; |
| | potato starch, arrowroot powder | |
| | and/or cornstarch | |
| (5) | sodium bicarbonate | 0.10 parts ± 75%; |
| (6) | gum | 0.15 parts ± 65%; and |
| (7) | salt | 0.10 parts ± 35%. |

A further embodiment may include a sugar cookie mix comprising the following ingredients:

| | | |
|---|---|---|
| (1) | sugar | 7.00 parts ± 30%; |
| (2) | white rice flour | 6.00 parts ± 25%; |
| (3) | potato flour | 0.60 parts ± 40%; |
| (4) | tapioca flour | 0.20 parts ± 40%; |
| (5) | baking powder | 0.40 parts ± 35%; |
| (6) | brown rice flour | 0.30 parts ± 40%; |
| (7) | potato starch | 0.15 parts ± 40%; |
| (8) | sodium bicarbonate | 0.10 parts ± 75%; |
| (9) | xanthan gum | 0.15 parts ± 65%; and |
| (10) | salt | 0.10 parts ± 40%. |

The sugar cookie mix may further comprise 0.32 parts brown sugar, wherein the brown sugar may vary by up to ±35%. The sugar cookie mix may also comprise 0.03 parts dextrose and/or titanium dioxide, wherein the dextrose and/or titanium dioxide may vary by ±80%. In addition, the cookie mix may comprise 0.15 parts natural vanilla flavor, in an extract or powder, wherein the natural vanilla flavor may vary by up to ±40%.

A sugar cookie dough may comprise the following components at the indicated relative parts (weight) wherein each ingredient may vary by up to the indicated percentage:

| | | |
|---|---|---|
| (i) | sugar cookie mix | 2.33 parts ± 10%; |
| (ii) | daily free, soy-free butter | 0.50 parts ± 10%; and |
| (iii) | water and/or carbonated beverage | 0.50 parts ± 10%. |

Alternatively, the following components can be mixed to make the dough:

| | | |
|---|---|---|
| (i) | sugar cookie mix | 2.75 parts ± 10%; |
| (ii) | butter flavored shortening | 0.50 parts ± 10%; and |
| (iii) | water and/or carbonated beverage | 0.50 parts ± 10%. |

A method of making an allergen-free sugar cookie may comprise baking the sugar cookie dough at 350° F. to produce the allergen-free sugar cookie. Also included are allergen-free sugar cookies made by the disclosed method.

17. Pancake Waffle/Crêpe Mix

Allergen-free food compositions also include a pancake/waffle/crêpe mix comprising the following components added in the indicated number of parts (by weight) wherein each ingredient may vary by up to the indicated percentage:

| | | |
|---|---|---|
| (1) | white rice flour and/or brown rice flour | 11.50 parts ± 15% |
| (2) | sugar | 0.90 parts ± 35%; |
| (3) | powdered rice milk | 1.45 parts ± 10%; |
| (4) | baking powder, tapioca starch, tapioca starch, | 0.75 parts ± 35%; |
| | potato starch, arrowroot powder | |
| | and/or cornstarch | |
| (5) | salt | 0.30 parts ± 65%; |
| (6) | sodium bicarbonate | 0.25 parts ± 75%; and |
| (7) | gum | 0.10 parts ± 75%. |

A further embodiment may include a pancake/waffle/crêpe mix comprising the following ingredients:

| | | |
|---|---|---|
| (1) | white rice flour | 10.90 parts ± 15% |
| (2) | sugar | 0.90 parts ± 35%; |
| (3) | powdered rice milk | 1.45 parts ± 10%; |
| (4) | baking powder | 0.75 parts ± 35%; |
| (5) | brown rice flour | 0.60 parts ± 35%; |
| (6) | salt | 0.30 parts ± 65%; |
| (7) | sodium bicarbonate | 0.25 parts ± 75%; and |
| (8) | xanthan gum | 0.10 parts ± 75%. |

A pancake batter may comprise the following components at the indicated relative parts (weight) wherein each ingredient may vary by up to the indicated percentage:

| | | |
|---|---|---|
| (i) | pancake/waffle/crêpe mix | 1.00 parts ± 10%; |
| (ii) | oil | 0.06 parts ± 10%; |
| (iii) | rice milk (powdered or liquid) | 0.75 parts ± 10%; and |
| (iv) | water | 0.13 parts ± 10%. |

In one embodiment, the batter is refrigerated. In another embodiment, a method of making a pancake product comprises cooking the pancake batter under medium heat to produce a pancake product. Also provided are allergen-free pancakes made by the presently disclosed method.

A waffle batter may comprise the following components at the indicated relative parts (weight) wherein each ingredient may vary by up to the indicated percentage:

| | | |
|---|---|---|
| (i) | pancake/waffle/crêpe mix | 1.25 parts; ± 10%; |
| (ii) | oil | 0.06 parts; ± 10%; and |
| (iii) | rice milk (powdered or liquid) | 1.00 parts ± 10%, |

In one embodiment, the batter is refrigerated. In another embodiment, a method of making a waffle product comprises cooking the waffle batter to produce a waffle product. Also provided are allergen-free waffles made by the presently disclosed method.

A crêpe batter may comprise the following components at the indicated relative parts (weight) wherein each ingredient may vary by up to the indicated percentage:

| | | |
|---|---|---|
| (i) | pancake/waffle/crêpe mix | 1.00 parts ± 10%; |
| (ii) | oil | 0.06 parts ± 10%; |
| (iii) | rice milk (powdered or liquid) | 1.00 parts ± 10%; |
| (iv) | vanilla | 0.01 parts ± 10%; and |
| (v) | sugar | 0.03 parts ± 10%. |

In one embodiment, the batter is refrigerated. In another embodiment, a method of making a crêpe product comprises cooking the crêpe batter under medium heat to produce a crêpe product. Also provided are allergen-free crêpes made by the presently disclosed method.

### 18. Vanilla Frosting Mix

Allergen-free flour compositions include a frosting mix comprising the following components added in the indicated number of parts (by weight) wherein each ingredient may vary by up to the indicated percentage:

| | | |
|---|---|---|
| (1) | powdered sugar and/or sugar substitute | 13.61 parts ± 15%; and |
| (2) | powdered rice milk | 0.30 parts ± 35%. |

The frosting mix may further comprise 0.10 parts vanilla, e.g., natural vanilla flavor, in an extract or powder, wherein the vanilla may vary by up to ±75%. The frosting may also comprise 0.04 parts dextrose and/or titanium dioxide, wherein the dextrose and/or titanium dioxide may vary by up to ±80%.

Allergen-free frosting may comprise the following components at the indicated relative parts (weight) wherein each ingredient may vary by up to the indicated percentage:

| | | |
|---|---|---|
| (i) | frosting mix | 4.25 parts ± 10%; |
| (ii) | soy-free shortening | 0.50 parts ± 10%; |
| (iii) | rice milk (powdered or liquid) | 0.25 parts ± 35%; and |
| (iv) | water | 0.13 parts ± 10%. |

The vanilla frosting can be made by a method comprising (1) combining and beating the ingredients; and (2) beating on medium-high speed until thoroughly blended. For creamier frosting on cupcakes add additional water, 1 tablespoon at a time, until desired texture is reached. In one embodiment, regular soy-free shortening can be replaced with butter flavored soy-free shortening to make buttercream frosting. Two cups frosting would be sufficient for 1 cake or 12 cupcakes.

In one embodiment, the method is conducted at high altitude without changes. Also included is frosting made by the disclosed method. In one embodiment, the chocolate frosting may be frozen or refrigerated.

### 19. Chocolate Frosting Mix

Allergen-free flour compositions include a chocolate frosting mix comprising the following components added in the indicated number of parts (by weight) wherein each ingredient may vary by up to the indicated percentage:

| | | |
|---|---|---|
| (1) | powdered sugar and/or sugar substitute | 12.45 parts ± 15%; |
| (2) | cocoa powder | 1.15 parts ± 20%; and |
| (3) | powdered rice milk | 0.30 parts ± 35%. |

Allergen-free chocolate frosting may comprise the following components at the indicated relative parts (weight) wherein each ingredient may vary by up to the indicated percentage:

| | | |
|---|---|---|
| (i) | the chocolate frosting | 2.25 parts ± 10%; |
| (ii) | soy free shortening | 0.50 parts ± 10%; |
| (iii) | rice milk (powdered or liquid) | 0.25 parts ± 10%; and |
| (iv) | water | 0.50 parts ± 10%. |

The chocolate frosting can be made by a method comprising (1) combining and beating the ingredients; and (2) beating on medium-high speed until thoroughly blended. For creamier frosting on cupcakes add additional water, 1 tablespoon at a time, until desired texture is reached. Two cups frosting would be sufficient for 1 cake or 12 cupcakes.

In one embodiment, the method is conducted at high altitude without changes. Also included is chocolate frosting made by the disclosed method. In one embodiment, the chocolate frosting may be frozen or refrigerated.

### 20. Sauce & Gravy Mix

Allergen-free flour compositions include a sauce & gravy mix comprising the following components added in the indicated number of parts (by weight) wherein each ingredient may vary by up to the indicated percentage:

| | | |
|---|---|---|
| (1) | sweet, white, or brown rice flour | 9.40 parts ± 15%; and |
| (2) | cornstarch, tapioca starch, tapioca starch, | 3.96 parts ± 35%. |
| | baking powder, arrowroot powder and/ | |
| | or potato starch | |

A further embodiment may include a sauce & gravy mix comprising

| | | |
|---|---|---|
| (1) | sweet, white, or brown rice flour | 9.40 parts ± 15%; |
| (2) | cornstarch | 3.76 parts ± 35%; and |
| (3) | tapioca flour | 0.20 parts ± 75%. |

The sauce & gravy mix may further comprise 0.40 parts salt, wherein the salt may vary by up to ±30%. The sauce & gravy mix may also comprise 0.06 parts white pepper, wherein the white pepper may vary by up to ±80%, in addition, the sauce & gravy mix may also comprise 0.40 parts waxy rice flour, wherein the waxy rice flour may vary by up to ±30%.

Allergen-free basic white sauce may comprise the following components at the indicated relative parts (weight) wherein each ingredient may vary by up to the indicated percentage:

| | | |
|---|---|---|
| (i) | the sauce & gravy mix | 0.13 parts ± 10%; |
| (ii) | oil and/or water | 0.13 parts ± 10%; |
| (iii) | rice milk (powdered or liquid) | 0.75 parts ± 10%; and |
| (iv) | vegetable broth | 0.25 parts ± 10%, |

The ingredients are stirred together and heated to boiling over medium heat for 1-2 minutes. Also included are the basic white sauces made by the disclosed method.

Allergen-free basic butter cream sauce may comprise the following components at the indicated relative parts (weight) wherein each ingredient may vary by up to the indicated percentage:

| | | |
|---|---|---|
| (i) | sauce & gravy | 0.13 parts ± 10%; |
| (ii) | dairy free, soy-free butter | 0.13 parts ± 10%; |
| (iii) | rice milk (powdered or liquid) | 0.50 parts ± 10%; and |
| (iv) | vegetable broth | 0.25 parts ± 10%. |

The ingredients are stirred together and heated to boiling over medium heat for 1-2 minutes. Also included are the butter cream sauces made by the disclosed method.

Allergen-free gravy may comprise the following components at the indicated relative parts (weight) wherein each ingredient may vary by up to the indicated percentage:

| | | |
|---|---|---|
| (i) | the sauce & gravy mix | 0.125 parts ± 10%; |
| (ii) | meat broth | 1.000 parts ± 10%; and |
| (iii) | water and/or oil | 0.125 parts ± 10%. |

The ingredients are stirred together and heated to boiling over medium heat for 1-2 minutes. Also included are the gravies made by the disclosed method.

### 21. Pie Crust/Pastry Mix

Allergen-free flour compositions include a pie crust mix comprising the following components added in the indicated number of parts (by weight) wherein each ingredient may vary by up to the indicated percentage:

| | | |
|---|---|---|
| (1) | white rice flour and/or brown rice flour | 10.13 parts ± 15%; |
| (2) | sugar | 3.00 parts ± 30%; |
| (3) | baking powder, cornstarch, tapioca starch, | 2.50 parts ± 35%; |
| | tapioca starch, arrowroot powder and/ | |
| | or potato starch | |
| (4) | gum | 0.35 parts ± 65%; |
| (5) | vinegar | 0.15 parts ± 75%; and |
| (6) | salt | 0.12 parts ± 65%. |

A further embodiment may include a pie crust mix comprising:

| | | |
|---|---|---|
| (1) | white rice flour | 9.43 parts ± 15%; |
| (2) | sugar | 3.00 parts ± 30%; |
| (3) | baking powder | 1.80 parts ± 35%; |
| (4) | brown rice flour | 0.70 parts ± 30%; |
| (5) | potato starch | 0.70 parts ± 30%; |
| (6) | xanthan gum | 0.35 parts ± 65%; |
| (7) | vinegar | 0.15 parts ± 75%; and |
| (8) | salt | 0.12 parts ± 65%. |

Allergen-free pie crust may comprise the following components at the indicated relative parts (weight) wherein each ingredient may vary by up to the indicated percentage:

| | | |
|---|---|---|
| (i) | the pie crust mix | 3.00 parts ± 10%; |
| (ii) | soy-free shortening | 1.00 parts ± 10%; and |
| (iii) | ice cold water | 1.00 parts ± 10%. |

In one embodiment, the pie dough may be frozen or refrigerated.

The pie dough may be used in a method of making a pie crust comprising (1) beating the soy-free shortening and ice cold water; (2) mixing in the pie crust mix to form a pie dough; (3) forming a pie crust from the pie dough; (4) baking at 400° F. for about 10 minutes; (5) adding fillings; and (6) baking at 350° F. for 12-15 minutes or until the pie crust begins to turn golden. In one embodiment, the method is conducted at high altitude without changes. Also included are refrigerated pie crusts made by the disclosed method.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A depicts a bread product made using a Jules Shepard recipe.

FIG. 1D depicts a bread product made using a Pamela's Products recipe.

FIG. 1C depicts a cutaway bread product made using the presently disclosed bread recipe.

FIG. 1D depicts a bread product made using the presently disclosed bread recipe next to a ruler.

FIG. 2A depicts a cake made using a Namaste Foods recipe.

FIG. 2B depicts a cake made using an Arrowhead Mills recipe.

FIG. 2C depicts an allergen-free cake made using the presently disclosed vanilla cake recipe.

FIG. 3 depicts an allergen-free muffin made using the presently disclosed muffin recipe.

FIG. 4 depicts an allergen-free cookie made using the presently disclosed cookie recipe.

### DETAILED DESCRIPTION

In the present flour compositions, no single flour, starch, or other component (e.g., gum) substitutes for gluten or other major food allergen. Instead, the particular combination of replacement flours, starches, and other components imparts a distinctive texture, gloss, firmness, cohesiveness, etc., to the final allergen-free baked product. The quality of the final baked product in fact depends on the balance of each of the replacement flours, starches, and other components in the final baked product. For example, a simple adjustment of one component, such as baking powder, does not achieve this balance. The relative amounts of each flour and starch in presently disclosed flour compositions have been optimized for taste, firmness, rise, texture, and cohesiveness of the baked product.

The relative amounts of the various components in the mixes, dough, etc., are expressed as “parts.” Parts are measured in terms of relative weight. The present compositions may be scaled up without readjustment of the relative weight of the components. For example, in a flour containing 0.580 parts of sugar, 0.580 lb of sugar is added, when 1 part=1 lb. When 1 part=2 lb, for example, 1.160 lb would be added to the flour, etc. To convert the volume of water or other liquids to weight, 1 millimeter liquid equals 1 gram weight. Unless stated otherwise, “gum” means a gelling agent, including guar gum, xanthan gum, agar-agar gum, gelatin, cellulose, pectin, and locust bean gum.

Unless stated otherwise, “salt” means kosher salt, crystalline sea salt, flaked sea salt, pickling salt, rock salt, sea salt, table salt, or a salt substitute equivalent, e.g., sodium-free salt, NoSalt®, or AlsoSalt®.

Unless stated otherwise, “sugar” means granulated sugar, agave, powdered sugar, maple sugar, evaporated cane juice, honey, raw sugar, table sugar, stevia sweetener, dextrose, or an artificial sugar or sugar substitute, “Sugar” can come from cane or beet, for example.

“Brown sugar” includes natural brown sugar, as well as artificial brown sugar and brown sugar substitutes, such as Organic Sucanat®.

Unless otherwise stated, “allergen free oil” means canola oil, corn oil, olive oil, safflower oil, sesame oil, or sunflower oil.

Unless otherwise stated, “molasses” means molasses powder, liquid molasses, dark corn syrup, honey, or maple syrup.

Baked products disclosed herein can be made without any major food allergen, including eggs, milk (all dairy), butter, soy flour, and grains rich in gluten. A “major food allergen” means one of the following eight listed foods: (1) milk, (2) eggs, (3) fish, (4) crustacean shellfish, (5) tree nuts, (6) peanuts, (7) grains, or (8) soy, or an ingredient that contains protein derived from one or more of these eight foods. “Milk” means all dairy, e.g., butter, cow's milk. Tree nuts include almonds, beech nuts, brazil nuts, butternuts, cashews, chestnuts, chinquapin, coconuts, hazel huts, ginko nuts, hickory nuts, lychee nuts, macadamia nuts, pine nuts, pili nuts, pistachios, pecans, sheanuts, and walnuts. “Grain,” for the purpose of this disclosure, means grains containing any gluten. Such grains include gains from wheat, rye, and barley and Triticum species, such as spelt, kamut, or durum wheat, or a crossbred hybrid of these grains. Oats are gluten-free, but often contain contaminants from cross-contamination during manufacturing and processing from equipment used to process gluten-containing equipment, etc.

A “major food allergen” includes an ingredient that contains protein derived from one or more of the eight listed foods. An ingredient that contains protein derived from gain, for example, includes wheat bran, bulgur wheat, couscous, barley malt, wheat germ, and semolina. Ingredients are “gluten-free” if they contain 20 parts per million (ppm) or less of gluten. Ingredients that contain protein derived from milk, for example, include dairy products (synonymous with “derivatives”), such as butter, cow's milk, buttermilk, yogurt, and whey. Examples of ingredients that contain protein derived from soy, for example, include soy flour, lecithin, hydrolyzed soy protein, and soy-derived miso. Other ingredients that contain protein derived from a major food allergen include edible oils, starch, hydrolyzed proteins (e.g., partially hydrolyzed casein), flavors, or incidental additives made from a major food allergen.

Unless otherwise specified, an “allergen-free” baked product is free of all major food allergens. In some embodiments, baked products may contain eggs, e.g., whole eggs or egg Whites. In other embodiments, baked products may contain milk, e.g., dairy products. Dairy products may be used in allergen-free baked products to increase water absorption and the handling properties of the batter. Accordingly, the disclosure provides allergen-free baked products that also are free of milk and ingredients that contains protein derived from milk.

The baked product may contain no additive that substitutes for a major food allergen. Examples of such additives include the gluten substitutes sodium stearoyl lactylate, hydroxypropyl methylcellulose (HPMC), methylcellulose, and carboxymethylcellulose (CMC). In other embodiments, such additives may be used to provide various qualities to the baked product, e.g., texture, in combination with the other components of the compositions. The baked product may contain an additive, such as an artificial flavor, food additive, food coloring, preservative (e.g., citric acid), or sugar substitute (e.g., artificial sweetener). In some embodiments, the additive does not contain protein derived from a major food allergen. For example, the allergen-free baked product may contain raisins, poppy seeds, herbs, dairy-free, soy-free chocolate chips or chunks (e.g., SOY FREE SALES), etc.

The flour or baked product is “free” of a major food allergen, if no major food allergen is added to the flour or baked product composition. Trace amounts of allergens may be introduced into the flour or baked product through contaminated kitchen surfaces or utensils, for example. Such contamination may be minimized or prevented by using kitchen surfaces and utensils devoted to preparing allergen-free flours and baked products. In some embodiments, a flour or baked product is “free” of a major food allergen, if it contains sufficiently low levels of major food allergens to avoid an allergic reaction. The amount of a major food allergen may be 200, 100, 50, or 20 ppm or less by weight in the flour or baked product. In one embodiment, a flour or baked product contains 20 ppm or less of each major food allergen. The flour or baked product may be gluten-free, i.e., it may contain 20 ppm or less of gluten.

An “allergy” includes food allergies and food intolerances, e.g., lactose intolerance, gastrointestinal disorders from gluten and diary products.

The term “vanilla” means all vanilla flavoring products, including liquid or powered vanilla, natural or imitation vanilla.

As used herein the term “warm water” means any temperature of water that can activate yeast. “Warm water” may be in a temperature range of about 100° F. to 130° F., or more specifically about 105° F. to 110° F.

As used herein the term “cold water” means ice-cold water, “Cold water” may be in a temperature range of about 32° F. to 45° F.

“Shelf stable food” is food of a type that would normally be stored refrigerated but which has been processed so that it can be safely stored in a sealed container at room or ambient temperature for a usefully long shelf life.

Unless otherwise indicated, the present baked products may be made at high altitude without adjustment of the flour, batter, or dough compositions. “High altitude,” as used herein, means 3500-6500 feet above sea level. All times and temperatures for cooking are provided for conditions at sea level and not for baking conditions at high altitudes; baking times and temperatures would be modified as necessary for high altitudes, as is known in the art or as specifically indicated herein.

All the disclosed ingredients can be substituted the same ingredient in organic form.

1. Grain Substitutes

Allergen-free food compositions may be free of “grains,” as defined above, or an ingredient that contains protein derived from one of these grains. Gluten is a major protein component of the grains defined above as major food allergens. Gluten is commonly used as a major binding ingredient and protein source in flour compositions, so its removal necessitates adding a suitable replacement. Various replacement flours and starches are therefore provided as components of an allergen-free flour composition. Grain replacements include starches and flours from amaranth, buckwheat (i.e., beechwheat or saracen corn), corn, cornmeal (i.e., maize), bean flours (e.g., fava bean, garbanzo bean), quinoa, gram (i.e., chickpea or garbanzo flour), isomalt (made from sugar beet rather than barley malt), lentils, millet, oats (barring cross-contamination), polenta (a coarsely ground, whole corn meal), potato, quinoa, rice (brown, white, and wild), sorghum, teff, tapioca, and all forms of modified tapioca (e.g., EXPANDEX®). Replacement starches may be made from arrowroot, corn, potato, tapioca, and modified tapioca (e.g., EXPANDEX®).

Several of the replacement flours and starches above may be used interchangeably in an allergen-free flour composition. Baking powder, tapioca flour, tapioca starch, potato starch, cornstarch, and arrowroot powder, for example, may be used interchangeably to make the present flour compositions. Brown, white, and wild rice flours also are interchangeable. Teff flour and sorghum flour are also interchangeable. Interchangeable components may be substituted in whole or in part on a 1:1 weight basis.

2. Milk Substitutes

Allergen-free flour compositions also may be free of milk or an ingredient (i.e., dairy product) that contains protein derived from milk, e.g., butter, cream cheese, fromage frais, margarine, and shortenings. Milk and dairy products commonly serve as moisturizers and/or structural enhancers for baked products. When a liquid substitute for milk is needed, allergen free oils can be used. Such allergen free oils include canola oil, corn oil, olive oil, safflower oil, sesame oil, and sunflower oil. The allergen free liquid milk substitute may also include rice milk, rice milk, concentrate, or hemp milk. Rice milk may be added as liquid rice milk, a rice milk concentrate, or powdered rice milk. Powdered rice milk is a rice syrup powder, rice starch, and rice flour, which can be used as a replacement for powdered milk. Rice milk has a lower fat content than whole milk or many milk substitutes, e.g., soymilk, almond milk, and coconut milk. Use of rice milk advantageously can provide a low-fat and cholesterol-free food composition. For example, 8 oz rice milk contains only 2 gams of fat and 0 grams of cholesterol.

Other suitable moisturizers include ascorbic acid (in powdered form) and vinegar (in powdered or liquid form). Suitable vinegars include cider vinegar, balsamic vinegar, cane vinegar, fruit vinegar, red wine vinegar, rice vinegar, sherry vinegar, white vinegar (distilled), and white wine vinegar. Vinegars may be in powder or liquid form. Replacement butters include Dairy Free, Soy Free Butter (e.g., EARTH BALANCE®).

3. Egg Substitutes

In conventional baking, eggs are an essential ingredient and the role of eggs are critical to a successful outcome. Eggs provide richness, color, protein, and tenderness. In a cake that uses egg proteins, like the gluten proteins, help build the structure of the cake. The proteins in eggs enable them to act as leavens. Proteins unwind and stretch to form the flexible, elastic film that encases air bubbles. When eggs are beaten, they can expand to foam that is up to eight times their original volume. Beaten egg whites hold millions of tiny air bubbles, which lift cakes. While the elasticity of proteins is lost when eggs are cooked, the firming of proteins allows eggs to perform yet another function. As their proteins coagulate, eggs bind ingredients together. Eggs are a binding agent, which is a compound that connects the ingredients to one another in a semi-solid form. Without adequate binding, the ingredients in a cake or other baked item will not remain mixed and will not hold their form. Eggs provide leavening to help create and retain bubbles that will expand during baking, thus creating a lighter, fluffier baked product. Egg whites are 88 percent water, and each egg contributes liquid to a recipe, which serves as a toughener, especially the egg white portion. But too many egg whites in a reduced fat cake recipe, for example, make it dry. Beaten egg whites provide extra volume and air, while the yolks contribute to color, flavor, and texture of baked products. The yolk functions to emulsify fat and liquids due to its lecithin content. Including at least one whole egg helps to tenderize.

Powdered and frozen egg replacers usually consist of egg whites mixed with vegetable gum. The test kitchen staff at “Cook's Illustrated” magazine compared frozen egg replacers as a cake ingredient and found them to be a “reasonable” replacement for real eggs, although the finished cake texture was slightly gummy and required covering with icing to mask the finish.

The problem with egg substitutes in baking is there is no exact replica that has the same unique elements and produces the same result in baking. For example, tofu (which comes from soybean) can make baked products firm while applesauce will make products extra moist and have a distinct apple taste. Egg whites may help with the baking result, but are still allergenic and are an animal by-product.

The presently disclosed products are allergen-free, so they are free of eggs and gluten. The ability to replace eggs to make acceptable allergen-free baked products is surprising, (As used herein, the terms egg replacer and egg substitute are used interchangeably.)

In one example of the disclosed batters and dough, eggs can be replaced with a mixture of water and ground flax (regular flax or golden flax). The flax typically may be all golden flax. The components may be mixed by beating with a hand mixer, e.g., an electric mixer. Once mixed, the egg substitute may be stored at room temperature, refrigerated, or frozen. One egg may be replaced with 0.0450 lb flax mixed with 0.0887 lb of water. The weights of flax and water are doubled when replacing two eggs, and so on. In another embodiment of the disclosed allergen-free compositions, methylcellulose, when blended with the appropriate amounts of other components, can replace the functions normally provided by eggs.

The subject matter of the disclosure is described in further detail in the following examples. The following examples are offered to illustrate, but not to limit, the embodiments described herein and the claims set forth

### EXAMPLES

### Example 1

Allergen-free baked products according to the present disclosure have a moistness, springiness, texture, and rise comparable to traditional baked products. Representative baked products of the present disclosure were compared with gluten-free baked products prepared using other recipes.

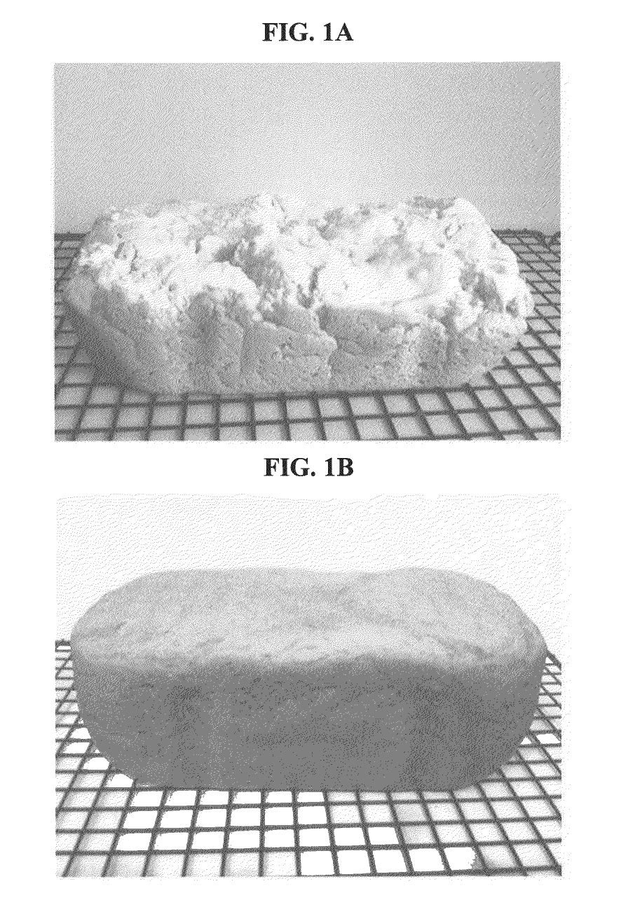

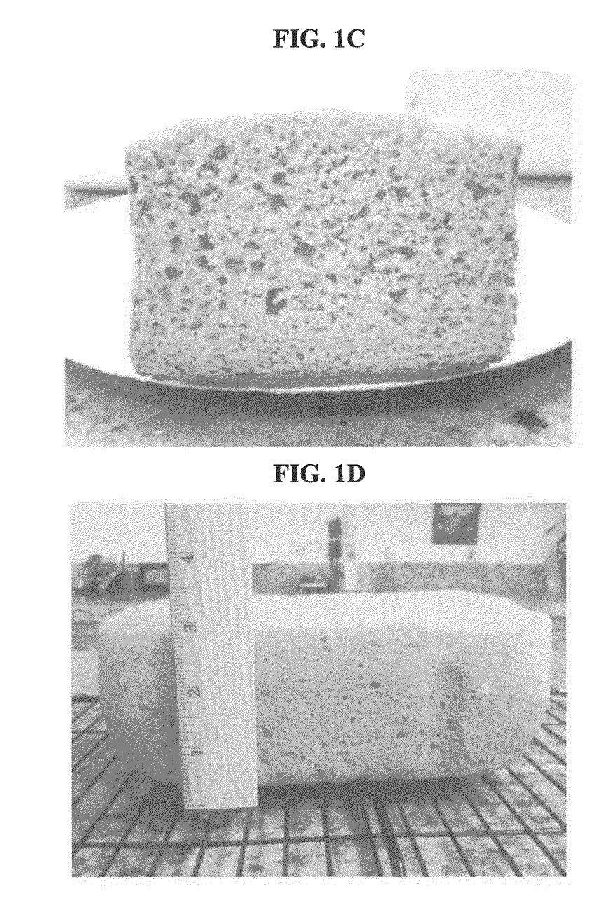

In one example, an allergen-free bread product was made as disclosed in Example 10, below. FIG. 1C shows a cutaway bread loaf made with this flour. FIG. 1D shows a rule next to the bread loaf, for purposes of scale. As apparent from FIG. 1C and 1D, the present bread has an acceptable color, texture, and rise.

For comparison, a bread made with Jules™ gluten-free all purpose flour also was prepared. A photograph of this bread is shown in FIG. 1A. The Jules™ gluten-free flour is disclosed in U.S. Published Application No. 2009/0123627 A1. The recipe for making the bread calls for:

4¼ cup Jules™ gluten-free flour;

1⅓ cup water;

4 tbl sugar;

2 tbl dry milk;

2 tsp salt;

2½ butter;

2 tsp yeast; and

2 whole eggs.

A bread made with Pamela's™ Products gluten-free bread mix also was prepared. A photograph of this bread is shown in FIG. 1B. The recipe for making the bread calls for:

1 bag (19 oz) Pamela's Mix;

1 packet yeast;

¼ cup oil; and

2 whole eggs.

Properties of the three breads were compared by a blind assay. The weight (grams) of each loaf was measured, as was the volume (cc) of a quarter of the loaf. The firmness of the loaves was measured (grains) by applying a steady pressure from a probe to the top of the loaves. The resistance against the probe was measured before the probe penetrated the top of the loaves. The results shown in Table 1 were obtained:

TABLE 1

| | | | Allergen- |
|---|---|---|---|
| | Jules ™ | Pamela's ™ | Free Bread |
| | gluten-free | Products | Product of |
| | Bread | Bread | Example 1 |
| Weight (g) | 980.0 | 883.1 | 915.4 |
| Volume (cc) | 1274 | 1607 | 1801 |
| Rel. Density (wt/vol) | 0.769 | 0.550 | 0.504 |
| Firmness (g) | 5399 | 1429 | 1266 |

As evidenced in Table 1, the present allergen-free bread, even though it was made without eggs, has a lower density and firmness, compared to gluten-free breads. This gives the present allergen-free bread an appealing lighter texture. The lighter texture of the present breads is also evident by comparison of FIG. 1A, B, and C.

### Example 2

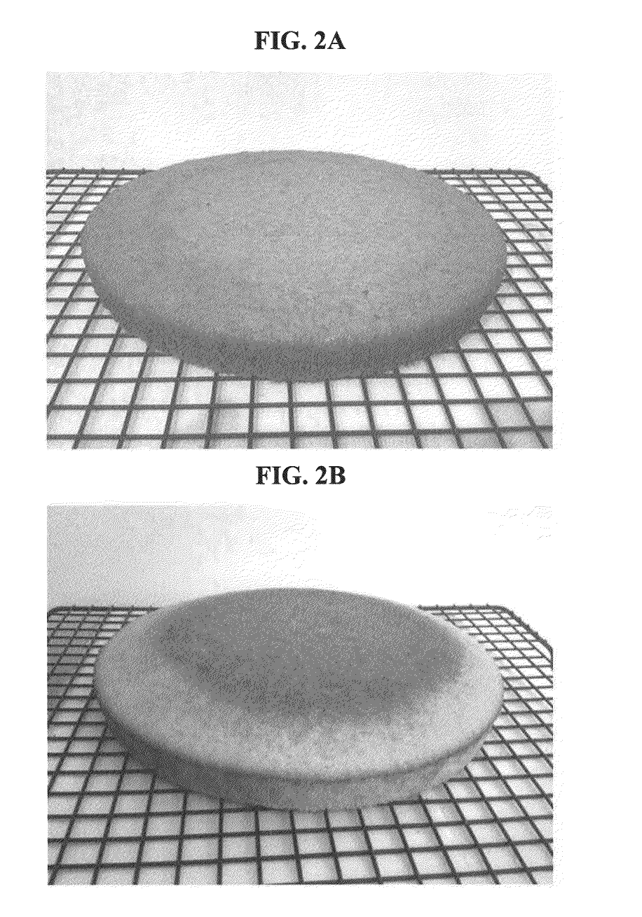

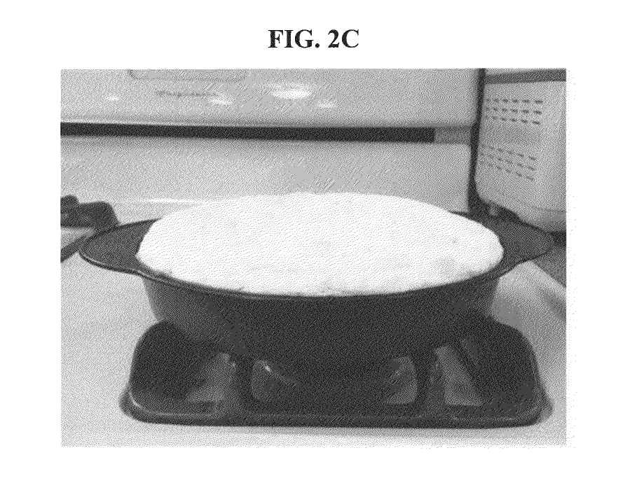

In another example, an allergen-free vanilla cake was made as disclosed in Example 4, below. FIG. 2C shows a cake made with this flour. As apparent from FIG. 2C, the present allergen-free cake has an acceptable color and rise.

For comparison, a cake was made with a gluten-free vanilla cake mix from Namaste Foods, LLC. The flour mix generally is made in a dedicated facility free of gluten, wheat, soy, corn, potato, peanuts, tree nuts, dairy, and casein. To prepare the vanilla cake, 1 bag (26 oz) of the cake mix was mixed with 3 eggs, ½ cup oil, and 1 cup water. A cake prepared using this mix is shown in FIG. 2A.

Another cake was made with a gluten-free vanilla cake mix from Arrowhead Mills. The mix is gluten-free and wheat-free and is made with rice flour, evaporated cane juice, potato starch, buttermilk solids, tapioca starch, baking powder, vanilla flavor, sea salt, and xanthan gum. The recipe for making cakes requires the contents of 1 box (20.9 oz), ½ cup canola oil, 1 cup water, and 2 eggs.

Properties of a single layer of the three cakes were compared by a blind assay. The weight (grams) of each layer was measured, as was the volume (cc) of a quarter of the layer. The firmness of the cakes was measured (grams) by applying a steady pressure from a probe to the top of the cakes. The resistance against the probe was measured before the probe penetrated the top of the cakes. The results shown in Table 2 were obtained:

TABLE 2

| | Namaste | Arrowhead | Allergen-Free Vanilla |
|---|---|---|---|
| | Foods Cake | Mills Cake | Cake of Example 4 |
| Weight (g) | 833.2 | 953.6 | 913.2 |
| Volume (cc) | 1354 | 1465 | 1419 |
| Rel. Density | 0.615 | 0.651 | 0.644 |
| (wt/vol) | | | |
| Firmness (g) | 931 | 1000 | 617 |

As evidenced in Table 2, the present allergen-free cake, even though it was made without eggs, has a comparable density and lower firmness, compared to gluten-free cakes. This gives the present allergen-free cakes an appealing lighter texture.

### Example 3

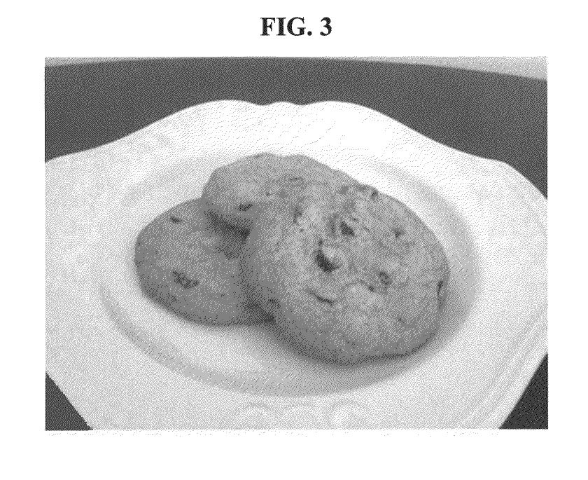

The following example describes a recipe for allergen-free chocolate chunk/chip cookies. Representative chocolate chunk/chip cookies made using the present recipe are depicted in FIG. 3.

Cookie Mix

| Ingredient | Weight (lb) |
|---|---|
| Cookie Flour | 0.66065 |
| Baking Soda | 0.01225 |
| Salt (table) | 0.01470 |
| Pure Vanilla Powder | 0.00625 |
| Granulated Sugar | 0.37700 |
| Brown Sugar | 0.27000 |

Cookie Flour

| Ingredient | Weight (lb) |
|---|---|
| Tapioca Starch | 0.45000 |
| Potato Starch | 0.27000 |
| Brown Rice | 0.20000 |
| Flour | |
| Potato Flour | 0.15000 |
| White Rice Flour | 0.10000 |
| Teff | 0.10000 |
| Pea Protein | 0.10000 |
| Xanthan Gum | 0.01300 |

### Materials Needed:

1 bag (1.3408 lb) Cookie Mix

1-2 bags (0.300-0.756 lb) of dairy free, soy free chocolate chunks/chips or chunks

1 cup (2 sticks) (0.49335 lb) dairy free, soy-free butter or margarine, softened

Egg substitute (2 egg equivalent): 0.09000 lb ground golden flax and 0.17740 lb water

### Instructions:

1. Preheat oven to 325° F.,
2. In a medium size bowl, beat butter, and egg substitute with a hand mixer or by another means of mixing.
3. Using a fork, gradually add cookie mix and mix ingredients together thoroughly. Do not beat with hand mixer. Keep mixing until completely blended. Do not add additional water.
4. Stir in the chocolate chunks/chips or Chunks.
5. Drop by rounded tablespoon onto ungreased baking sheets. Press and flatten with the bottom of the spoon.
6. Bake for 12-15 minutes or until golden brown.
7. Cool on baking sheets for 2 minutes.
8. Remove to wire racks to cool completely.
   Makes about 4 dozen cookies.
   High Altitude: No change.

### Example 4

The following example describes a recipe for allergen-free vanilla cakes. A representative vanilla cake made using the present recipe is depicted in FIG. 2C.

Vanilla Cake Mix

| Ingredient | Weight (lb) |
|---|---|
| Cake Flour | 0.61000 |
| Granulated Sugar | 0.58020 |
| Powdered Rice Milk Base | 0.08770 |
| Baking Powder | 0.03285 |
| Salt (table) | 0.00810 |
| Cream of Tartar | 0.00780 |
| Pure Vanilla Powder | 0.00625 |
| Dextrose, Titanium | 0.00500 |
| Dioxide | |

Cake Flour

| Ingredient | Weight (lb) |
|---|---|
| Tapioca Starch | 0.45000 |
| Potato Starch | 0.27000 |
| Brown Rice | 0.20000 |
| Flour | |
| Potato Flour | 0.15000 |
| White Rice Flour | 0.10000 |
| Teff | 0.10000 |
| Pea Protein | 0.10000 |
| Xanthan Gum | 0.01300 |

### Materials Needed:

1 bag (1.33790 parts) Vanilla Cake Mix
Egg substitute (2 egg equivalent): 0.09000 lb ground golden flax and 0.17740 lb water
½ cup all soy-free shortening (0.17820 lb)
1 cup (0.52280 lb) water

### Instructions:

1. Preheat oven to 300° F.
2. Cut the soy-free shortening until fine crumbs are formed and place in a medium size bowl.
3. Add egg substitute and beat with a hand mixer.
4. Gradually beat in flour mixture at a low speed for 1 minute, then high for 3 minutes, scraping the bowl frequently.
5. Using two 9″×9″ inch square/round pans or one 9″×13″ pan spray with non-sticking cooking spray.
6. Pour batter into pan and spread evenly with spatula. The batter may seem heavier to spread.
7. Bake for 35-40 minutes or until baked through.
8. Check doneness by placing toothpick in the center of the cake. If the dough pulls through on the toothpick, add additional time until no dough remains on the toothpick.
9. Cool 5 minutes before removing from cake pan.
10. Invert to remove from pan and place on wire rack.
11. Cool completely. Add frosting.
   Makes 1 layer cake. 12 servings.
   High Altitude: No change.

### Variation:

Coconut Cake: add ¼ tsp coconut extract.
Lemon Cake: add 1 TBSP gated lemon zest, ½ cup fresh lemon juice. Decrease water to ½ cup.

### Vanilla Cupcakes:

### Instructions:

1. Follow the directions listed above.
2. Instead of using as cake pan, use a muffin pan.
3. Using a standard muffin pan, fill in each muffin mold until ½ full.
4. Bake for 20-25 minutes or until baked through.
5. Cool 5 minutes before removing from muffin pan,
6. Cool completely. Add frosting,
   Makes 12 cupcakes.
   High Altitude: No change.

### Example 5

The following example describes a recipe for allergen-free chocolate cakes.

Cake Flour

| Ingredient | Weight (lb.) |
|---|---|
| Tapioca Starch | 0.45000 |
| Potato Starch | 0.27000 |
| Brown Rice | 0.20000 |
| Flour | |
| Potato Flour | 0.15000 |
| White Rice Flour | 0.10000 |
| Teff | 0.10000 |
| Pea Protein | 0.10000 |
| Xanthan Gum | 0.01300 |

Chocolate Cake Mix

| Ingredient | Weight (lb.) |
|---|---|
| Cake Flour | 0.61000 |
| Granulated Sugar | 0.58020 |
| Powdered Rice Milk | 0.08770 |
| Base | |
| Cocoa Powder | 0.07000 |
| Baking Powder | 0.03285 |
| Salt (table) | 0.00810 |
| Cream of Tartar | 0.00780 |
| Pure Vanilla Powder | 0.00625 |

### Materials Needed:

### 1 bag (1.40590 lb) Chocolate Cake Mix

Egg substitute (2 egg equivalent): 0.09000 lb ground golden flax and 0.17740 lb water
½ cup (0.17820 lb) all soy-free shortening
1 cup (0.52280 lb) water

### Instructions:

1. Preheat oven to 300° F.
2. Cut the soy-free shortening until fine crumbs are funned and place in a medium size bowl.
3. Add egg substitute and beat with hand mixer,
4. Gradually beat in flour mix at a low speed for 1 minute, then on high for 3 minutes, scraping the bowl frequently.
5. Using two 9″×9″ inch square/round pans or one 9″×13″ pan spray with non-sticking cooking spray.
6. Pour batter into pan and spread evenly with spatula. Batter may seem heavier to spread.
7. Bake for 35-40 minutes or until baked through.
8. Check doneness by placing toothpick in the center of the cake. If dough pulls through on the toothpick, add additional time until no dough remains on the toothpick.
9. Cool 5 minutes before removing from cake pan.
10. Invert to remove from pan and place on wire rack.
11. Cool completely. Add frosting.
   Makes 1 layer cake. 12 servings.
   High Altitude (3500-6500 ft.): No change.

### Chocolate Cupcakes:

### Instructions:

1. Follow the directions listed above.

2. Instead of using a cake pan, substitute for a muffin pan.

3. Using a standard muffin pan, fill in each muffin mold until ½ full.

4. Bake for 20-25 minutes or until baked through.

5. Cool 5 minutes before removing from muffin pan.

6. Cool completely. Add frosting.

Makes 12 cupcakes.
High Altitude (3500-6500 ft.): No change.

### Example 6

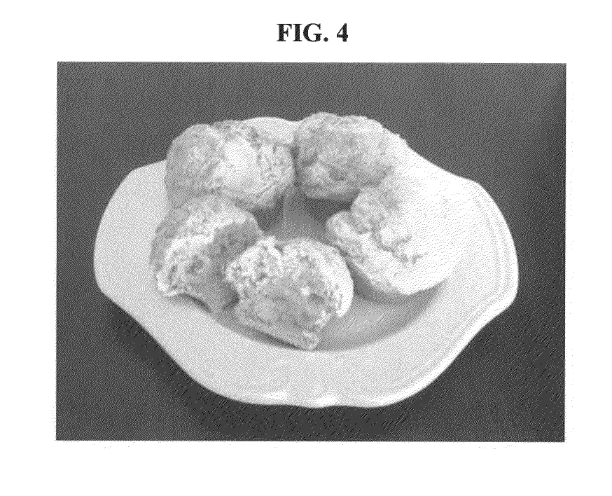

The following example describes a recipe for allergen-free muffins. Representative muffins prepared by the present recipe are depicted in FIG. 4.

Muffin Flour

| Ingredient | Weight (lb) |
|---|---|
| Tapioca Starch | 0.45000 |
| Potato Starch | 0.27000 |
| Brown Rice | 0.20000 |
| Flour | |
| Potato Flour | 0.15000 |
| White Rice | 0.10000 |
| Flour | |
| Teff | 0.10000 |
| Pea Protein | 0.10000 |
| Xanthan Gum | 0.01300 |

Muffin Mix

| Ingredient | Weight (lb) |
|---|---|
| Muffin Flour | 0.51720 |
| Baking Powder | 0.03215 |
| Salt (table) | 0.01570 |
| Granulated Sugar | 0.12640 |
| Powdered Rice | 0.53475 |
| Milk Base | |

### Materials Needed:

### 1 bag (1.22620 lb) Muffin Mix

Egg substitute (2 egg equivalent): 0.09000 lb ground golden flax and 0.17740 lb water
⅔ cup (0.29540 lb) canola oil
1½ cup (0.77950 lb) water

### Instructions:

1. Preheat oven to 320° F.
2. Beat oil and egg substitute.
3. Gradually add mix and heat.
4. Grease muffin pan or spray with nonstick cooking spray.
5. Using a standard muffin pan, fill in each muffin mold until ⅔ full.
6. Bake for 25-30 minutes or until baked through.
7. Check doneness by placing toothpick in center of muffin. If the dough pulls through on the toothpick, add additional time until no dough remains on the toothpick.
8. Cool 5 minutes before removing from muffin pan.
9. Remove to wire racks to cool completely.
   Makes about 12 medium muffins,
   High Altitude: No change.

### Variation:

Apple: add 2 cups shredded apple, and replace water with applesauce or apple juice.
Banana: add 2 cups ripe mashed bananas.
Blueberry: add 2 cups fresh or frozen blueberries.
Berry: add 1 cup each fresh or frozen raspberries and blackberries.
Carrot Raisin: add 2 cups shredded carrots and 1 cup raisons.
Chocolate Chip: add 2 cups dairy free, soy free chocolate chips or chunks.
Cinnamon Sugar: add ¼ cup sugar and ½ tsp cinnamon. For topping, mix ¼ cup sugar and ¾ tsp cinnamon in small bowl. Immediately dip the top of the muffin with ½ cup melted dairy free, soy free butter or margarine, then top with the sugar-cinnamon mixture.
Dried Cranberry Apple: add 2 cups shredded apple and ½ cup dried cranberries.
Poppy Seed: add ½ tsp poppy seeds per muffin.
Pumpkin Raisin: add 15 oz. can pumpkin, ½ tsp cinnamon, ¼ tsp nutmeg, and 1 cup raisins.
Tropical: substitute 10.5 oz. coconut milk for water, add 2 cups dried diced tropical fruit, and add 1 cup shredded coconut.
Zucchini: add 2 cups shredded zucchini.

### Example 7

The following example describes a recipe for an allergen-free baking mix and baked products produced with the mix.

Baking Mix

| Ingredient | Weight (lb.) |
|---|---|
| Pancake and | 1.86240 |
| Baking Flour | |
| Rice Milk Powder | 0.10450 |
| Granulated Sugar | 0.05440 |
| Baking Powder | 0.03100 |
| Salt (table) | 0.01560 |
| Baking Soda | 0.01250 |

Baking Hour

| | Weight |
|---|---|
| Ingredient | (lb.) |
| White Rice Flour | 0.93120 |
| Potato Starch | 0.20660 |
| Tapioca Flour | 0.11460 |
| Xanthan Gum | 0.00700 |

### Pancakes:

1⅓ cup (2.08040 lb) Baking Mix
Egg substitute (1 egg equivalent): 0.04500 lb ground golden flax and 0.08870 lb water
¾ cup (0.37790 lb) water
1 TBSP (0.05470 lb) canola oil

### Instructions:

1. Using an electric hand mixer, mix all ingredients.
2. Spray griddle with non-stick cooking oil.
3. Pour ¼ cup batter onto a pre-heated, lightly oiled griddle at medium-low heat.
4. Flip and cook approximately 45 seconds.
5. Serve immediately with maple syrup or fruit preserves.
   Extra pancakes can be cooked, cooled, and then wrapped in plastic and frozen. To reheat, remove the wrapping and microwave pancakes wrapped in a paper towel until hot, approximately one minute.
   For variety add one or more of the following: 1 tsp. ground cinnamon, ½ tsp. ground ginger or nutmeg, ½ cup raisins or other dried fruit (chopped), ½ cup chopped nuts, ½ cup coconut, ½ cup grated fresh apple.
   Makes six-4 inch pancakes.
   High Altitude: No change.

### Waffles:

1⅓ cup (2.08040 lb) Baking Mix
Egg substitute (1 egg equivalent): 0.04500 lb ground golden flax and 0.08870 lb water
¾ cup (0.37790 lb) water
1 TBSP (0.05470 lb) canola oil

### Instructions:

1. Using an electric hand mixer, mix all ingredients.
2. Pour ½ cup batter onto a pre-heated, non-stick waffle maker.
3. Follow waffle maker timer instructions for best results.
4. Serve immediately with maple syrup or fruit preserves.
   Extra waffles can be cooked, cooled, and then wrapped in plastic and frozen. To reheat, remove the wrapping and microwave waffles wrapped in a paper towel until hot, approximately one minute.
   Makes six-4 inch waffles.
   High Altitude: No change.
   Crêpes:
   1⅓ cup (2.08040 lb) Baking Mix
   Egg substitute (1 egg equivalent): 0.04500 lb ground golden flax and 0.08870 lb water
   ¾ cup (0.37790 lb) water
   1 TBSP (0.05470 lb) canola oil
   ½ tsp (0.00925 lb) granulated sugar
   ½ tsp (0.01425 lb) vanilla extract

### Instructions:

1. Using an electric hand mixer, mix all ingredients
2. Heat 8-inch non-stick skillet.
3. Pour ¾ cup batter onto the skillet and move your wrist in a circular pattern to coat the pan with a thin even layer of batter.
4. Cook for about 1 minute or until the first side browns lightly.
5. Flip and cook 45 minutes to 1 minute longer.
6. Remove to a plate and repeat with remaining batter.
7. Fill with jam, honey, sugar, chocolate hazelnut spread, peanut butter, or bananas.
   Extra crêpes can be cooked, cooled, and then wrapped in plastic and frozen. To reheat, remove the wrapping, and microwave wrapped in a paper towel until hot, approximately one minute.
   Makes six to eight crêpes.
   High Altitude No change.

### Example 8

The following example describes a recipe for an allergen-free pizza crust and pizza.

Pizza Crust Mix

| Ingredient | Weight (lb.) |
|---|---|
| White Rice Flour | 0.63050 |
| Tapioca Flour | 0.25800 |
| Teff | 0.15570 |
| Arrowroot Starch | 0.11410 |
| Granulated Sugar | 0.08350 |
| Salt (table) | 0.02640 |
| Xanthan Gum | 0.02740 |
| Molasses Powder | 0.01500 |
| Vinegar Powder | 0.00900 |

### Materials Needed:

### 1 bag (1.46530 lb) Pizza Crust Mix

Egg substitute (3 egg equivalent): 0.13500 lb ground golden flax and 0.26610 lb water
4 TBSP (0.11055 lb) olive oil (plus oil for pans)
1½ cup (0.77330 lb) warm water
1 packet (0.01640 lb) active yeast
White rice flour (dusting)

### Instructions:

1. Preheat oven to 400° F.
2. With electric hand mixer, beat the water, oil, and egg substitute,
3. Add 1 cup mix and yeast and beat on medium speed for 30 seconds.
4. Add remaining mix and beat on medium-high speed for 2 minutes. The dough will be stiff and sticky.
5. In a 14″ pizza pan or two medium size pizza pans drizzle the bottom and sides with oil.
6. Dust roiling pin with white rice flour and roll out pizza on pizza pan.
7. Drizzle the top with oil and form edges to the outer shape of the pan.
8. Bake crust until the top is set and bottom begins to brown, 8-12 minutes depending on the thickness.
9. Remove from the oven, and top as desired.
10. Return to the oven and bake for an additional 6-10 minutes, until bottoms are browned and toppings are cooked.
   Makes one 14″ pizza or two size medium pizzas, 12 to 16 slices,
   High Altitude: No change.

### Example 9

The following example describes a recipe for an allergen-free pie crust.

Pie Crust Flour

| Ingredient | Weight (lb) |
|---|---|
| White Rice Flour | 0.61000 |
| Potato Starch | 0.32180 |
| Brown Rice | 0.12700 |
| Flour | |
| Xanthan Gum | 0.26000 |

Pie Crust Mix

| Ingredient | Weight (lb) |
|---|---|
| Pie Crust Hour | 1.31880 |
| Granulated Sugar | 0.22000 |
| Vinegar Powder | 0.01600 |
| Salt (table) | 0.01000 |

### Materials Needed:

### 1 bag (1.56480 lb) Pie Crust Mix

Egg substitute (2 egg equivalent): 0.09000 lb ground golden flax and 0.17740 lb water
1 cup (0.35640 lb) all soy-free shortening
1 cup (0.52280 lb) ice cold water
¾ cup (0.25960 lb) white rice flour (for rolling dough)

### Instructions:

1. Preheat oven to 400° F.
2. Cut the soy-free shortening until fine crumbs are formed,
3. Add egg substitute and water.
4. Gradually add mix and combine using fork until combined.
5. Form into a dough ball. Do not handle dough that much after liquid has been added and a ball is formed,
6. Cover with cling wrap and chill in refrigerator for 20 minutes.
7. Sprinkle wax paper with white rice flour and place chilled dough in center,
8. Roll out to appropriate size.
9. Lift wax paper and carefully invert over pie plate and peel away paper.
10. Prick the bottom and sides of crust with fork.
11. Place a cake pan (upside down) inside to keep dough from bubbling. Place in oven on lowest rack and bake 10 minutes by itself before adding filling.

12. Add filling.

13. Rollout additional dough for top crust. Put over filling and pinch edges,

14. Reduce oven temperature to 350° F. Bake 12-15 minutes until set and beginning to turn golden.

15. Cool 5 minutes, and invert to serve.

Makes one 9″ pie,
High Altitude: No change.
Time Saver Tip: Pie Crust can be made in advance, rolled out, and frozen in freezer safe pie pans. Simply cover with cling wrap and place in freezer. Thaw crust prior to baking.

### Example 10

The following example describes a recipe for allergen-free bread products.

White Bread Mix or Roll Mix

| Ingredient | Weight (lb) |
|---|---|
| Potato Starch | 0.45000 |
| Tapioca Flour | 0.40000 |
| White Rice Flour | 0.35000 |
| Cornstarch | 0.30000 |
| Granulated Sugar | 0.11420 |
| Teff | 0.06740 |
| Baking Powder | 0.05000 |
| Powdered Rice Milk | 0.04300 |
| Base | |
| Vinegar Powder | 0.04000 |
| Molasses Powder | 0.04000 |
| Salt (table) | 0.03055 |
| Xanthan Gum | 0.01300 |

### Materials Needed:

### 1 bag (1.25980 lb) Bread Mix

1 packet (0.01640 lb) yeast
1 cup, plus 1 TBSP (0.55885 lb) warm water
¼ cup (0.10430 lb) canola oil
Egg substitute (2 egg equivalent): 0.09000 lb ground golden flax and 0.17740 lb water

### Oven Baking:

1. Remove yeast packet and place in medium size mixing bowl. Add bread mix. Wisk yeast and bread mix thoroughly.
2. In a separate bowl, beat egg substitute, canola oil, and warm water using a hand mixer.
3. Gradually add bread mix/yeast and beat for 3 minutes on medium/high.
4. Using an 8″×4″ non-stick loaf pan, grease pan or spray with non-sticking cooking spray,
5. Pour batter into pan and spread evenly with spatula.
6. Place dough filled pan in warm oven. About 1 hour.
7. Remove pan from oven and increase oven temperature to 350° F.
8. Once temperature reaches 350° F., place dough filled pan back in oven.
9. Bake for 25-30 minutes or until baked through,
10. Check doneness by placing toothpick in the center of the cake. If the dough pulls through on the toothpick, add additional time until no dough remains on the toothpick.
11. Cool 5 minutes before removing from loaf pan.
12. Invert to remove from pan and place on wire rack.
13. Cool completely before slicing.

### Bread Maker:

1. Pour warm water, canola oil, and eggs replacer into a bread maker.
2. Add bread mix and yeast.
3. Set machine on white bread and medium setting. Do not use gluten-free setting.
4. Start machine and scrape down sides and corners of pan while the dough is mixing.
5. Oven temperatures can vary. During the last 30 minutes, check bread to insure it does not over bake. If the bread gets too dark, remove early from the bread machine.
6. After baking, remove from pan and let cool before slicing. Makes 1 loaf white bread.
   High Altitude Use 1 cup (0.52280 lb) water.

### Variations:

Cinnamon Bread: Use the Oven Baking recipe only. In a separate bowl, combine 2 tsp cinnamon and ½ cup sugar. Fold cinnamon mixture into dough approximately three times to create cinnamon swirls. Let the dough rest in a pan for one hour and bake as indicated above.
Croutons: Cut slices of allergen-free bread into small squares and bake on a cookie sheet for additional two hours in a 200° F. oven. Cut larger, thinner pieces to make to make toasts for appetizers.
Herb Bread: Add 2 tsp. Italian herbs and ½ tsp onion powder.
Three Seed Bread (peanut- and tree nut-free): add 2 TBSP sesame seeds, 2 TBSP sunflower seeds, and 1 TBSP poppy seeds.

### Example 11

The following example describes a recipe for an allergen-free pizza crust and pizza,

Pizza Crust Mix

| Ingredient | Weight (oz) |
|---|---|
| White Rice Flour | 11.032 |
| Powdered Rice Milk | 2.100 |
| Brown Rice Flour | 2.000 |
| Cane Sugar | 1.000 |
| Salt | 0.300 |
| Baking Powder | 0.200 |
| Molasses Powder | 0.200 |
| Powdered Sugar | 0.150 |
| Methylcellulose | 0.006 |
| Yeast Packet | 0.262 |

### Materials Needed:

3⅓ cups Pizza Crust Mix
3 TBSP olive oil
1⅓ cup warm water

### Instructions:

1. Preheat over to 400° F.
2. With electric hand mixer, beat the water and oil.
3. Add 1 cup mix and yeast and beat on medium speed for 30 seconds,
4. Add remaining mix and beat on medium-high speed for 2 minutes. The dough will be stiff and sticky.
5. In a 14″ pizza pan or two medium size pizza pans drizzle the bottom and sides with oil.
6. Dust rolling pin with white rice flour and roll out pizza on pizza pan.
7. Drizzle the top with oil and form edges to the outer shape of the pan.
8. Bake crust until the top is set and bottom begins to brown, 8-12 minutes depending on the thickness.
9. Remove from the oven, and top as desired.
10. Return to the oven and bake for an additional 6-10 minutes, until bottoms are browned and toppings are cooked.
   Makes one 14″ pizza or two size medium pizzas, 12 to 16 slices.
   High Altitude: No change.

### Example 12

The following example describes a recipe for allergen-free white cakes and cupcakes.

White Cake and Cupcakes Mix

| Ingredient | Weight (oz) | Parts |
|---|---|---|
| Granulated sugar | 9.80 | 9.800 |
| White rice flour | 7.55 | 7.550 |
| Aluminum free baking powder | 1.80 | 1.800 |
| Brown rice flour | 1.40 | 1.400 |
| Tapioca flour | 0.60 | 0.600 |
| Natural vanilla flavor | 0.30 | 0.300 |
| Xanthan gum | 0.20 | 0.200 |
| Sea salt | 0.15 | 0.150 |
| Cream of tartar | 0.12 | 0.120 |
| Dextrose, titanium dioxide | 0.08 | 0.080 |

or

| Ingredient | Weight (oz) | Parts |
|---|---|---|
| Granulated sugar | 9.80 | 9.800 |
| White rice flour | 7.45 | 7.450 |
| Aluminum free baking powder | 1.80 | 1.800 |
| Brown rice flour | 1.40 | 1.400 |
| Tapioca flour | 0.60 | 0.600 |
| Natural vanilla flavor | 0.30 | 0.300 |
| Xanthan gum | 0.20 | 0.200 |
| Sea salt | 0.15 | 0.150 |
| Cream of tartar | 0.12 | 0.120 |
| Cornstarch | 0.10 | 0.100 |
| Dextrose, titanium dioxide | 0.08 | 0.080 |

Natural vanilla flavor is optional.

### Materials Needed:

3¾ cups (3.750 parts) white cake mix
⅓ cup (0.333 parts) soy-free shortening
1¼ cups (1.250 parts) rice milk ¼ cups (0.250 parts) club soda.

### Instructions:

1. Preheat oven to 350° F.
2. Cut the soy-free shortening until fine crumbs are formed and place in a medium size bowl.
3. Gradually beat in flour mixture at a low speed for 1 minute, then high for 3 minutes, scraping the bowl frequently.
4. Using two 9″×9″ inch square/round pans or one 9″×13″ pan spray with non-sticking cooking spray.
5. Pour batter into pan and spread evenly with spatula. The batter may seem heavier to spread.
6. Bake for 25-30 minutes or until baked through.
7. Check doneness by placing toothpick in the center of the cake. If the dough pulls through on the toothpick, add additional time until no dough remains on the toothpick.
8. Cool 5 minutes before removing from cake pan.
9. Invert to remove from pan and place on wire rack.
10. Cool completely. Add frosting.
   Makes 1 layer cake or 12 servings.
   High Altitude: No change.

The following example describes a recipe for allergen-free chocolate cakes and cupcakes.

Chocolate Cake Mix

| Ingredient | Weight (oz) | Parts |
|---|---|---|
| Granulated Sugar | 9.80 | 9.800 |
| White rice flour | 7.90 | 7.900 |
| Aluminum free baking powder | 1.80 | 1.800 |
| Cocoa (processed with alkali) | 1.00 | 1.000 |
| Brown rice flour | 0.50 | 0.500 |
| Tapioca flour | 0.20 | 0.200 |
| Natural vanilla flavor | 0.30 | 0.300 |
| Xanthan gum | 0.20 | 0.200 |
| Cream of tartar | 0.15 | 0.150 |
| Sea salt | 0.15 | 0.150 |

Natural vanilla flavor is optional.

### Materials Needed:

3¾ cups (3.750 parts) chocolate cake mix
⅓ cup (0.500 parts) soy-free shortening
1⅓ cups (0.333 parts) rice milk
¼ cup (0.250 parts) club soda

### Instructions:

1. Preheat oven to 350° F.
2. Cut the soy-free shortening until fine crumbs are formed and place in a medium size bowl.
3. Gradually heat in flour mix at a low speed for 1 minute, then on high for 3 minutes, scraping the howl frequently.
4. Using two 9″×9″ inch square/round pans or one 9″×13″ pan spray with non-sticking cooking spray.
5. Pour batter into pan and spread evenly with spatula. Batter may seem heavier to spread.
6. Bake for 35-40 minutes or until baked through.
7. Check doneness by placing toothpick in the center of the cake. If dough pulls through on the toothpick, add additional time until no dough remains on the toothpick.
8. Cool 5 minutes before removing from cake pan.
9. Invert to remove from pan and place on wire rack,
10. Cool completely. Add frosting.
   Makes 1 layer cake or 12 servings.
   High Altitude (3500-6500 ft.): No change.

### Example 13

The following example describes a recipe for allergen-free muffins.

Muffin Mix

| Ingredient | Weight (oz) | Parts |
|---|---|---|
| White rice flour | 10.38 | 10.380 |
| Granulated sugar | 2.30 | 2.300 |
| Aluminum free baking | 1.70 | 1.700 |
| powder | | |
| Brown rice flour | 1.20 | 1.200 |
| Sodium bicarbonate | 0.18 | 0.180 |
| Xanthan gum | 0.18 | 0.180 |
| Natural vanilla flavor | 0.16 | 0.160 |
| Sea salt | 0.10 | 0.100 |

Natural vanilla flavor is optional.

### Materials Needed:

3¼ cups (3.250 parts) muffin mix
⅓ cup (0.333 parts) canola oil
1¼ cups (1.250 parts) rice milk
1¼ cups (1.250 parts) water
2 Tbls. (0.115 parts) club soda.

### Instructions:

1. Preheat oven to 350° F.
2. Beat oil.
3. Gradually add mix and beat.
4. Grease muffin pan or spray with non-stick cooking spray.
5. Using a standard muffin pan, fill in each muffin mold until full.
6. Bake for 10-12 minutes or until baked through.
7. Check doneness by placing toothpick in center of muffin. If the dough pulls through on the toothpick, add additional time until no dough remains on the toothpick.
8. Cool 5 minutes before removing from muffin pan,
9. Remove to wire racks to cool completely.
   Makes about 12 medium muffins.
   High Altitude No change.

### Variation:

Apple: add 2 cups shredded apple, and replace water with applesauce or apple juice.
Banana: add 2 cups ripe mashed bananas.
Blueberry: add 2 cups fresh or frozen blueberries.
Berry: add 1 cup each fresh or frozen raspberries and blackberries.
Carrot Raisin: add 2 cups shredded carrots and 1 cup raisons.
Chocolate Chip: add 2 cups dairy free, soy free chocolate chips or chunks.
Cinnamon Sugar: add ¼ cup sugar and ½ tsp cinnamon. For topping, mix ¼ cup sugar and ¾ tsp cinnamon in small bowl. Immediately dip the top of the muffin with ½ cup melted dairy free, soy free butter or margarine, then top with the sugar-cinnamon mixture.
Dried Cranberry Apple: add 2 cups shredded apple and ½ cup dried cranberries.
Poppy Seed: add ½ tsp poppy seeds per muffin.
Pumpkin Raisin: add 15 oz. can pumpkin, ½ tsp cinnamon, ¼ nutmeg, and 1 cup raisins.
Tropical: substitute 10.5 oz. coconut milk for water, add 2 cups dried diced tropical fruit, and add 1 cup shredded coconut.
Zucchini: add 2 cups shredded zucchini.

### Example 14

The following example describes a recipe for an allergen-free brownie.

Brownie Mix

| Ingredient | Weight (oz) | Parts |
|---|---|---|
| Chocolate chips or chunks | 1.85 | 1.850 |
| Granulated sugar | 6.50 | 6.500 |
| White rice flour | 4.32 | 4.320 |
| Brown sugar | 0.75 | 0.750 |
| Cocoa (processed with alkali) | 0.45 | 0.450 |
| Aluminum free baking powder | 0.18 | 0.180 |
| Tapioca flour | 0.15 | 0.150 |
| Xanthan gum | 0.15 | 0.150 |
| Brown rice flour | 0.10 | 0.100 |
| Sodium bicarbonate | 0.10 | 0.100 |
| Natural vanilla flavor | 0.10 | 0.100 |
| Sea salt | 0.10 | 0.100 |

Natural vanilla flavor is optional.

### Materials Needed:

2 cups (2.000 parts) Brownie Mix
¼ cup (0.250 parts) Canola oil
¾ cup (0.750 parts) rice milk

### Instructions:

Mix and bake at 350° F. for 25-30 minutes.

### Example 15

The following example describes a recipe for allergen-free cornbreads.

Cornbread and Muffin Mix

| Ingredient | Weight (oz) | Parts |
|---|---|---|
| Cornmeal | 5.15 | 5.150 |
| Granulated sugar | 4.10 | 4.100 |
| Tapioca flour | 1.45 | 1.450 |
| White rice flour | 1.15 | 1.150 |
| Cornstarch | 1.10 | 1.100 |
| Aluminum free baking | 0.90 | 0.900 |
| powder | | |
| Potato starch | 0.20 | 0.200 |
| Xanthan gum | 0.20 | 0.200 |
| Natural vanilla flavor | 0.15 | 0.150 |
| Sea salt | 0.10 | 0.100 |

Natural vanilla flavor is optional.

### Materials Needed:

2¾ cups (2.750 parts) Cornbread and Muffin Mix
½ cup (0.500 parts) melted dairy free, soy-free butter
¾ cup (0.275 parts) rice milk
2 Tbls. (0.115 parts) club soda.

### Instructions:

Mix and bake at 400° F. for 25-30 minutes.

### Example 16

The following example describes a recipe for allergen-free breads.

Bread Mix or Roll Mix

| Ingredient | Weight (oz) | Parts |
|---|---|---|
| Potato starch | 3.8000 | 3.8000 |
| White rice flour | 3.9400 | 3.9400 |
| Tapioca flour | 2.7500 | 2.7500 |
| Granulated sugar | 1.8500 | 1.8500 |
| Cornstarch | 1.5000 | 1.5000 |
| Aluminum free baking | 1.5000 | 1.5000 |
| powder | | |
| Brown rice flour | 1.0000 | 1.0000 |
| Powdered rice milk | 0.6500 | 0.6500 |
| Salt (table) | 0.6000 | 0.6000 |
| Potato flour | 0.2000 | 0.2000 |
| Molasses powder | 0.2000 | 0.2000 |
| Xanthan gum | 0.1500 | 0.1500 |
| Methylcellulose F4M | 0.1000 | 0.1000 |
| Yeast | 0.2624 | 0.2624 |

### Materials Needed:

4 cups (4.000 parts) Bread Mix
¼ cup (0.250 parts) canola oil
1¾ cup (0.750 parts) warm water

### Oven Baking:

1. Remove yeast packet and place in medium size mixing bowl. Add bread mix. Wisk yeast and bread mix thoroughly,
2, in a separate bowl, beat canola oil and warm water using a hand mixer.
3. Gradually add bread mix/yeast and beat for 3 minutes on medium/high.
4. Using an 8″×4″ non-stick loaf pan, grease pan or spray with non-sticking cooking spray.
5. Pour batter into pan and spread evenly with spatula.
6. Place dough filled pan in warm oven. About 1 hour,
7. Remove pan from oven and increase oven temperature to 350° F.
8. Once temperature reaches 350° F., place dough filled pan back in oven.
9. Bake for 25-30 minutes or until baked through.
10. Check doneness by placing toothpick in the center of the cake. If the dough pulls through on the toothpick, add additional time until no dough remains on the toothpick.
11. Cool 5 minutes before removing from loaf pan.
12. Invert to remove from pan and place on wire rack.
13. Cool completely before slicing.

### Bread Maker:

1. Pour warm water and canola oil into a bread maker.
2. Add bread mix and yeast.
3. Set machine on white bread and medium setting. Do not use gluten-free setting.
4. Start machine and scrape down sides and corners of pan while the dough is mixing.
5. Oven temperatures can vary. During the last 30 minutes, check bread to insure it does not over bake. If the bread gets too dark, remove early from the bread machine,
6. After baking, remove from pan and let cool before slicing.
   Makes 1 loaf white bread,
   High Altitude: Use 1 cup (0.52280 lb) water,

### Variations:

Cinnamon Bread: Use the Oven Baking recipe only. In a separate bowl, combine 2 tsp cinnamon and LA cup sugar. Fold cinnamon mixture into dough approximately three times to create cinnamon swirls. Let the dough rest in a pan for one hour and bake as indicated above.
Croutons: Cut slices of allergen-free bread into small squares and bake on a cookie sheet for additional two hours in a 200° F. oven. Cut larger, thinner pieces to make to make toasts for appetizers.
Herb Bread Add 2 tsp. Italian herbs and ½ tsp onion powder.
Three Seed Bread (peanut- and tree nut-free): add 2 TBSP sesame seeds, 2 TBSP sunflower seeds, and 1 TBSP poppy seeds.

### Example 17

The following example describes a recipe for an allergen-free pizza crust and pizza.

Pizza Crust Max

| Ingredient | Weight (oz) | Parts |
|---|---|---|
| White rice flour | 12.960 | 12.960 |
| Aluminum free baking | 1.600 | 1.600 |
| powder | | |
| Brown rice flour | 1.000 | 1.000 |
| Granulated sugar | 0.600 | 0.600 |
| Tapioca flour | 0.600 | 0.600 |
| Sea salt | 0.300 | 0.300 |
| Powdered rice milk | 0.400 | 0.400 |
| Molasses powder | 0.250 | 0.250 |
| Xanthan gum | 0.220 | 0.220 |
| Vinegar | 0.060 | 0.060 |
| Yeast | 0.262 | 0.262 |

### Materials Needed:

4 cups (4.000 parts) Pizza Crust Mix
¼ cup+1 TBSP (0.313 parts) olive oil
¼ cup (0.250 parts) rice milk
1¾ cups (1.750 parts) warm water

### Instructions:

1. Form pizza dough into ball.
2. Using rolling pin, roll dough onto pizza crust pan rotating until the even rolled to the edges.
3. Brush olive oil over pizza dough before baking.
4. Bake at 300° F. for 15-20 minutes,
5. Remove from oven. Increase baking temperature to 350° F. Add toppings and bake for 8-10 minutes, depending on the thickness.
   Makes two medium size or one large pizza.
   High Altitude No change.

### Example 18

The following example describes a recipe for allergen-free chocolate chip cookies, oatmeal raisin cookies, and sugar cookies.

Chocolate Chip Cookie Mix

| Ingredient | Weight (oz.) | Parts |
|---|---|---|
| Chocolate chips or chunks | 3.56 | 3.560 |
| (evaporated cane sugar, | | |
| chocolate liquor, non-dairy | | |
| cocoa butter) | | |
| Granulated sugar | 3.20 | 3.200 |
| Brown sugar | 2.30 | 2.300 |
| Tapioca flour | 1.89 | 1.890 |
| Potato flour | 1.38 | 1.380 |
| White rice flour | 0.92 | 0.920 |
| Aluminum free baking | 0.40 | 0.400 |
| powder | | |
| Brown rice flour | 0.16 | 0.160 |
| Potato starch | 0.14 | 0.140 |
| Xanthan gum | 0.15 | 0.150 |
| Natural vanilla flavor | 0.15 | 0.150 |

Natural vanilla flavor is optional.

### Materials Needed:

2 cups (2.000 parts) chocolate chip cookie mix
½ cup (0.500 parts) chocolate chip
½ cup (0.500 parts) dairy free, soy-free butter (room temperature)
¼ cup (0.250 parts) water

### Instructions:

1. Preheat oven to 350° F.
2. Spray cookie sheet with non-stick cooking spray.
3. In medium size bowl, mix dry and wet ingredients together using fork until cookie dough is formed.
4. Using the palm of the hands roll cookie dough for each and flatten on cookie sheet. Since these are cookies are free of gluten and eggs, they do not naturally spread when baked.
5. Bake at 350° F.
   High Altitude: No change.

Oatmeal Raisin Cookie Mix

| Ingredient | Weight (oz.) | Parts |
|---|---|---|
| Tapioca flour | 3.20 | 3.200 |
| Oats | 2.90 | 2.900 |
| Potato flour | 2.34 | 2.340 |
| Raisins | 2.60 | 2.600 |
| Brown sugar | 2.30 | 2.300 |
| Granulated sugar | 1.75 | 1.750 |
| White rice flour | 1.56 | 1.560 |
| Aluminum free baking | 0.40 | 0.400 |
| powder | | |
| Brown rice flour | 0.10 | 0.100 |
| Potato starch | 0.25 | 0.250 |
| Xanthan gum | 0.15 | 0.150 |
| Natural vanilla flavor | 0.15 | 0.150 |
| Molasses powder | 0.10 | 0.100 |
| Sodium bicarbonate | 0.10 | 0.100 |
| Sea Salt | 0.10 | 0.100 |
| Ground cinnamon | 0.05 | 0.050 |

Natural vanilla flavor is optional.

### Materials Needed:

3 cups (3.000 parts) Oatmeal Raisin Cookie Mix
½ cup (0.500 parts) dairy free, soy-free butter (room temperature)
¼ cup (0.250 parts) water
¼ cup (0.250 parts) lemon-lime soda

### Instructions:

1. Preheat oven to 350° F.
2. Spray cookie sheet with non-stick cooking spray.
3. In medium size how', mix dry and wet ingredients together using fork until cookie dough is formed.
4. Using the palm of the hands roll cookie dough for each and flatten on cookie sheet. Since these are cookies are free of gluten and eggs, they do not naturally spread when baked.
5. Baked at 350° F.
   High Altitude: No change.

Sugar Cookie Mix

| Ingredient | Weight (oz.) | Parts |
|---|---|---|
| Granulated sugar | 7.0000 | 7.0000 |
| Tapioca flour | 3.6600 | 3.6600 |
| Potato flour | 2.5000 | 2.5000 |
| White rice flour | 1.6000 | 1.6000 |
| Aluminum free baking | 0.4000 | 0.4000 |
| powder | | |
| Brown rice flour | 0.3000 | 0.3000 |
| Potato starch | 0.2500 | 0.2500 |
| Natural vanilla flavor | 0.1500 | 0.1500 |
| Sodium bicarbonate | 0.1000 | 0.1000 |
| Xanthan gum | 0.1500 | 0.1500 |
| Dextrose, titanium dioxide | 0.0400 | 0.0400 |
| Sea salt | 0.1000 | 0.1000 |

Natural vanilla flavor is optional.

### Materials Needed:

2¾ cups (2.750 parts) Sugar Cookie Mix
½ cup (0.500 parts) dairy free, soy-free butter (room temperature)
½ cup (0.500 parts) water

### Instructions:

1. Preheat oven to 350° F.
2. Spray cookie sheet with non-stick cooking spray.
3. In medium size bowl, mix dry and wet ingredients together using fork until cookie dough is formed.
4. Using the palm of the hands roll cookie dough for each and flatten on cookie sheet. Since these are cookies are free of gluten and eggs, they do not naturally spread when baked.
5. Baked at 350° F.
   High Altitude: No change.
   The following components can be mixed to make cookie cutter cookies:
   2¾ cups (2.750 parts) Sugar Cookie Mix
   ½ cup (0.500 parts) butter flavored shortening
   ½ cup (0.500 parts) water

### Example 19

The following example describes a recipe for allergen-free pancakes, waffles, crêpes.

Pancake/Waffle/Crepe Mix

| Ingredient | Weight (lb.) | Parts |
|---|---|---|
| White rice flour | 10.90 | 10.900 |
| Granulated sugar | 0.90 | 0.900 |
| Powdered rice milk | 1.45 | 1.450 |
| Aluminum free baking | 0.75 | 0.750 |
| powder | | |
| Brown rice flour | 0.60 | 0.600 |
| Salt | 0.30 | 0.300 |
| Sodium bicarbonate | 0.25 | 0.250 |
| Xanthan gum | 0.10 | 0100 |

### Pancakes:

1 cup (1.000 parts) Pancake/Waffle/Crêpe Mix
1 this (0.063 parts) canola oil
¾ cup (0.750 parts) rice milk
2 tbls (0.125 parts) water

### Instructions:

1. Using an electric hand mixer, mix all ingredients.
2. Spray griddle with non-stick cooking oil.
3. Pour ¼ cup batter onto a pre-heated, lightly oiled griddle at medium heat.
4. Flip and cook approximately 45 seconds.
5. Serve immediately with maple syrup or fruit preserves.
   Extra pancakes can be cooked, cooled, and then wrapped in plastic and frozen. To reheat, remove the wrapping and microwave pancakes wrapped in a paper towel until hot, approximately one minute.
   For variety add one or more of the following: 1 tsp. ground cinnamon, ½ tsp. ground ginger or nutmeg, ½ cup raisins or other dried fruit (chopped), ½ cup chopped nuts, ½ cup coconut, ½ cup grated fresh apple.
   Makes four 4 inch pancakes.

### Waffles:

1¼ cups (1.250 parts) Pancake/Waffle/Crêpe Mix
1 this (0.063 parts) canola oil
1 cup (1.000 parts) rice milk

### Instructions:

1. Using an electric hand mixer, mix all ingredients.
2. Pour ½ cup batter onto a pre-heated, non-stick waffle maker.
3. Follow waffle maker timer instructions for best results.
4. Serve immediately with maple syrup or fruit preserves.
   Extra waffles can be cooked, cooled, and then wrapped in plastic and frozen. To reheat, remove the wrapping and microwave waffles wrapped in a paper towel until hot, approximately one minute.
   Makes four 4 inch waffles.
   Crêpes:
   1 cup (1.000 parts) Pancake/Waffle/Crêpe Mix
   1 This (0.063 parts) canola oil
   1 cup (1.000 parts) rice milk
   ¼ tsp (0.005 parts) vanilla extract
   ½ Tbls (0.031 parts) granulated sugar

### Instructions:

1. Using an electric hand mixer, mix all ingredients.

2. Heat 8-inch non-stick skillet.

3. Pour ¾ cup hatter onto the skillet and move your wrist in a circular pattern to coat the pan with a thin even layer of hatter.

4. Cook for about 1 minute or until the first side browns lightly.

5. Flip and cook 45 minutes to 1 minute longer.

6. Remove to a plate and repeat with remaining hatter.

7. Fill with jam, honey, sugar, chocolate hazelnut spread, peanut butter, or bananas.

Extra crêpes can be cooked, cooled, and then wrapped in plastic and frozen. To reheat, remove the wrapping, and microwave wrapped in a paper towel until hot, approximately one minute.
Makes four 5 inch crepes.

### Example 20

The following example describes recipes for an allergen-free vanilla frosting and a chocolate frosting.

Vanilla Frosting Mix

| Ingredient | Weight (oz) | Parts |
|---|---|---|
| Powdered sugar | 13.61 | 13.610 |
| Powdered rice milk | 0.30 | 0.300 |
| Natural vanilla flavor | 0.10 | 0.100 |
| Sea salt | 0.10 | 0.100 |
| Dextrose, titanium dioxide | 0.04 | 0.040 |

### Materials Needed:

4¼ cups (4.250 parts) vanilla frosting mix
½ cup (0.500 parts) soy-free shortening
¼ cup (0.250 parts) rice milk
1 tbls. (0.063 parts) water

### Instructions:

1. Using an electric mixer and medium size bowl, combine and beat ingredients,
2. Beat on medium-high speed until thoroughly blended.
3. Spread frosting evenly using icing spreader over cakes and other baked items.
4. For creamier frosting on cupcakes add additional water, 1 tablespoon at a time, until desired texture is reached.
   Caution: Too much water can cause frosting to slide downward,
   2 cups frosting would be sufficient for 1 cake or 12 cupcakes. Regular soy-free shortening can be replaced with butter flavored soy-free shortening to make buttercream frosting.

Chocolate Frosting Mix

| Ingredient | Weight (oz) | Parts |
|---|---|---|
| Powdered sugar | 12.05 | 12.050 |
| Cocoa powder (processed with | 1.15 | 1.150 |
| alkali) | | |
| Aluminum free baking powder | 0.40 | 0.400 |
| Powdered rice milk | 0.30 | 0.300 |
| Natural vanilla flavor | 0.10 | 0.100 |
| Sea salt | 0.10 | 0.100 |

Natural vanilla flavor is optional.

### Materials Needed:

2¼ cups (2.250 parts) vanilla frosting mix
½ cup (0.500 parts) soy-free shortening
¼ cup (0.250 parts) rice milk
2 tbls. (0.125 parts) water

### Instructions:

1. Using an electric mixer and medium size bowl, combine and beat ingredients.
2. Beat on medium-high speed until thoroughly blended.
3. Spread frosting evenly using icing spreader over cakes and other baked items.
4. For creamier frosting on cupcakes add additional water, 1 tablespoon at a time, until desired texture is reached.
   Caution: Too much water can cause frosting to slide downward. 2 cups frosting would be sufficient for 1 cake or 12 cupcakes.

### Example 21

The following example describes a recipe for an allergen-free sauce and gravy.

Sauce & Gravy Mix

| Ingredient | Weight (oz) | Parts |
|---|---|---|
| Sweet rice flour | 4.89 | 4.890 |
| Cornstarch | 1.88 | 1.880 |
| Tapioca flour | 0.10 | 0.100 |
| Sea salt | 0.20 | 0.200 |
| White pepper | 0.03 | 0.030 |

### Materials Needed for Bask White Sauce:

2 tbls. (0.125 parts) Sauce & Gravy Mix
2 tbls. (0.125 parts) Canola oil
¾ cup (0.750 parts) rice milk
1¼ cups (1.250 parts) Vegetable broth

### Materials Needed for Butter Cream Sauce:

2 tbls. (0.125 parts) Sauce & Gravy Mix
2 tbls. (0.125 parts) Dairy free, soy-free butter
½ cup (0.500 parts) rice milk
1¼ cups (1.250 parts) Vegetable broth

### Materials Needed for Gravy:

2 tbls. (0.125 parts) Sauce & Gravy Mix
1 cup (1.000 parts) meat broth
2 tbls. (0.125 parts) water and/or oil

### Instructions:

1. In a 1-quart saucepan, stir together all ingredients.
2. Heat to boiling over medium heat, stirring constantly, for 1-2 minutes.

### Example 22

The following example describes a recipe for an allergen-free pie crust.

Pie Crust Mix

| Ingredient | Weight (oz) | Parts |
|---|---|---|
| White rice flour | 9.43 | 9.430 |
| Granulated sugar | 3.00 | 3.000 |
| Aluminum free baking | 1.80 | 1.800 |
| powder | | |
| Brown rice flour | 0.70 | 0.700 |
| Potato starch | 0.70 | 0.700 |
| Xanthan gum | 0.35 | 0.350 |
| Vinegar powder | 0.15 | 0.150 |
| Sea salt | 0.12 | 0.120 |

### Materials Needed:

3 cups (3.000 parts) Pie Crust Mix
1 cup (1.000 parts) soy-free shortening
1 cup (1.000 parts) ice cold water

### Instructions:

1. Preheat oven to 400° F.
2. Cut the soy-free shortening until fine crumbs are formed.
3. Add water,
4. Gradually add mix and combine using fork until combined.
5. Form into a dough ball. Do not handle dough that much after liquid has been added and a ball is formed.
6. Cover with cling wrap and chill in refrigerator for 20 minutes.
7. Sprinkle wax paper with white rice flour and place chilled dough in center.
8. Roll out to appropriate size.
9. Lift wax paper and carefully invert over pie plate and peel away paper.
10. Prick the bottom and sides of crust with fork.
11. Place a cake pan (upside down) inside to keep dough from bubbling. Place in oven on lowest rack and bake 10 minutes by itself before adding filling,
12. Add filling,
13. Rollout additional dough for top crust. Put over filling and pinch edges.
14. Reduce oven temperature to 350° F. Bake 12-15 minutes until set and beginning to turn golden.
15. Cool 5 minutes, and invert to serve.

### Makes one 9″ pie.

Time Saver Tip: Pie Crust can be made in advance, rolled out, and frozen in freezer safe pie pans. Simply cover with cling wrap and place in freezer. Thaw crust prior to baking.

### Example 23

The following example describes recipes for allergen-free white cakes and chocolate cakes.

White Cake Mix

| Ingredient | Weight (oz) | Parts |
|---|---|---|
| Granulated sugar | 9.80 | 9.800 |
| White rice flour | 7.70 | 7.700 |
| Aluminum free baking powder | 1.80 | 1.800 |
| Brown rice flour | 1.40 | 1.400 |
| Tapioca flour | 0.50 | 0.500 |
| Natural vanilla flavor | 0.30 | 0.300 |
| Xanthan gum | 0.20 | 0.200 |
| Sea salt | 0.15 | 0.150 |
| Cream of tartar | 0.12 | 0.120 |
| Dextrose, titanium dioxide | 0.08 | 0.080 |

### Materials Needed:

3¾ cups (3.750 parts) white cake mix
⅓ cup (0.333 parts) soy-free shortening
1¼ cup (1.250 parts) rice milk
1½ cups (1.500 parts) club soda

### Instructions:

1. Preheat oven to 350° F.
2. Cut the soy-free shortening until fine crumbs are formed and place in a medium size bowl.
3. Gradually beat in flour mixture at a low speed for 1 minute, then high for 3 minutes, scraping the bowl frequently.
4. Using two 9″×9″ inch square/round pans or one 9″×13″ pan spray with non-sticking cooking spray.
5. Pour batter into pan and spread evenly with spatula. The batter may seem heavier to spread.
6. Bake for 20-25 minutes or until baked through.
7. Check doneness by placing toothpick in the center of the cake. If the dough pulls through on the toothpick, add additional time until no dough remains on the toothpick.
8. Cool 5 minutes before removing from cake pan,
9. Invert to remove from pan and place on wire rack.
10. Cool completely. Add frosting.
   Makes 1 layer cake. 12 servings.
   High Altitude: No change.

Chocolate Cake Mix

| Ingredient | Weight (oz) | Parts |
|---|---|---|
| Granulated Sugar | 9.80 | 9.800 |
| White rice flour | 7.90 | 7.900 |
| Aluminum free baking powder | 1.80 | 1.800 |
| Cocoa (processed with alkali) | 1.00 | 1.000 |
| Brown rice flour | 1.00 | 1.000 |
| Potato starch | 0.20 | 0.200 |
| Natural vanilla flavor | 0.30 | 0.300 |
| Xanthan gum | 0.20 | 0.200 |
| Cream of tartar | 0.10 | 0.100 |
| Sea salt | 0.15 | 0.150 |

Natural vanilla flavor is optional.

### Materials Needed:

3¾ cups (3.750 parts) chocolate cake mix
⅓ cup (0.333 parts) soy-free shortening
1⅓ cups (1.333 parts) rice milk
¼ cup (0.250 parts) club soda

### Instructions:

1. Preheat oven to 350° F.
2. Cut the soy-free shortening until fine crumbs are formed and place in a medium size bowl.
3. Gradually beat in flour mix at a low speed for 1 minute, then on high for 3 minutes, scraping the bowl frequently.
4. Using two 9″×9″ inch square/round pans or one 9″×13″ pan spray with non-sticking cooking spray.
5. Pour batter into pan and spread evenly with spatula. Batter may seem heavier to spread.
6. Bake for 20-25 minutes or until baked through.
7. Check doneness by placing toothpick in the center of the cake. If dough pulls through on the toothpick, add additional time until no dough remains on the toothpick.
8. Cool 5 minutes before removing from cake pan.
9. Invert to remove from pan and place on wire rack.
10. Cool completely. Add frosting.
   Makes 1 layer cake. 12 servings.
   High Altitude (3500-6500 ft.): No change.

### Example 24

The following example describes a recipe for allergen-free chocolate chip cookies, oatmeal raisin cookies, and sugar cookies.

Chocolate Chip Cookie Mix

| Ingredient | Weight (oz.) | Parts |
|---|---|---|
| Chocolate chips or chunks (evaporated cane | 3.56 | 3.560 |
| sugar, chocolate liquor, non-dairy cocoa butter) | | |
| Granulated sugar | 3.20 | 3.200 |
| Brown sugar | 2.40 | 2.400 |
| Tapioca flour | 0.20 | 0.200 |
| Potato flour | 0.60 | 0.600 |
| White rice flour | 4.38 | 4.380 |
| Aluminum free baking powder | 0.40 | 0.400 |
| Brown rice flour | 0.15 | 0.150 |
| Potato starch | 0.15 | 0.5 |
| Xanthan gum | 0.15 | 0.150 |
| Natural vanilla flavor | 0.15 | 0.150 |
| Sea salt | 0.10 | 0.10 |
| Sodium bicarbonate | 0.06 | 3.560 |

Natural vanilla flavor is optional.

### Materials Needed:

2 cups (2.000 parts) chocolate chip cookie mix
½ cup (0.500 parts) chocolate chips
½ cup (0.500 parts) dairy free, soy-free butter (room temperature)
¼ cup (0.250 parts) water

### Instructions:

1. Preheat oven to 350° F.
2. Spray cookie sheet with non-stick cooking spray.
3. In medium size bowl, mix dry and wet ingredients together using fork until cookie dough is formed.
4. Using the palm of the hands roll cookie dough for each and flatten on cookie sheet. Since these are cookies are free of gluten and eggs, they do not naturally spread when baked.
5. Bake at 350° F.
   High Altitude: No change,

Sugar Cookie Mix

| Ingredient | Weight (oz.) | Parts |
|---|---|---|
| Granulated sugar | 7.0000 | 7.0000 |
| Tapioca flour | 0.2000 | 0.2000 |
| Potato flour | 0.600 | 0.6000 |
| White rice flour | 1.6000 | 6.0000 |
| Aluminum free baking powder | 0.4000 | 0.4000 |
| Brown rice flour | 0.3000 | 0.3000 |
| Potato starch | 0.1500 | 0.1500 |
| Natural vanilla flavor | 0.1500 | 0.1500 |
| Sodium bicarbonate | 0.1000 | 0.1000 |
| Xanthan gum | 0.1500 | 0.1500 |
| Dextrose, titanium dioxide | 0.0300 | 0.0300 |
| Sea salt | 0.1000 | 0.1000 |
| Brown sugar | 0.3200 | 0.3200 |

Natural vanilla flavor is optional.

### Materials Needed:

2⅓ cups (2.750 parts) Sugar Cookie Mix
½ cup (0.500 parts) dairy free, soy-free butter (room temperature)
½ cup (0.500 parts) water

### Instructions:

1. Preheat oven to 350° F.
2. Spray cookie sheet with non-stick cooking spray.
3. In medium size bowl, mix dry and wet ingredients together using fork until cookie dough is formed.
4. Using the palm of the hands roll cookie dough for each and flatten on cookie sheet. Since these are cookies are free of gluten and eggs, they do not naturally spread when baked.
5. Baked at 350° F.
   High Altitude: No change.
   The following components can be mixed to make cookie cutter cookies:
   2¾ cups (2.750 parts) Sugar Cookie Mix
   ½ cup (0.500 parts) butter flavored soy-free shortening
   ½ cup (0.500 parts) water

Oatmeal Raisin Cookie Mix

| Ingredient | Weight (oz) | Parts |
|---|---|---|
| Tapioca flour | 3.20 | 3.200 |
| Oats | 0.50 | 0.50 |
| Potato flour | 0.10 | 0.100 |
| Raisins | 2.60 | 2.600 |
| Brown sugar | 2.60 | 2.600 |
| Granulated sugar | 2.25 | 2.250 |
| White rice flour | 5.05 | 5.05 |
| Aluminum free baking powder | 0.40 | 0.400 |
| Brown rice flour | 0.10 | 0.100 |
| Potato starch | 0.15 | 0.150 |
| Xanthan gum | 0.15 | 0.150 |
| Natural vanilla flavor | 0.15 | 0.150 |
| Molasses powder | 0.12 | 0.120 |
| Sodium bicarbonate | 0.06 | 0.060 |
| Sea Salt | 0.10 | 0.100 |
| Ground cinnamon | 0.07 | 0.070 |

Natural vanilla flavor is optional,

### Materials Needed:

2½ cups (2.500 parts) Oatmeal Raisin Cookie Mix
½ cup (0.500 parts) dairy free, soy-free butter (room temperature)
¼ cup (0.250 parts) water
¼ cup (0.250 parts) “lemon-lime” soda

### Instructions:

1. Preheat oven to 350° F.
2. Spray cookie sheet with non-stick cooking spray.
3. in medium size howl, mix dry and wet ingredients together using fork until cookie dough is formed.
4. Using the palm of the hands roll cookie dough for each and flatten on cookie sheet. Since these are cookies are free of gluten and eggs, they do not naturally spread when baked.
5. Baked at 350° F.
   High Altitude: No change.

### Example 25

The following example describes a recipe for an allergen-free pizza crust and pizza.

Pizza Crust Mix

| Ingredient | Weight (oz) | Parts |
|---|---|---|
| White rice flour | 12.960 | 12.960 |
| Aluminum free baking powder | 1.600 | 1.600 |
| Brown rice flour | 1.000 | 1.000 |
| Granulated sugar | 0.600 | 0.600 |
| Tapioca flour | 0.600 | 0.600 |
| Sea salt | 0.300 | 0.300 |
| Powdered rice milk | 0.400 | 0.400 |
| Molasses powder | 0.250 | 0.250 |
| Xanthan gum | 0.250 | 0.250 |
| Vinegar | 0.060 | 0.060 |
| Yeast | 0.344 | 0.344 |

### Materials Needed:

4 cups (4.000 parts) Pizza Crust Mix
⅓ cup (0.333 parts) olive oil
¼ cup (0.250 parts) rice milk
1¾ cups (1.750 parts) warm water

### Instructions:

1. Form pizza dough into ball.
2. Using rolling pin, roll dough onto pizza crust pan rotating until the even rolled to the edges.
3. Brush olive oil over pizza dough before baking.
4. Bake at 300° F. for 15-20 minutes.
5. Remove from oven. Increase baking temperature to 350° F. Add toppings and bake for 8-10 minutes, depending on the thickness.
   Makes two medium size or one large pizza.
   High Altitude: No change.

### Example 26

The following example describes a recipe for allergen-free breads.

Bread Mix or Roll Max

| Ingredient | Weight (oz) | Parts |
|---|---|---|
| Potato starch | 4.1800 | 4.1800 |
| White rice flour | 3.9600 | 3.9600 |
| Tapioca flour | 2.7500 | 2.7500 |
| Granulated sugar | 1.8500 | 1.8500 |
| Cornstarch | 1.5000 | 1.5000 |
| Aluminum free baking powder | 1.5000 | 1.5000 |
| Brown rice flour | 1.0000 | 1.0000 |
| Powdered rice milk | 0.6500 | 0.6500 |
| Salt | 0.6000 | 0.6000 |
| Potato flour | 0.1800 | 0.1800 |
| Molasses powder | 0.1300 | 0.1300 |
| Xanthan gum | 0.1800 | 0.1800 |
| Methylcellulose F4M | 0.1000 | 0.1000 |
| Yeast | 0.2624 | 0.2624 |
| Teff Grain | 0.180 | 0.180 |

### Materials Needed:

4 cups (4.000 parts) Bread Mix
¼ cup (0.250 parts) canola oil
1¾ cup (0.750 parts) warm water

### Oven Baking:

1. Remove yeast packet and place in medium size mixing bowl. Add bread mix. Wisk yeast and bread mix thoroughly.
2. In a separate bowl, beat canola oil and warm water using a hand mixer.
3. Gradually add bread mix/yeast and beat for 3 minutes on medium/high.
4. Using an 8″×4″ non-stick loaf pan, grease pan or spray with non-sticking cooking spray.
5. Pour batter into pan and spread evenly with spatula,
6. Place dough filled pan in warm oven (at about 170° F.). About 1 hour.
7. Remove pan from oven and increase oven temperature to 300° F.
8. Once temperature reaches 300° F., place dough filled pan back in oven.
9. Bake for 25-30 minutes or until baked through.
10. Check doneness by placing toothpick in the center of the cake. If the dough pulls through on the toothpick, add additional time until no dough remains on the toothpick.
11. Cool 5 minutes before removing from loaf pan.
12. Invert to remove from pan and place on wire rack.
13. Cool completely before slicing.

### Bread Maker:

1. Pour warm water and canola oil into a bread maker.
2. Add bread mix and yeast,
3. Set machine on white bread and medium setting. Do not use gluten-free setting.
4. Start machine and scrape down sides and corners of pan while the dough is mixing.
5. Oven temperatures can vary. During the last 30 minutes, check bread to insure it does not over bake. If the bread gets too dark, remove early from the bread machine.
6. After baking, remove from pan and let cool before slicing.
   Makes 1 loaf white bread.
   High Altitude Use 1 cup (0.52280 lb) water.

### Example 27

The following example describes recipes for an allergen-free vanilla and chocolate frosting.

Vanilla Frosting Mix

| Ingredient | Weight (oz) | Parts |
|---|---|---|
| Powdered sugar | 13.61 | 13.610 |
| Powdered rice milk | 0.30 | 0.300 |
| Natural vanilla flavor | 0.10 | 0.100 |
| Dextrose, titanium dioxide | 0.04 | 0.040 |

### Materials Needed:

4¼ cups (4.250 parts) vanilla frosting mix
½ cup (0.500 parts) soy-free shortening
¼ cup (0.250 parts) rice milk
2 tbls. (0.126 parts) water

### Instructions:

1. Using an electric mixer and medium size bowl, combine and beat ingredients.
2. Beat on medium-high speed until thoroughly blended.
3. Spread frosting evenly using icing spreader over cakes and other baked items,
4. For creamier frosting on cupcakes add additional water, 1 tablespoon at a time, until desired texture is reached.
   Caution: Too much water can cause frosting to slide downward.
   2 cups frosting would be sufficient for 1 cake or 12 cupcakes. Regular soy-free shortening can be replaced with butter flavored soy-free shortening to make buttercream frosting.

Chocolate Frosting Mix

| Ingredient | Weight (oz) | Parts |
|---|---|---|
| Powdered sugar | 12.45 | 12.450 |
| Cocoa powder (processed with alkali) | 1.15 | 1.150 |
| Powdered rice milk | 0.30 | 0.300 |
| Natural vanilla flavor | 0.10 | 0.100 |
| Sea salt | 0.10 | 0.100 |

Natural vanilla flavor is optional.

### Materials Needed:

2¼ cups (2.250 parts) vanilla frosting mix
¼ cup (0.250 parts) soy-free shortening
¼ cup (0.250 parts) rice milk
2 tbls. (0.125 parts) water

### Instructions:

1. Using an electric mixer and medium size bowl, combine and beat ingredients.
2. Beat on medium-high speed until thoroughly blended.
3. Spread frosting evenly using icing spreader over cakes and other baked items.
4. For creamier frosting on cupcakes add additional water, 1 tablespoon at a time, until desired texture is reached.
   Caution: Too much water can cause frosting to slide downward. 2 cups frosting would be sufficient for 1 cake or 12 cupcakes.

### Example 28

The following example describes a recipe for an allergen-free sauce and gravy.

Sauce & Gravy Mix

| Ingredient | Weight (oz) | Parts |
|---|---|---|
| Sweet rice flour | 9.40 | 9.400 |
| Cornstarch | 3.76 | 3.7600 |
| Waxy rice flour | 0.40 | 0.400 |
| Sea salt | 0.40 | 0.400 |
| Tapioca flour | 0.20 | 0.200 |
| White pepper | 0.06 | 0.060 |

### Materials Needed for Basic White Sauce:

2 tbls. (0.125 parts) Sauce & Gravy Mix
2 tbls. (0.125 parts) Canola oil
¾ cup (0.750 parts) rice milk
1¼ cups (1.250 parts) Vegetable broth

### Materials Needed for Butter Cream Sauce:

2 tbls. (0.125 parts) Sauce & Gravy Mix
2 tbls. (0.125 parts) Dairy free, soy-free butter
½ cup (0.500 parts) rice milk
¼ cups (1.250 parts) Vegetable broth

### Materials Needed for Gravy:

2 tbls. (0.125 parts) Sauce & Gravy Mix
1 cup (1.000 parts) meat broth
2 tbls. (0.125 parts) water and/or oil

### Instructions:

1. In a 1-quart saucepan, stir together all ingredients.
2. Heat to boiling over medium heat, stirring constantly, for 1-2 minutes.

It will be apparent to those skilled in the art that various modifications and variation can be made to the compositions and methods of using same without departing from the spirit or scope of the intended use.

What is claimed:

1. A bread mix comprising the following ingredients:
1. A bread mix comprising the following ingredients:

| | | |
|---|---|---|
| (1) | white rice flour and/or brown rice flour | 4.96 parts ± 15%; |
| (2) | tapioca flour, tapioca starch, | 9.93 parts ± 15%; |
| | potato starch, cornstarch, | |
| | arrowroot powder and/or baking powder | |
| (3) | sugar | 1.85 parts ± 40%; |
| (4) | powdered rice milk | 0.65 parts ± 40%; |
| (5) | salt | 0.60 parts ± 65%; |
| (6) | potato flour | 0.18 parts ± 50%; |
| (7) | gum | 0.18 parts ± 65%; |
| (8) | methylcellulose | 0.10 parts ± 75%; and |
| (9) | yeast | 0.34 parts ± 60%. |

2. A bread dough comprising the following ingredients:

| | | |
|---|---|---|
| (i) | the bread mix of claim 1 | 4.00 parts ± 10%; |
| (ii) | oil | 0.33 parts ± 10%; and |
| (iii) | warm water | 1.75 parts ± 15%. |

3. A method of making the bread dough of claim 2 comprising (1) mixing the bread mix of claim 1; (2) mixing oil and warm water; and (3) blending the mixes from steps (1) and (2) together to form the bread dough.

4. A method of making an allergen-free bread product comprising (1) warming the bread dough of claim 2 for about one hour; and (2) baking the bread dough at 300° F. for 25-30 minutes or until baked through to form the bread product.

5. An allergen-free bread product made by the method of claim 4.

6. A first white cake mix comprising the following ingredients:

| | | |
|---|---|---|
| (1) | sugar | 9.80 parts ± 15%; |
| (2) | white rice flour and/or brown rice flour | 9.10 parts ± 15%; |
| (3) | baking powder, tapioca flour, tapioca starch, | 2.30 parts ± 35%; |
| | potato starch, arrowroot powder and/ | |
| | or cornstarch | |
| (4) | gum | 0.20 parts ± 40%; |
| (5) | salt | 0.15 parts ± 40%; and |
| (6) | cream of tartar | 0.12 parts ± 65%. |

7. A white cake batter comprising the following ingredients:

| | | |
|---|---|---|
| (i) | the white cake mix of claim 6 | 1.75 parts ± 10%; |
| (ii) | soy free shortening | 0.33 parts ± 10%; |
| (iii) | rice milk, liquid or powdered | 0.25 parts ± 10%; and |
| (iv) | water and/or carbonated beverage | 0.25 parts ± 10%. |

8. A method of making the white cake batter of claim 7 comprising: (1) beating the soy-free shortening, rice milk, and water and/or carbonated beverage; and (2) beating in the white cake mix to produce the white cake batter.

9. A method of making an allergen-free white cake comprising baking the white cake batter of claim 8 at 350° F. for 25-30 minutes or until baked through to produce the allergen-free white cake.

10. An allergen-free white cake made by the method of claim 9.

11. A chocolate cake mix comprising the following ingredients:

| | | |
|---|---|---|
| (1) | sugar | 9.80 parts ± 15%; |
| (2) | white rice flour and/or brown rice flour | 8.90 parts ± 15%; |
| (3) | baking powder, tapioca flour, tapioca starch, | 2.00 parts ± 35%; |
| | potato starch, arrowroot powder | |
| | and/or cornstarch | |
| (4) | cocoa | 1.00 parts ± 25%; |
| (5) | gum | 0.20 parts ± 40%; |
| (6) | cream of tartar | 0.10 parts ± 65%; and |
| (7) | salt | 0.15 parts ± 65%. |

12. A chocolate cake batter comprising the following ingredients:

| | | |
|---|---|---|
| (i) | the chocolate cake mix of claim 11 | 3.75 parts ± 10%; |
| (ii) | soy free shortening | 0.33 parts ± 10%; |
| (iii) | rice milk, liquid or powdered | 1.33 parts ± 10%; and |
| (iv) | water and/or carbonated beverage | 0.25 parts ± 10%. |

13. A method of making the chocolate cake batter of claim 12 comprising: (1) beating the soy-free shortening, rice milk, and water and/or carbonated beverage; and (2) beating in the chocolate cake mix to produce the chocolate cake batter.

14. A method of making an allergen-free chocolate cake comprising baking the chocolate cake batter of claim 12 at 350° F. until baked through to produce the allergen-free chocolate cake.

15. An allergen-free chocolate cake made by the method of claim 14.

16. A muffin mix comprising:

| | | |
|---|---|---|
| (1) | white rice flour and/or brown rice flour | 11.58 parts ± 20%; |
| (2) | sugar | 2.30 parts ± 35%; |
| (3) | baking powder, tapioca flour, tapioca | 1.70 parts ± 25%; |
| | starch, potato starch, arrowroot | |
| | powder and/or cornstarch | |
| (4) | sodium bicarbonate | 0.18 parts ± 50%; |
| (5) | gum | 0.18 parts ± 40%; and |
| (6) | salt | 0.10 parts ± 65%. |

17. A muffin batter comprising:

| | | |
|---|---|---|
| (i) | the muffin mix of claim 16 | 3.250 parts ± 10%; |
| (ii) | oil | 0.333 parts ± 10%; |
| (iii) | rice milk, liquid or powdered | 1.250 parts ± 10%; |
| (iv) | water and/or carbonated beverage | 1.385 parts ± 10%; and |

18. A method of making the muffin batter of claim 17 comprising: (1) beating the canola oil, the rice milk, and the water and/or carbonated beverage; and (2) beating in the muffin mix to produce the muffin batter.

19. A method of making allergen-free muffins comprising baking the muffin batter of claim 17 at 350° F. for 10-12 minutes until baked through to produce the allergen-free muffins.

20. An allergen-free muffin made by the method of claim 19.

21. A brownie mix comprising:

| | | |
|---|---|---|
| (1) | sugar | 6.50 parts ± 15%; |
| (2) | white rice flour and/or brown rice flour | 4.42 parts ± 15%; |
| (3) | brown sugar | 0.75 parts ± 35%; |
| (4) | cocoa | 0.45 parts ± 25%; |
| (5) | baking powder, tapioca flour, tapioca | 0.33 parts ± 35%; |
| | starch, potato starch, arrowroot | |
| | powder and/or cornstarch | |
| (6) | gum | 0.15 parts ± 40%; |
| (7) | sodium bicarbonate | 0.10 parts ± 40%; and |
| (8) | salt | 0.10 parts ± 65%. |

22. A brownie batter comprising:

| | | |
|---|---|---|
| (i) | the brownie mix of claim 21 | 2.00 parts ± 10%; |
| (ii) | oil | 0.25 parts ± 10%; and |
| (iii) | rice milk, liquid or powdered | 0.75 parts ± 10%. |

23. A method of making the brownie batter of claim 22 comprising: (1) beating the canola oil and the rice milk; and (2) beating in the brownie mix to produce the brownie batter.

24. A method of making allergen-free brownies comprising baking the brownie batter of claim 23 at 350° F. for 25-30 minutes until baked through to produce the allergen-free brownies.

25. An allergen-free brownie made by the method of claim 24.

26. A cornbread and muffin mix comprising:

| | | |
|---|---|---|
| (1) | cornmeal | 5.15 parts ± 30%; |
| (2) | sugar | 4.10 parts ± 40%; |
| (3) | tapioca flour, baking powder, tapioca | 3.65 parts ± 40%; |
| | starch, potato starch, arrowroot | |
| | powder and/or cornstarch | |
| (4) | white rice flour and/or brown rice flour | 1.15 parts ± 40%; |
| (5) | gum | 0.20 parts ± 65%; and |
| (6) | salt | 0.10 parts ± 65%. |

27. A cornbread and muffin dough comprising:

| | | |
|---|---|---|
| (i) | the cornbread and muffin mix of claim 26 | 2.75 parts ± 10%; |
| (ii) | dairy free, soy-free butter | 0.50 parts ± 10%; |
| (iii) | rice milk | 0.75 parts ± 10%; and |
| (iv) | water and/or carbonated beverage | 0.13 parts ± 10%. |

28. A method of making the cornbread and muffin dough of claim 27 comprising (1) beating the dairy free, soy-free butter, the rice milk, and the water and/or carbonated beverage; and (2) beating in the cornbread and muffin mix to produce the cornbread and muffin batter.

29. A method of making cornbread comprising baking the dough of claim 27.

30. An allergen-free cornbread made by the method of claim 29.

31. A pizza crust mix comprising the following ingredients:

| | | |
|---|---|---|
| (1) | white rice flour and/or brown rice flour | 13.96 parts ± 15%; |
| (2) | baking powder, tapioca flour, tapioca | 2.20 parts ± 40%; |
| | starch, potato starch, arrowroot | |
| | powder and/or cornstarch | |
| (3) | sugar | 0.60 parts ± 40%; |
| (4) | salt | 0.30 parts ± 65%; |
| (5) | powdered rice milk | 0.40 parts ± 40% |
| (6) | gum | 0.25 parts ± 65%; |
| (7) | vinegar | 0.06 parts ± 80%; and |
| (8) | yeast | 0.34 parts ± 25%. |

32. A pizza dough comprising the following ingredients:

| | | |
|---|---|---|
| (i) | the pizza crust mix of claim 31 | 4.00 parts ± 10%; |
| (ii) | oil | 0.33 parts ± 10%; |
| (iii) | rice milk, liquid or powdered | 0.25 parts ± 10%; and |
| (iv) | warm water | 1.75 parts ± 10%. |

33. A method of making an allergen-free pizza dough comprising mixing the ingredients of claim 32.

34. A method of making an allergen-free pizza comprising baking the pizza dough of claim 32 at 300° F.

35. An allergen-free pizza made by the method of claim 34.

36. A cookie mix comprising the following ingredients:

| | | |
|---|---|---|
| (1) | sugar | 3.20 parts ± 30%; |
| (2) | brown sugar | 2.40 parts ± 35%; |
| (3) | white rice flour and/or brown rice flour | 4.53 parts ± 15%; |
| (4) | tapioca flour, baking powder, tapioca | 0.75 parts ± 35%; |
| | starch, potato starch, arrowroot | |
| | powder and/or cornstarch | |
| (5) | potato flour | 0.60 parts ± 30%; |
| (6) | gum | 0.15 parts ± 65%; |
| (7) | sodium bicarbonate | 0.06 parts ± 75%; and |
| (8) | salt | 0.10 parts ± 65%. |

37. A cookie dough comprising the following ingredients:

| | | |
|---|---|---|
| (i) | the cookie mix of claim 36 | 2.00 parts ± 10%; |
| (ii) | dairy free, soy-free butter | 0.50 parts ± 10%; and |
| (iii) | water and/or carbonated beverage | 0.25 parts ± 10%. |

38. A method of making cookie dough comprising mixing the ingredients of claim 37.

39. A method of making an allergen-free cookie comprising baking the cookie dough of claim 37 at 350° F. to produce an allergen-free cookie.

40. An allergen-free cookie made by the method of claim 39.

41. An oatmeal cookie mix comprising the following ingredients:

| | | |
|---|---|---|
| (1) | white rice flour and/or brown rice flour | 5.15 parts ± 15%; |
| (2) | oats | 2.60 parts ± 30%; |
| (3) | brown sugar | 2.60 parts ± 15%; |
| (4) | sugar | 2.25 parts ± 15%; |
| (5) | tapioca flour, baking powder, tapioca | 1.05 parts ± 35%; |
| | starch, potato starch, arrowroot | |
| | powder and/or cornstarch | |
| (6) | potato flour | 0.10 parts ± 65%; |
| (7) | gum | 0.15 parts ± 65%; |
| (8) | sodium bicarbonate | 0.06 parts ± 75%; and |
| (9) | salt | 0.10 parts ± 65%. |

42. An oatmeal cookie dough comprising the following ingredients:

| | | |
|---|---|---|
| (i) | the oatmeal cookie mix of claim 41 | 2.50 parts ± 10%; |
| (ii) | dairy free, soy-free butter | 0.50 parts ± 10%; and |
| (iii) | water and/or carbonated beverage | 0.50 parts ± 10%. |

43. A method of making oatmeal cookie dough comprising mixing the ingredients of claim 42.

44. A method of making an allergen-free oatmeal cookie comprising baking the oatmeal cookie dough of claim 42 at 350° F. to produce an allergen-free oatmeal raisin cookie.

45. An allergen-free oatmeal cookie made by the method of claim 44.

46. A sugar cookie mix comprising the following ingredients:

| | | |
|---|---|---|
| (1) | sugar | 7.00 parts ± 30%; |
| (2) | white rice flour and brown rice flour | 6.30 parts ± 25%; |
| (3) | potato flour | 0.60 parts ± 40%; |
| (4) | tapioca flour, baking powder, tapioca | 0.75 parts ± 40%; |
| | starch, potato starch, arrowroot | |
| | powder and/or cornstarch | |
| (5) | sodium bicarbonate | 0.10 parts ± 75%; |
| (6) | gum | 0.15 parts ± 65%; and |
| (7) | salt | 0.10 parts ± 40%. |

47. A sugar cookie dough comprising the following ingredients:

| | | |
|---|---|---|
| (i) | the sugar cookie mix of claim 46 | 2.33 parts ± 10%; |
| (ii) | dairy free, soy-free butter | 0.50 parts ± 10%; and |
| (iii) | water and/or carbonated beverage | 0.50 parts ± 10%. |

48. A method of making sugar cookie dough comprising mixing the ingredients of claim 47.

49. A method of making an allergen-free sugar cookie comprising baking the sugar cookie dough of claim 47 at 350° F. to produce an allergen-free sugar cookies.

50. An allergen-free sugar cookie made by the method of claim 49.

51. A pancake/waffle/crêpe mix comprising:

| | | |
|---|---|---|
| (1) | white rice flour and/or brown rice flour | 11.50 parts ± 15% |
| (2) | sugar | 0.90 parts ± 35%; |
| (3) | powdered rice milk | 1.45 parts ± 10%; |
| (4) | baking powder, tapioca starch, tapioca | 0.75 parts ± 35%; |
| | starch, potato starch, arrowroot powder | |
| | and/or cornstarch | |
| (5) | salt | 0.30 parts ± 65%; |
| (6) | sodium bicarbonate | 0.25 parts ± 75%; |
| | | and |
| (7) | gum | 0.10 parts ± 75%. |

52. A pancake batter comprising:

| | | |
|---|---|---|
| (i) | the pancake/waffle/crêpe mix of claim 51 | 1.00 parts ± 10%; |
| (ii) | oil | 0.06 parts ± 10%; |
| (iii) | rice milk, liquid or powdered | 0.75 parts ± 10%; |
| | | and |
| (iv) | water | 0.13 parts ± 10%. |

53. A method of making the pancake batter comprising mixing the ingredients of claim 52.

54. A method of making an allergen-free pancake comprising cooking the pancake batter of claim 52 under medium heat to produce the allergen-free pancake.

55. An allergen-free pancake made by the method of claim 54.

56. A waffle batter comprising:

| | | |
|---|---|---|
| (i) | the pancake/waffle/crêpe mix of claim 51 | 1.25 parts; ± 10%; |
| (ii) | oil | 0.06 parts; ± 10%; |
| (iii) | rice milk, liquid or powdered | 1.00 parts ± 10%; |
| | | and |
| (iv) | vanilla | 0.01 parts ± 10%; |

57. A method of making the waffle batter comprising mixing the ingredients of claim 56.

58. A method of making an allergen-free waffle comprising cooking the waffle batter of claim 56 to produce the allergen-free waffle.

59. An allergen-free waffle made by the method of claim 58.

60. A crêpe batter comprising:

| | | |
|---|---|---|
| (i) | the pancake/waffle/crêpe mix of claim 51 | 1.00 parts ± 10%; |
| (ii) | oil | 0.06 parts ± 10%; |
| (iii) | rice milk, liquid or powdered | 1.00 parts ± 10%; |
| | | and |
| (iv) | sugar | 0.03 parts ± 10%. |

61. A method of making the crêpe batter comprising mixing the ingredients of claim 60.

62. A method of making an allergen-free crêpe comprising cooking the crêpe batter of claim 60 under medium heat to produce the allergen-free crepe.

63. An allergen-free crepe made by the method of claim 62.

64. A frosting mix comprising the following ingredients:

| | | |
|---|---|---|
| (1) | powdered sugar and/or sugar substitute | 13.61 parts ± 15%; and |
| (2) | powdered rice milk | 0.30 parts ± 35%. |

65. An allergen-free frosting comprising the following ingredients:

| | | |
|---|---|---|
| (i) | the frosting mix of claim 64 | 4.25 parts ± 10%; |
| (ii) | soy-free shortening | 0.50 parts ± 10%; |
| (iii) | rice milk, liquid or powdered | 0.25 parts ± 10%; and |
| (iv) | water | 0.13 parts ± 10%. |

66. A method of making the frosting comprising mixing the ingredients of claim 65.

67. An allergen-free frosting made by the method of claim 66.

68. A chocolate frosting mix comprising:

| | | |
|---|---|---|
| (1) | powdered sugar and/or sugar substitute | 12.45 parts ± 15%; |
| (2) | cocoa powder | 1.15 parts ± 20%; and |
| (3) | powdered rice milk | 0.30 parts ± 35%. |

69. Allergen-free chocolate frosting comprising:

| | | |
|---|---|---|
| (i) | the chocolate frosting mix of claim 68 | 2.25 parts ± 10%; |
| (ii) | soy free shortening | 0.50 parts ± 10%; |
| (iii) | rice milk, liquid or powdered | 0.25 parts ± 10%; and |
| (iv) | water | 0.50 parts ± 10%. |

70. A sauce & gravy mix comprising the following ingredients:

| | | |
|---|---|---|
| (1) | sweet, white, or brown rice flour | 9.40 parts ± 15%; and |
| (2) | cornstarch, tapioca starch, tapioca | 3.96 parts ± 35%. |
| | starch, baking powder, arrowroot | |
| | powder and/or potato starch | |

71. An allergen-free basic white sauce comprising:

| | | |
|---|---|---|
| (i) | the sauce & gravy mix of claim 70 | 0.13 parts ± 10%; |
| (ii) | oil or water | 0.13 parts ± 10%; |
| (iii) | rice milk, liquid or powdered | 0.75 parts ± 10%; and |
| (iv) | vegetable broth | 0.25 parts ± 10%. |

72. A method of making an allergen-free basic white sauce comprising: (1) stifling ingredients of claim 70, and (2) heating to boiling over medium heat for 1-2 minutes.

73. An allergen-free basic white sauce made by the method of claim 71.

74. An allergen-free butter cream sauce comprising:

| | | |
|---|---|---|
| (i) | the sauce & gravy mix of claim 70 | 0.13 parts ± 10%; |
| (ii) | dairy free, soy-free butter | 0.13 parts ± 10%; |
| (iii) | rice milk, liquid or powdered | 0.50 parts ± 10%; and |
| (iv) | vegetable broth | 0.25 parts ± 10%. |

75. A method of making an allergen-free butter cream sauce comprising: (1) stirring ingredients of claim 74, and (2) heating to boiling over medium heat for 1-2 minutes.

76. An allergen-free butter cream sauce made by the method of claim 75.

77. An allergen-free gravy comprising:

| | | |
|---|---|---|
| (i) | the sauce & gravy mix of claim 70 | 0.125 parts ± 10%; |
| (ii) | meat broth | 1.000 parts ± 10%; and |
| (iii) | water and/or oil | 0.125 parts ± 10%. |

78. A method of making an allergen-free gravy comprising: (1) stirring ingredients of claim 77, and (2) heating to boiling over medium heat for 1-2 minutes.

79. An allergen-free gravy made by the method of claim 78.

80. A pie crust mix comprising:

| | | |
|---|---|---|
| (1) | white rice flour and/or brown rice flour | 10.13 parts ± 15%; |
| (2) | sugar | 3.00 parts ± 30%; |
| (3) | baking powder, cornstarch, tapioca starch, | 2.50 parts ± 35%; |
| | tapioca starch, arrowroot powder and/or | |
| | potato starch | |
| (4) | gum | 0.35 parts ± 65%; |
| (5) | vinegar | 0.15 parts ± 75%; and |
| (6) | salt | 0.12 parts ± 65%. |

81. A pie dough comprising:

| | | |
|---|---|---|
| (i) | the pie crust mix of claim 80 | 3.00 parts ± 10%; |
| (ii) | soy-free shortening | 1.00 parts ± 10%; and |
| (iii) | ice cold water | 1.00 parts ± 10%. |

82. A method of making an allergen-free pie crust comprising baking the pie dough of claim 81 at 400° F. until the pie crust begins to turn golden.

83. An allergen-free pie crust made by the method of claim 82.
